(19) United States
(12) Patent Application Publication
(10) Pub. No.: US 2026/0107937 A1
(43) Pub. Date: Apr. 23, 2026

(54) ANTIPATHOGENIC NANOSTRUCTURES

(71) Applicant: The Boeing Company, Arlington, VA (US)

(72) Inventors: Michael MONTEIRO, Brisbane (AU); Changhe ZHANG, Melbourne (AU); Sung-Po CHEN, Brisbane (AU)

(73) Assignee: The Boeing Company, Arlington, VA (US)

(21) Appl. No.: 19/485,602

(22) PCT Filed: May 15, 2024
(86) PCT No.: PCT/US2024/029391

§ 371 Date: Nov. 18, 2025

Related U.S. Application Data
(60) Provisional application No. 63/467,746, filed on May 19, 2023.

(51) Int. Cl. A01N 25/10; A01P 1/00; C09D 5/14

(52) U.S. Cl. CPC A01N 25/10; A01P 1/00; C09D 5/14

(57) ABSTRACT

Systems and methods of depositing a nanostructure including a compound, or salt thereof. The compound includes a plurality of N-alkylacrylamide units. The compound includes a moiety represented by the formula (I), wherein R¹ is C₁-C₂₀ alkyl. The compound includes a moiety represented by the formula (II), wherein R², R³, and R⁴ are each independently hydrogen or C₁-C₂₀ alkyl. The compound includes a plurality of moieties represented by the formula (III): R⁵ wherein R⁵ is C₄-C₁₀ aryl. The compound includes a plurality of moieties represented by the formula (IV), wherein Q is O or N, R** is C₁-C₂₀ alkyl, R⁶, R⁷, and R⁸ are independently C₁-C₆ alkyl or hydrogen and R⁹, if present, is C₁-C₁₆ alkyl, C₁-C₆ alkylyne, azole, guanidine, an oligomer of guanidine such as diguanidine, polysaccharide, chromophore, and combination(s) thereof, q is an integer of 0 or 1. In at least one instance of the plurality, R⁹ is present and is diguanidine.

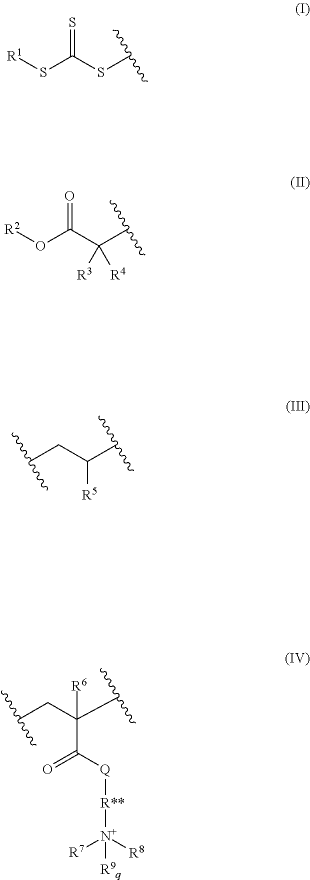

### CROSS-REFERENCE TO RELATED APPLICATIONS

This application is a U.S. National Stage Application of International Application No. PCT Application No. PCT/US2024/029391, filed on May 15, 2024 and published as WO 2024/242953 A1 on Nov. 28, 2024 and claims benefit of and priority to U.S. Application No. 63/467,746, filed May 19, 2023, the entire contents of which are incorporated herein by reference.

### FIELD

The present disclosure provides an antipathogenic nanostructures, such as a coating of antipathogenic nanostructures over a surface of a vehicle, a building, a wearable, a filter, or any other suitable object.

### BACKGROUND

Pandemics have major and lingering impacts on society. Reduction in pathogen transmission can be achieved on/in high touch surfaces and enclosed environments including vehicles, offices, transportation facilities, habitation, among others by reducing potential for the transmission of pathogens, such as viruses and microbes.

One goal of airlines includes aircraft cabin cleanliness and space transportation, and habitation industries are concerned with reducing potential for the transmission of pathogens, such as viruses and microbes. Indeed, certain pathogens, e.g., mRNA pathogens such as SARS-CoV-2 and variants thereof, are sense RNA viruses. Sense RNA viruses are capable of protein translation even after lysis of the host cell occurs. This feature of such mRNA pathogens makes it challenging to prevent pathogen transmission because standard cell lysing techniques are often ineffective against these sense RNA viruses. Moreover, these lysing techniques often require the use of undesirable chemicals to synthesize the molecules used to lyse the pathogen cells.

Currently disease transmission reduction techniques focus on improving mechanical features of air filtration systems. Unfortunately, this does not reduce or stop the transmission of pathogens via surfaces. Other disease reduction techniques focus on lysing the host cell having the pathogen. However, these techniques can fail to deactivate RNA and RNA translation of sense RNA viruses. As such, the sense RNA viruses can linger on surfaces.

Therefore, there is a need for improved self-decontaminating surface coatings.

### SUMMARY

The present disclosure provides a nanostructure including a compound, or salt thereof. The compound includes a plurality of N-alkylacrylamide units. The compound includes a moiety represented by the formula:

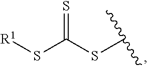

wherein R¹ is C₁-C₂₀ alkyl. The compound includes a moiety represented by the formula:

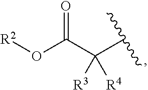

wherein R², R³, and R⁴ are each independently hydrogen or C₁-C₂₀ alkyl. The compound includes a plurality of moieties represented by the formula:

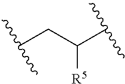

wherein R⁵ is C₄-C₁₀ aryl. The compound includes a plurality of moieties represented by the formula:

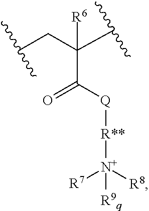

wherein Q is O or N, R** is C₁-C₂₀ alkyl, e.g., methyl, ethyl, propyl, butyl, pentyl, hexyl, heptyl, octyl, nonyl, decyl, or the like, R⁶, R⁷, and R⁸ are independently C₁-C₆ alkyl or hydrogen and R⁹, if present, is C₁-C₁₆ alkyl, C₁-C₆ alkylyne, azole, diguanidine, polysaccharide, chromophore, such as coumarin, and combination(s) thereof. q is an integer of 0 or 1. In at least one instance of the plurality, R⁹ is present and is an oligomer of guanidine, e.g., diguanidine.

The present disclosure also provides methods of depositing a nanostructure onto a surface. In some aspects, the nanostructure includes a compound, or salt thereof. The compound includes a plurality of N-alkylacrylamide units. The compound includes a moiety represented by the formula:

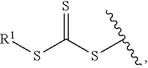

wherein R¹ is C₁-C₂₀ alkyl. The compound includes a moiety represented by the formula:

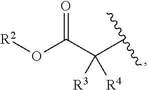

wherein R², R³, and R⁴ are each independently hydrogen or C₁-C₂₀ alkyl. The compound includes a plurality of moieties represented by the formula:

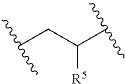

wherein R⁵ is C₄-C₁₀ aryl. The compound includes a plurality of moieties represented by the formula:

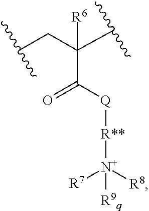

wherein Q is O or N, R** is C₁-C₂₀ alkyl, e.g., methyl, ethyl, propyl, butyl, pentyl, hexyl, heptyl, octyl, nonyl, decyl, or the like, R⁶, R⁷, and R⁸ are C₁-C₆ alkyl or hydrogen and R⁹, if present, is C₁-C₁₆ alkyl, C₁-C₆ alkylyne, azole, guanidine, an oligomer of guanidine e.g., diguanidine, polysaccharide, chromophore, and combination(s) thereof. q is an integer of 0 or 1. In at least one instance of the plurality, R⁹ is present and is an oligomer of guanidine, e.g., diguanidine.

### BRIEF DESCRIPTION OF THE DRAWINGS

So that the manner in which the above recited features of the present disclosure can be understood in detail, a more particular description of the disclosure, briefly summarized above, may be had by reference to aspects, some of which are illustrated in the appended drawings. It is to be noted, however, that the appended drawings illustrate only typical aspects of this present disclosure and are therefore not to be considered limiting of its scope, for the present disclosure may admit to other equally effective aspects.

FIG. 1A is a schematic view illustrating a nanoworm, according to certain aspects of the present disclosure.

FIG. 1B depicts an illustration of a synthesis scheme of forming a nanostructure, according to certain aspects of the present disclosure.

FIG. 2 depicts a ¹H NMR (CDCl₃) spectrum of the crude mixture of 1,1′-(azanediylbis(propane-3,1-diyl))diguanidine dihydrobromide, according to certain aspects of the present disclosure.

FIG. 3 depicts a ¹H NMR (CDCl₃) spectrum of the crude mixture of 1,1′-(azanediylbis(propane-3,1-diyl))diguanidine dihydrobromide, according to certain aspects of the present disclosure.

FIG. 4 depicts a ¹H NMR (CDCl₃) spectrum of the crude mixture of 2-chloro-N,N-bis(3-guanidinopropyl)acetamide dihydrobromide, according to certain aspects of the present disclosure.

FIG. 5 depicts a ¹H NMR (CDCl₃) spectrum of the crude mixture of 2-chloro-N,N-bis(3-guanidinopropyl)acetamide dihydrobromide, according to certain aspects of the present disclosure.

FIG. 6 depicts a ¹H NMR (CDCl₃) spectrum of the crude mixture of MacroCTA-A directly after polymerization (i.e. before dialysis), according to certain aspects of the present disclosure.

FIG. 7 depicts a molecular weight distribution of MacroCTA-A determined by SEC (RI detection, and using DMAc as eluent), according to certain aspects of the present disclosure.

FIG. 8 depicts a ¹H NMR (CDCl₃) spectrum of MacroCTA-A after purification by dialysis against water and freeze-drying, according to certain aspects of the present disclosure.

FIG. 9 depicts a ¹H NMR (CDCl₃) spectrum of the crude mixture of MacroCTA-B directly after polymerization (i.e. before dialysis). DMAEMA conversion=100%. NIPAM conversion=90, according to certain aspects of the present disclosure.

FIG. 10 depicts a molecular weight distribution of MacroCTA-B determined by SEC (RI detection, and using DMAc as eluent), according to certain aspects of the present disclosure.

FIG. 11 depicts a ¹H NMR (CDCl₃) spectrum of MacroCTA-B after purification by dialysis against water and freeze-drying. n(NIPAM)=45; n(DMAEMA)=30, according to certain aspects of the present disclosure.

FIG. 12 depicts a synthetic procedure of a nanoworm, according to certain aspects of the present disclosure.

FIG. 13 depicts a ¹H NMR (CDCl₃) spectrum of crude mixture of an emulsion polymerization, according to certain aspects of the present disclosure.

FIG. 14 depicts a SEC trace of purified polymer after dialyzed and freeze-drying (RI detector, DMAc as eluent). M_{n,TD}=19389, Ð_{RI} 1.36, according to certain aspects of the present disclosure.

FIG. 15 depicts a ¹H NMR (DMSO-d6) spectrum of purified emulsion latex after dialyzed and freeze-drying, according to certain aspects of the present disclosure.

FIGS. 16A-16C depict TEM images of aspects of nanostructures, according to certain aspects of the present disclosure. FIG. 16A depicts a nanoworm without addition of toluene (Spheres). FIG. 16B depicts a nanostructure after addition of toluene (nanoworms). FIG. 16C depicts removal of toluene from the nanoworm by rota-evaporation (still maintains nanoworm structure).

FIG. 17 depicts a synthetic procedure of a nanoworm, according to certain aspects of the present disclosure.

FIG. 18 depicts ¹H NMR (CDCl₃) spectra of a polymer latex sampled after emulsion polymerization at 70° C. for 5 h, exposing polymer latex to air at 70° C. for 4 h, and cooling polymer latex from 70 to 25° C. for 24 h, according to certain aspects of the present disclosure.

FIG. 19 depicts TEM spheres of a nanostructure produced after (i) emulsion polymerization for 5 h at 70° C., (ii) exposing polymer latex to air for 4 h at 70° C., and (iii) cooling polymer latex from 70 to 25° C. for 24 h, according to certain aspects of the present disclosure.

FIGS. 20A and 20B depict TEM images of nanoworm (NW) latex heated at 50° C. for 1 hour, according to certain aspects of the present disclosure. FIG. 20A depicts 8.2 wt % of nanoworm in water. FIG. 20B depicts 4.1 wt %.

FIG. 21 depicts a synthetic process of producing nanoworms using PGal, poly(D-galactose 6-O-acrylate); 7HC—N₃, and 3-azido-7-hydroxycoumarin, according to certain aspects of the present disclosure.

FIG. 22 depicts a synthetic process of quaternization of a nanoworm with diguanidine chloroacetamide (digua-Cl) at 60° C., according to certain aspects of the present disclosure.

FIG. 23 depicts ¹H NMR (DMSO-d6) spectra of the crude reaction mixtures before and after reaction, according to certain aspects of the present disclosure.

FIG. 24 depicts ¹H NMR (DMSO-d6) spectra of the purified (after dialysis) polymers before and after quaternization with digua-Cl, according to certain aspects of the present disclosure.

FIG. 25 depicts a synthetic process of quaternization of a nanoworm with diguanidine chloroacetamide at 50° C. prior to functionalization with propargyl bromide, 1-iodooctane, polysugar azide, and coumarin azide, according to certain aspects of the present disclosure.

FIG. 26 depicts ¹H NMR (DMSO-d6) spectra for quaternization of a nanoworm at 50° C. with di-gua-Cl, according to certain aspects of the present disclosure.

FIGS. 27A and 27B depict TEM images after the reaction of nanoworms at 50° C. with digua-Cl, according to certain aspects of the present disclosure. FIG. 27A depicts a 14 h reaction. FIG. 27B depicts a 36 h reaction.

FIG. 28 depicts a synthetic process of quaternization of a nanoworm with propargyl bromide, according to certain aspects of the present disclosure.

FIG. 29 depicts ¹H NMR (DMSO-d6) spectra for the quaternization of nanoworms at room temperature with propargyl bromide, according to certain aspects of the present disclosure. Zoomed-in section focuses on CH₂ peak of propargyl bromide. Reactions A and B were done at the same time. The toluene found in the NMR was from propargyl bromide solution.

FIG. 30 depicts ¹H NMR (DMSO-d6) spectra of purified samples after quaternization with propargyl bromide, according to certain aspects of the present disclosure.

FIG. 31 depicts a synthetic process of quaternization of a nanoworm with 1-iodooctane, according to certain aspects of the present disclosure.

FIG. 32 depicts ¹H NMR (DMSO-d6) spectra of purified sample after further quaternized with 1-iodooctane, compared to purified nano-spheres, according to certain aspects of the present disclosure.

FIG. 33 depicts a synthetic process of copper catalyzed azide alkyne cycloaddition (CuAAC) coupling with polysugar azide and coumarin azide, according to certain aspects of the present disclosure.

FIG. 34 depicts ¹H NMR of (in DMSO-d6) spectra of crude mixtures before and after CuAAC, according to certain aspects of the present disclosure.

FIG. 35 depicts a schematic illustration of click reactions on nanoworms, according to certain aspects of the present disclosure.

FIGS. 36A and 36B depict TEM images after dialysis for the two replicate reactions, according to certain aspects of the present disclosure. FIG. 36A depicts a TEM image after dialysis of reaction A. FIG. 36B depicts a TEM image after dialysis of reaction B.

FIG. 37 depicts a ¹H NMR (in DMSO-d6) spectra comparison among samples (one of the reactions in parallel) before and after CuAAC to track polysugar, according to certain aspects of the present disclosure.

FIG. 38 depicts a ¹H NMR (in DMSO-d6) spectra comparison among samples (the other reaction in parallel) before and after CuAAC to track polysugar, according to certain aspects of the present disclosure.

FIGS. 39A-39C depict an analysis of the nanostructure, according to certain aspects of the present disclosure. FIG. 39A depicts a compound of the nanostructure. FIG. 39B depicts a ¹H NMR spectrum of a purified sample of reaction A. FIG. 39C depicts a 1H NMR spectrum after addition of D₂O into the DMSO-d6 NMR mixture.

FIG. 40 depicts ¹H NMR spectra of a purified sample of one of the replicate reaction, reaction B and a sample after addition of D₂O into the DMSO-d6 NMR mixture, according to certain aspects of the present disclosure.

FIG. 41 depicts a synthetic process of quaternization of a nanoworm with diguanidine chloroacetamide at 50° C. after functionalization with propargyl bromide, 1-iodooctane, polysugar azide and coumarin azide, according to certain aspects of the present disclosure.

FIGS. 42A and 42B depict TEM images of aspects of nanostructures, according to certain aspects of the present disclosure. FIG. 42A depicts a TEM image after quaternization with digua-Cl. FIG. 42B depicts a TEM image of the two reactions in parallel.

FIGS. 43A-43C depict an analysis of the nanostructure, according to certain aspects of the present disclosure. FIG. 43A depicts a ¹H NMR (in DMSO-d6) spectrum of purified reaction A after quaternization with digua-Cl at 50° C. FIG. 43B depicts a ¹H NMR (in DMSO-d6) spectrum of purified reaction B after quaternization with digua-Cl at 50° C. FIG. 43C depicts a ¹H NMR (in DMSO-d6) spectrum of a purified nanoworm after quaternization with digua-Cl at 50° C.

FIG. 44 depicts a synthetic process of producing a nanostructure via quaternizations of nanoworms at elevated temperature with proposed polysugar pseudo-halide, digua-Cl and iodooctane components, according to certain aspects of the present disclosure.

FIGS. 45A-45F depict synthetic processes of producing a nanostructure via quaternizations of nanoworms, according to certain aspects of the present disclosure. FIG. 45A depicts a first synthetic process. FIG. 45B depicts a second synthetic process. FIG. 45C depicts a third synthetic process. FIG. 45D depicts a fourth synthetic process. FIG. 46E depicts a fifth synthetic process. FIG. 45F depicts a general synthetic process.

FIG. 46 depicts a synthetic processes of producing a nanostructure via quaternizations of nanoworms, according to certain aspects of the present disclosure.

FIGS. 47A-47C depict TEM images of aspects of nanostructures, according to certain aspects of the present disclosure. FIG. 47A depicts a TEM image after quaternization without addition of plasticizer. FIG. 47B depicts a parallel TEM image after quaternization without addition of plasticizer. FIG. 47C depicts a parallel TEM image after quaternization without addition of plasticizer.

FIG. 48 depicts a synthetic process of a CuAAAC ‘click’ of nanoworm with a polysaccharide and a chromophore, according to certain aspects of the present disclosure.

FIGS. 49A-49C depict TEM images of aspects of nanostructures, according to certain aspects of the present disclosure. FIG. 49A depicts a TEM image after CuAAC with a polysaccharide and a chromophore. FIG. 49B depicts a parallel TEM image after CuAAC with a polysaccharide and a chromophore. FIG. 49C depicts a parallel TEM image after CuAAC with a polysaccharide and a chromophore.

FIG. 50 is a schematic representation of transformation from sphere to nanoworm, according to certain aspects of the present disclosure.

FIGS. 51A and 51B depict TEM images of aspects of nanostructures, according to certain aspects of the present disclosure. FIG. 51A depicts nanoworms obtained from a first mixture. FIG. 51B depicts nanoworms obtained from a second mixture.

FIG. 52 depicts a large scale synthetic procedure of a nanoworm, according to certain aspects of the present disclosure.

FIG. 53 depicts an SEC trave of the large scale nanoworm, according to certain aspects of the present disclosure.

FIG. 54 depicts a large scale synthetic procedure for quaternization of nanoworms, according to certain aspects of the present disclosure.

FIGS. 55A-55C depict TEM images of aspects of nanostructures, according to certain aspects of the present disclosure. FIG. 55A depicts a TEM image after quaternization without addition of plasticizer. FIG. 55B depicts a parallel TEM image after quaternization without addition of plasticizer. FIG. 55C depicts a parallel TEM image after quaternization without addition of plasticizer.

FIGS. 56A-56D depict tray table sample images of aspects of nanostructures, according to certain aspects of the present disclosure. FIG. 56A depicts a tray table sample of a control sample under ambient light. FIG. 55B depicts a tray table sample of a sample coated with nanostructure A under ambient light. FIG. 56C depicts a tray table sample of a control sample under UV light. FIG. 55D depicts a tray table sample of a sample coated with nanostructure A under UV light.

FIG. 57 depicts a TCID₅₀ spectrum of an Omicron variant of SARS-CoV-2 titre comparing uncoated samples and comparative samples, according to certain aspects of the present disclosure.

FIG. 58 depicts a qRT-PCR of an Omicron variant of SARS-CoV-2 comparing uncoated samples, comparative samples, and nanostructures of the present disclosure, according to certain aspects of the present disclosure.

FIG. 59 depicts a qRT-PCR of a Delta variant of SARS-CoV-2 comparing uncoated samples and nanostructures of the present disclosure, according to certain aspects of the present disclosure.

FIG. 60 depicts a qRT-PCR of an Alpha variant of SARS-CoV-2 comparing uncoated samples and nanostructures of the present disclosure, according to certain aspects of the present disclosure.

FIG. 61 depicts a TCID₅₀ spectrum of an Influenza infectious titre comparing uncoated samples and comparative samples, according to certain aspects of the present disclosure.

FIG. 62 depicts a qRT-PCR of a PR8 genome comparing uncoated samples, comparative samples, and nanostructures of the present disclosure, according to certain aspects of the present disclosure.

### DETAILED DESCRIPTION

The rise in coronavirus variants and other sense RNA viruses or DNA viruses has resulted in surges of the disease across the globe. For example, the mutations in the spike protein on the surface of the virion membrane not only allow for greater transmission but raise concerns about vaccine effectiveness. Preventing the spread of SARS-CoV-2, variants of SARS-CoV-2 and other sense RNA viruses from person-to-person via airborne or surface transmission requires inactivation of the virus.

The present disclosure provides nanostructures, such as a coating of antipathogenic nanoworms over a surface of a vehicle, a building, a wearable, a filter, or any other suitable object having a porous or non-porous composition, such as a solid and/or a woven or non-woven fabric, in which antipathogenic nanoworms are nanoworms suitable for reducing one or more pathogen s on the surface to be coated. The coating has antipathogenic properties effective at reducing or eliminating pathogens and/or reducing the transmission of pathogens.

A coating can be deployed using any aqueous-based method, such as by an aqueous spray-on nanocoating. The spray-on nanocoating can inactivate proteins or virion particles and degrade DNA or RNA of the virus. Without being bound by theory, it is believed that the nanostructure of the coating binds and, through subsequent large conformational changes of the nanoworm the nanoworm ruptures the viral membrane. Subsequently, the nanostructure of the coating binds and degrades the genetic material of the virus, inactivating the virus, such as SARS-CoV-2 (VICO1), an evolved B.1.1.7 (alpha) variant, influenza A, or a virus containing a surrogate capsid pseudovirus expressing the influenza A virus attachment glycoprotein, hemagglutinin. A polygalactose functionality on a nanostructure targets the conserved S2 subunit on the SARS-CoV-2 virion surface spike glycoprotein for stronger binding, and the additional attachment of the guanidine groups is known to catalyze the degradation of the RNA genome of the virus.

In some examples, a nanostructure of the present disclosure is coated onto a surface of an item of personal protective equipment, such as a mask, a face shield, a rebreather, a filter cartridge, or combinations thereof. Coating surgical masks with the nanostructures can result in complete inactivation of the enveloped VICO1 and B.1.1.7, providing a powerful control measure for SARS-CoV-2 and its variants. Inactivation can also be observed for the enveloped influenza A and an AAV-HA capsid pseudovirus, providing broad viral inactivation when using a nanoworm of the present disclosure. The technology described herein represents a coating with a proposed nano-mechanical mechanism for inactivation of viruses both enveloped and capsid. The functionalized nanostructures can be modified to target other viruses known and unknown, and are compatible with large scale manufacturing processes.

In certain aspects, a nanostructure coated surface can become a hydrophilic surface. For example, a nanostructure coated surface can become hydrophilic (water soluble) allowing the wetting of a droplet, such as a mucosal drop, blood, urine, sweat, other bodily fluids, and other non-bodily fluids, across the nanostructure coated surface. In certain aspects, pathogens on the surface of the droplet or suspended within the droplet can be captured, inactivated, or deactivated by the nanostructure coated surface. The coatings described herein can include a polymer and can have a transparent appearance when applied to surfaces. In some aspects, the coatings are useful for inactivating one or more, such as all, variants of SARS-CoV-2. Without being bound by theory, it is believed that the coatings target the highly glycosylated spike protein and/or the influenza A virus attachment glycoprotein, hemagglutinin, on a virion surface and disrupt the viral membrane through a process of conformational change in the nanoworms to perform a mechanical rupture of the virus membrane.

In certain aspects, a nanostructure of the present disclosure is produced using a diguanidine reagents, e.g., diguanidine-chloroacetamide (digua-Cl), diguanidine acetate, diguanidine phosphate, diguanidine platinum, and the like, which simplifies the synthetic process as compared to conventional nanostructures. Diguanidine reagents can be preferable to other guanidine reagents, e.g., guanidine-azide, because of the enhanced stability exhibited by the diguanidine reagents. For example, and without limitation, a diguanidine reagent of diguanidine-chloroacetamide exhibits enhanced stability compared to guanidine-azide. Additionally, or alternatively, diguanidine reagents such as diguanidine-chloroacetamide can be scalable to ensure commercial viability.

In certain aspects, personal protective equipment (e.g. a face mask, a face shield, a rebreather, a filter cartridge, or combinations thereof) and treatment of high-touch surfaces with antiviral coatings of the present disclosure can provide long-lasting (e.g., days, weeks, months, etc.) disinfection of contaminated surfaces to reduce or eliminate the spread of SARS-CoV-2 and/or variants thereof.

### Definitions

The term “DNA” refers to a polymer composed of two polynucleotide chains that coil around each other to form a double helix. DNA, otherwise known as deoxyribonucleic acid includes one or more of adenine, cytosine, guanidine, and/or thymine. DNA can include a modified base, e.g., 5-methylcytosine, N6-carbamoyl-methyladenine, N6-methadenine, 7-Deazaguanine, 7-Methylguanine, N4-methylcytosine, 5-carboxylcytosine, 5-formylcytosine, 5-glycosylhydroxymethylcytosine, 5-hydroxycytosine, 5-methylcytosine, alpha-glutamythymidine, alpha-putrescinylthymine, base j, uracil, 5-dihydroxypentauracil, 5-hydroxymethyldeoxyuracil, deoxyarchaeosine, 2,6-diaminopurine, or combinations thereof. A DNS virus can include a double-stranded DNA virus or a single-stranded DNA virus.

As used herein, a “nanostructure” refers to a 3-dimensional structure provided by two or more functional groups (that may have the same or different chemical structure). The nanostructure may be any suitable nanostructure having a length or width of about 1 nm to about 100 μm, e.g., about 1 nm to about 5 μm, about 500 nm to about 1 μm, or about 10 nm to about 250 nm.

A “nanoworm” is an example of a nanostructure and has a high aspect ratio (length divided by width), in which a high aspect ratio has a length that is greater than about 1000 times the width of the nanostructure. A “nanorod” is an example of a nanostructure that has a low aspect ratio (length divided by width) as compared to a nanoworm, in which a low aspect ratio has a length that is at about 10 to about 1000 times the width of the nanostructure. As used herein, the term “pathogen” refers to viruses, bacteria, fungi, and/or other microbes or germs. The coatings described herein are capable of reducing or eliminating the presence of and/or transmission of a wide range of pathogens, such as SARS-CoV-2 and variants thereof, such as alpha, beta, delta, omicron, or combinations thereof.

The term “pharmaceutically-acceptable” means suitable for use in pharmaceutical preparations, generally considered as safe for such use, officially approved by a regulatory agency of a national or state government for such use, or being listed in the U.S. Pharmacopoeia or other generally recognized pharmacopoeia for use in animals, and more particularly in humans.

The term “pharmaceutically-acceptable salt” refers to a salt which can enhance desired pharmacological activity. Examples of pharmaceutically-acceptable salts include acid addition salts formed with inorganic or organic acids, metal salts and amine salts. Examples of acid addition salts formed with inorganic acids include salts with hydrochloric acid, hydrobromic acid, sulfuric acid, nitric acid and phosphoric acid. Examples of acid addition salts formed with organic acids such as acetic acid, propionic acid, hexanoic acid, heptanoic acid, cyclopentanepropionic acid, glycolic acid, pyruvic acid, lactic acid, malonic acid, succinic acid, malic acid, maleic acid, fumaric acid, tartaric acid, citric acid, benzoic acid, o-(4-hydroxy-benzoyl)-benzoic acid, cinnamic acid, mandelic acid, methanesulfonic acid, ethanesulfonic acid, 1,2-ethanedisulfonic acid, 2-hydroxyethane-sulfonic acid, benzenesulfonic acid, p-chlorobenzenesulfonic acid, 2-naphthalenesulfonic acid, p-toluenesulfonic acid, camphorsulfonic acid, 4-methyl-bicyclo[2.2.2]oct-2-enel-carboxylic acid, gluco-heptonic acid, 4,4′-methylenebis(3-hydroxy-2-naphthoic) acid, 3-phenylpropionic acid, trimethyl-acetic acid, tertiary butylacetic acid, lauryl sulfuric acid, gluconic acid, glutamic acid, hydroxy-naphthoic acids, salicylic acid, stearic acid and muconic acid. Examples of metal salts include salts with sodium, potassium, calcium, magnesium, aluminum, iron, and zinc ions. Examples of amine salts include salts with ammonia and organic nitrogenous bases strong enough to form salts with carboxylic acids.

The term “RNA” refers to a ribonucleic acid living within a virus or cell. RNA can include one or more of adenine, cytosine, guanidine, and/or uracil. RNA can include a phosphate group attached at a 3′ position of the one ribose and the 5′ position of the next. RNA can be a sense RNA. The term “Sense RNA virus” refers to a type of virus containing a positive sense single-stranded RNA or a negative sense single-stranded RNA. A Sense RNA virus can be capable of operating as mRNA and can be directly translated into the protein in the host.

The term “therapeutically-effective amount” refers to an amount of a compound that, when administered to a subject for treating a condition, is sufficient to effect treatment for the condition. “Therapeutically effective amount” can vary depending on the compound, the condition and its severity, the age, and the weight of the subject to be treated.

The term “virus” refers to a submicroscopic infective agent that includes a nonliving complex molecule that typically contains a protein coat surrounding an RNA or DNA core of genetic material but no semipermeable membrane, that is capable of growth and multiplication in living cells, and that can cause a disease in humans, animals, or plants. In at least one aspect, the virus can be a sense RNA virus, e.g., a positive sense RNA virus or a negative sense virus. For example, the virus can be SARS-CoV-2, or any variant thereof.

Compounds of the present disclosure include tautomeric, geometric or stereoisomeric forms of the compounds. Ester, oxime, onium, hydrate, solvate and N-oxide forms of a compound are also embraced by the present disclosure. The present disclosure considers all such compounds, including cis- and trans-geometric isomers (Z- and E-geometric isomers), R- and S-enantiomers, diastereomers, d-isomers, 1-isomers, atropisomers, epimers, conformers, rotamers, mixtures of isomers and racemates thereof are embraced by the present disclosure.

As used herein, the term “SARS-CoV-2 variant” refers to viruses that have mutated from SARS-CoV-2. The mutations can include about 1 to about 75 mutations across the virus genome, such as about 25 to about 50 mutations. One or more the mutations can include mutations in the spike protein of the virus, such as about 1 to about 40 mutations in the spike protein, such as about 32 mutations. Without being bound by theory, it is believed that certain known variants have enhanced binding to the ACE2 receptor through the receptor binding domain on the spike protein found predominantly on human throat and lung cells. Once bound to the cell, the mutation close to the S1/S2 region of the SARS-Cov-2 spike glycoprotein further enhances cleavage mainly by the serine proteinase (e.g., TMPRSS2) on the cell surface, exposing the spike's hydrophobic region to fuse and release the viral RNA within the cell, or enhance cell-cell fusion of giant multi-nuclear cells. Different variants can have different responses to vaccination, different rates of transmission, and different symptoms upon contraction. An antigenic shift, due to the high number of mutations in certain variants, such as the omicron spike, can stem from extensive replication in immune-deficient hosts or transmissions back and forth between humans and rodents. In some aspects, infected hosts can release SARS-CoV-2 into the environment via sneezing, coughing and skin contact, resulting in potential fomite contamination of surrounding surfaces. Infectious SARS-CoV-2 has been proven in laboratory-based studies to persist on many different surfaces.

### Compounds

A compound described herein includes a plurality of N-alkylacrylamide units. In at least one aspect, which can be combined with any other aspect described herein, N-alkylacrylamide is represented by the formula:

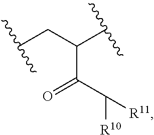

wherein each of R¹⁰ and R¹¹ is independently hydrogen or C₁-C₂₀ alkyl, where at least one of R¹⁰ or R¹¹ is C₁-C₂₀ alkyl, such as methyl, ethyl, n-propyl, or isopropyl. In at least one aspect, which can be combined with any other aspect described herein, at least one of R¹⁰ or R¹¹ is isopropyl.

In at least one aspect, which can be combined with any other aspect described herein, the compound comprises a moiety represented by the formula

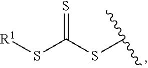

where R¹ is C₁-C₂₀ alkyl. In some aspects, which can be combined with any other aspect described herein, R¹ is methyl, ethyl, propyl, butyl, pentyl, hexyl, heptyl, octyl, nonyl, decyl, or the like. In some aspects, which can be combined with any other aspect described herein, R¹ is butyl.

In at least one aspect, which can be combined with any other aspect described herein, the compound comprises a moiety represented by the formula

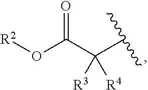

where R², R³, and R⁴ are each independently hydrogen or C₁-C₂₀ alkyl. In some aspects, R², R³, and R⁴ are each independently hydrogen. In some aspects, which can be combined with any other aspect described herein, R², R³, and R⁴ are each independently C₁-C₂₀ alkyl, e.g., methyl, ethyl, propyl, butyl, pentyl, hexyl, heptyl, octyl, nonyl, decyl, or the like. In some aspects, which can be combined with any other aspect described herein, R² and R³ are hydrogen and R⁴ is C₁-C₂₀ alkyl, e.g., methyl, ethyl, propyl, butyl, pentyl, hexyl, heptyl, octyl, nonyl, decyl, or the like. In some aspects, which can be combined with any other aspect described herein, R² and R⁴ are hydrogen and R³ is C₁-C₂₀ alkyl, e.g., methyl, ethyl, propyl, butyl, pentyl, hexyl, heptyl, octyl, nonyl, decyl, or the like. In some aspects, which can be combined with any other aspect described herein, R³ and R⁴ are hydrogen and R² is C₁-C₂₀ alkyl, e.g., methyl, ethyl, propyl, butyl, pentyl, hexyl, heptyl, octyl, nonyl, decyl, or the like. In some aspects, which can be combined with any other aspect described herein, R² is hydrogen and R³ and R⁴ are independently C₁-C₂₀ alkyl, e.g., methyl, ethyl, propyl, butyl, pentyl, hexyl, heptyl, octyl, nonyl, decyl, or the like. In some aspects, which can be combined with any other aspect described herein, R³ is hydrogen and R² and R⁴ are independently C₁-C₂₀ alkyl, e.g., methyl, ethyl, propyl, butyl, pentyl, hexyl, heptyl, octyl, nonyl, decyl, or the like. In some aspects, which can be combined with any other aspect described herein, R² and R⁴ are methyl, and R³ is hydrogen. In some aspects, which can be combined with any other aspect described herein, R⁴ is hydrogen and R² and R³ are independently C₁-C₂₀ alkyl, e.g., methyl, ethyl, propyl, butyl, pentyl, hexyl, heptyl, octyl, nonyl, decyl, or the like. In some aspects, which can be combined with any other aspect described herein, R² and R³ are methyl, and R⁴ is hydrogen.

In at least one aspect, which can be combined with any other aspect described herein, the compound comprises a plurality of moieties represented by the formula

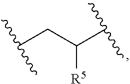

where R⁵ is C₄-C₁₀ aryl. In some aspects, which can be combined with any other aspect described herein, R⁵ is C₆ aryl. In some aspects, which can be combined with any other aspect described herein, R⁵ is phenyl. In some aspects, which can be combined with any other aspect described herein, phenyl can be substituted with between 1, 2, 3, 4, or 5 moieties, such as independently C₁-C₁₀ alkyl moieties. In at least one aspect which can be combined with any other aspect described herein, the compound comprises a plurality of moieties represented by the formula:

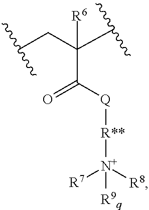

where Q is O or N, R** is C₁-C₂₀ alkyl, e.g., methyl, ethyl, propyl, butyl, pentyl, exyl, eptyl, octyl, nonyl, decyl, or the like, R⁶, R⁷, and R⁸ are independently C₁-C₆ alkyl or hydrogen. In some aspects, which can be combined with any other aspect described herein, R⁶, R⁷, and R⁸ are each independently C₁-C₆ alkyl, e.g., methyl, ethyl, propyl, butyl, pentyl, hexyl, or the like. In some aspects, R⁶, R⁷, and R⁸ are each methyl. In some aspects, which can be combined with any other aspect described herein, R⁶ and R⁷ are hydrogen and R⁸ is C₁-C₆ alkyl, e.g., methyl, ethyl, propyl, butyl, pentyl, hexyl, or the like. In some aspects, which can be combined with any other aspect described herein, R⁶ and R⁸ are hydrogen and R⁷ is C₁-C₆ alkyl, e.g., methyl, ethyl, propyl, butyl, pentyl, hexyl, or the like. In some aspects, which can be combined with any other aspect described herein, R⁷ and R⁸ are hydrogen and R⁶ is C₁-C₆ alkyl, e.g., methyl, ethyl, propyl, butyl, pentyl, hexyl, or the like. In some aspects, which can be combined with any other aspect described herein, R⁶ is hydrogen and R⁷ and R⁸ are independently C₁-C₆ alkyl, e.g., methyl, ethyl, propyl, butyl, pentyl, hexyl, or the like. In some aspects, which can be combined with any other aspect described herein, R⁷ is hydrogen and R⁶ and R⁸ are independently C₁-C₆ alkyl, e.g., methyl, ethyl, propyl, butyl, pentyl, hexyl, or the like. In some aspects, which can be combined with any other aspect described herein, R⁸ is hydrogen and R⁶ and R⁷ are independently C₁-C₆ alkyl, e.g., methyl, ethyl, propyl, butyl, pentyl, hexyl, or the like.

q is 0 or 1. In some aspects, which can be combined with any other aspect described herein, at least one instance of R⁹ (of the plurality) is C₁-C₁₆ alkyl, e.g., methyl, ethyl, propyl, butyl, pentyl, hexyl, heptyl, octyl, nonyl, decyl, or the like. Without being bound by theory, when R⁹ is C₅ or greater, enhanced cell membrane penetration of the alkyl moiety into the hydrophobic portion of a cell membrane (such as a viral cell) can occur promoting lysis of the viral cell. Additionally, the cationic nitrogen moieties can provide coulombic interactions of the compound (such as the quaternary ammonium moieties) with the cell membrane surface (such as the phosphate moieties of the phospholipid bilayer) further promoting lysis of the viral cell. Furthermore, the quaternary ammonium salt can provide sufficient hydrophilicity so that the alkyl moieties attached to the quaternary ammonium salt do not become substantially buried within the core of the three-dimensional structure (e.g., when the composition has the three dimensional structure of nanoworm or nanorod).

In some aspects, which can be combined with any other aspect described herein, R⁹ is C₁-C₆ alkylyne, e.g., C₁ alkylyne, C₂ alkylyne, C₃ alkylyne, C₄ alkylyne, C₅ alkylyne, C₆ alkylyne, or the like. In some aspects, R⁹ is azole. In some aspects, which can be combined with any other aspect described herein, R⁹ is an oligomer of guandine, e.g., diguanidine. In some aspects, which can be combined with any other aspect described herein, R⁹ is a diguanidine represented by the structure:

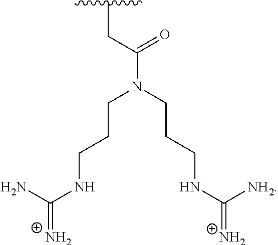 [SMILES: *CC(=O)N(CCCNC(N)=[NH2+])CCCNC(N)=[NH2+]]

In some aspects, which can be combined with any other aspect described herein, R⁹ is polygalactose having the structure:

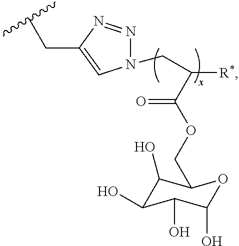

wherein x is an integer of 1 to 20, e.g., an integer of 10, and R* is hydrogen, —OH, or

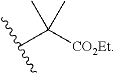 [SMILES: *C(C)(C)C(=O)OCC]

In some aspects, which can be combined with any other aspect described herein, R⁹ is coumarin, such as 7-hydroxycoumarin. In some aspects, which can be combined with any other aspect described herein, R⁹ is a combination of azole and polygalactose (e.g., polygalactose-substituted azole). In some aspects, which can be combined with any other aspect described herein, R⁹ is a combination of azole and coumarin (e.g., 3-azido-7-hydroxycoumarin), having the formula:

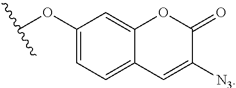 [SMILES: *Oc1ccc2cc(N=[N+]=[N-])c(=O)oc2c1]

For example, and without limitation, q is 1 and R⁹ is diguanidine.

In an aspect, which can be combined with any other aspect described herein, the moiety is represented by the formula:

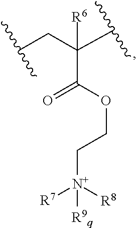

where R⁶, R⁷, and R⁸ are independently C₁-C₆ alkyl or hydrogen. In some aspects, which can be combined with any other aspect described herein, R⁶, R⁷, and R⁸ are each independently C₁-C₆ alkyl, e.g., methyl, ethyl, propyl, butyl, pentyl, hexyl, or the like. In some aspects, which can be combined with any other aspect described herein, R⁶, R⁷, and R⁸ are each methyl. In some aspects, which can be combined with any other aspect described herein, R⁶ and R⁷ are hydrogen and R⁸ is C₁-C₆ alkyl, e.g., methyl, ethyl, propyl, butyl, pentyl, hexyl, or the like. In some aspects, which can be combined with any other aspect described herein, R⁶ and R⁸ are hydrogen and R⁷ is C₁-C₆ alkyl, e.g., methyl, ethyl, propyl, butyl, pentyl, hexyl, or the like. In some aspects, which can be combined with any other aspect described herein, R⁷ and R⁸ are hydrogen and R⁶ is C₁-C₆ alkyl, e.g., methyl, ethyl, propyl, butyl, pentyl, hexyl, or the like. In some aspects, which can be combined with any other aspect described herein, R⁶ is hydrogen and R⁷ and R⁸ are independently C₁-C₆ alkyl, e.g., methyl, ethyl, propyl, butyl, pentyl, hexyl, or the like. In some aspects, which can be combined with any other aspect described herein, R⁷ is hydrogen and R⁶ and R⁸ are independently C₁-C₆ alkyl, e.g., methyl, ethyl, propyl, butyl, pentyl, hexyl, or the like. In some aspects, which can be combined with any other aspect described herein, R⁸ is hydrogen and R⁶ and R⁷ are independently C₁-C₆ alkyl, e.g., methyl, ethyl, propyl, butyl, pentyl, hexyl, or the like.

q is 0 or 1. In some aspects, which can be combined with any other aspect described herein, at least one instance of R⁹ (of the plurality) is C₁-C₁₆ alkyl, e.g., methyl, ethyl, propyl, butyl, pentyl, hexyl, heptyl, octyl, nonyl, decyl, or the like. Without being bound by theory, when R⁹ is C₅ or greater, enhanced cell membrane penetration of the alkyl moiety into the hydrophobic portion of a cell membrane (such as a viral cell) can occur promoting lysis of the viral cell. Additionally, the cationic nitrogen moieties can provide coulombic interactions of the compound (such as the quaternary ammonium moieties) with the cell membrane surface (such as the phosphate moieties of the phospholipid bilayer) further promoting lysis of the viral cell. Furthermore, the quaternary ammonium salt can provide sufficient hydrophilicity so that the alkyl moieties attached to the quaternary ammonium salt do not become substantially buried within the core of the three dimensional structure (e.g., when the composition has the three dimensional structure of nanoworm or nanorod).

In some aspects, which can be combined with any other aspect described herein, R⁹ is C₁-C₆ alkylyne, e.g., C₁ alkylyne, C₂ alkylyne, C₃ alkylyne, C₄ alkylyne, C₅ alkylyne, C₆ alkylyne, or the like. In some aspects, which can be combined with any other aspect described herein, R⁹ is azole. In some aspects, which can be combined with any other aspect described herein, R⁹ is a an oligomer of guanidine, e.g., diguanidine. In some aspects, which can be combined with any other aspect described herein, R⁹ is a diguanidine represented by the structure:

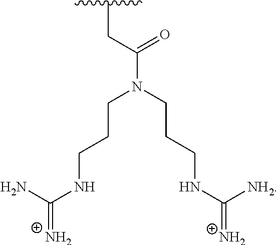 [SMILES: *CC(=O)N(CCCNC(N)=[NH2+])CCCNC(N)=[NH2+]]

In some aspects, which can be combined with any other aspect described herein, R⁹ is polygalactose having the structure:

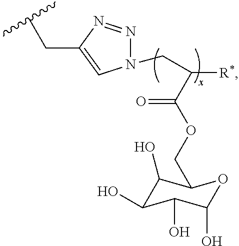

wherein x is an integer of 1 to 20, e.g., an integer of 10, and R* is hydrogen, —OH, or

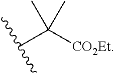 [SMILES: *C(C)(C)C(=O)OCC]

In some aspects, which can be combined with any other aspect described herein, R⁹ is coumarin, such as 7-hydroxycoumarin. In some aspects, which can be combined with any other aspect described herein, R⁹ is a combination of azole and polygalactose (e.g., polygalactose-substituted azole). In some aspects, which can be combined with any other aspect described herein, R⁹ is a combination of azole and coumarin (e.g., 3-azido-7-hydroxycoumarin), having the formula:

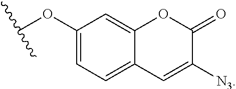 [SMILES: *Oc1ccc2cc(N=[N+]=[N-])c(=O)oc2c1]

For example, and without limitation, q is 1 and R⁹ is diguanidine.

In at least one aspect, which can be combined with any other aspect described herein, the compound is represented by formula (I):

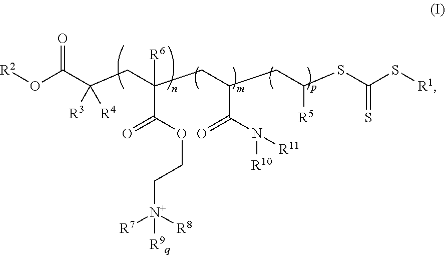

or a pharmaceutically acceptable salt thereof, where n, m, and p are each independently integers of 1 to 100. Each instance of q is independently an integer of 0 or 1. In some aspects, which can be combined with any other aspect described herein, n is an integer of 1 to 100, e.g., 20 to 50, 25 to 35, or the like. In some aspects, n is 30. In some aspects, which can be combined with any other aspect described herein, m is an integer of 1 to 100, e.g., 30 to 60, 35 to 55, or the like. In some aspects, which can be combined with any other aspect described herein, n is 45. In some aspects, which can be combined with any other aspect described herein, p is an integer of 1 to 100, e.g., 45 to 55, 48 to 52, or the like. In some aspects, which can be combined with any other aspect described herein, p is 50. In some aspects, which can be combined with any other aspect described herein, p is 52.

In some aspects, which can be combined with any other aspect described herein, R², R³, and R⁴ of Formula (I) are each independently hydrogen. In some aspects, which can be combined with any other aspect described herein, R², R³, and R⁴ are each independently C₁-C₂₀ alkyl, e.g., methyl, ethyl, propyl, butyl, pentyl, hexyl, heptyl, octyl, nonyl, decyl, or the like. In some aspects, which can be combined with any other aspect described herein, R² and R³ are hydrogen and R⁴ is C₁-C₂₀ alkyl, e.g., methyl, ethyl, propyl, butyl, pentyl, hexyl, heptyl, octyl, nonyl, decyl, or the like. In some aspects, which can be combined with any other aspect described herein, R² and R⁴ are hydrogen and R³ is C₁-C₂₀ alkyl, e.g., methyl, ethyl, propyl, butyl, pentyl, hexyl, heptyl, octyl, nonyl, decyl, or the like. In some aspects, which can be combined with any other aspect described herein, R³ and R⁴ are hydrogen and R² is C₁-C₂₀ alkyl, e.g., methyl, ethyl, propyl, butyl, pentyl, hexyl, heptyl, octyl, nonyl, decyl, or the like. In some aspects, which can be combined with any other aspect described herein, R² is hydrogen and R³ and R⁴ are independently C₁-C₂₀ alkyl, e.g., methyl, ethyl, propyl, butyl, pentyl, hexyl, heptyl, octyl, nonyl, decyl, or the like. In some aspects, which can be combined with any other aspect described herein, R³ is hydrogen and R² and R⁴ are independently C₁-C₂₀ alkyl, e.g., methyl, ethyl, propyl, butyl, pentyl, hexyl, heptyl, octyl, nonyl, decyl, or the like. In some aspects, which can be combined with any other aspect described herein, R² and R⁴ are methyl, and R³ is hydrogen. In some aspects, which can be combined with any other aspect described herein, R⁴ is hydrogen and R² and R³ are independently C₁-C₂₀ alkyl, e.g., methyl, ethyl, propyl, butyl, pentyl, hexyl, heptyl, octyl, nonyl, decyl, or the like. In some aspects, which can be combined with any other aspect described herein, R² and R³ are methyl, and R⁴ is hydrogen.

In some aspects, which can be combined with any other aspect described herein, R⁵ of Formula (I) is C₆ aryl. In some aspects R⁵ is phenyl. In some aspects, phenyl can be substituted with 1, 2, 3, 4, or 5 moieties, such as, which can be combined with any other aspect described herein, independently C₁-C₁₀ alkyl moieties.

In some aspects, which can be combined with any other aspect described herein, R⁶, R⁷, and R⁸ of Formula (I) are each independently C₁-C₆ alkyl, e.g., methyl, ethyl, propyl, butyl, pentyl, hexyl, or the like. In some aspects, which can be combined with any other aspect described herein, R⁶, R⁷, and R⁸ are each methyl. In some aspects, which can be combined with any other aspect described herein, R⁶ and R⁷ are hydrogen and R⁸ is C₁-C₆ alkyl, e.g., methyl, ethyl, propyl, butyl, pentyl, hexyl, or the like. In some aspects, which can be combined with any other aspect described herein, R⁶ and R⁸ are hydrogen and R⁷ is C₁-C₆ alkyl, e.g., methyl, ethyl, propyl, butyl, pentyl, hexyl, or the like. In some aspects, which can be combined with any other aspect described herein, R⁷ and R⁸ are hydrogen and R⁶ is C₁-C₆ alkyl, e.g., methyl, ethyl, propyl, butyl, pentyl, hexyl, or the like. In some aspects, which can be combined with any other aspect described herein, R⁶ is hydrogen and R⁷ and R⁸ are independently C₁-C₆ alkyl, e.g., methyl, ethyl, propyl, butyl, pentyl, hexyl, or the like. In some aspects, which can be combined with any other aspect described herein, R⁷ is hydrogen and R⁶ and R⁸ are independently C₁-C₆ alkyl, e.g., methyl, ethyl, propyl, butyl, pentyl, hexyl, or the like. In some aspects, which can be combined with any other aspect described herein, R⁸ is hydrogen and R⁶ and R⁷ are independently C₁-C₆ alkyl, e.g., methyl, ethyl, propyl, butyl, pentyl, hexyl, or the like.

In some aspects, which can be combined with any other aspect described herein, q of Formula (I) is 0 or 1. In some aspects, which can be combined with any other aspect described herein, at least one instance of R⁹ (of the plurality) is C₁-C₁₆ alkyl, e.g., methyl, ethyl, propyl, butyl, pentyl, hexyl, heptyl, octyl, nonyl, decyl, or the like. In some aspects, which can be combined with any other aspect described herein, R⁹ is C₁-C₆ alkylyne, e.g., C₁ alkylyne, C₂ alkylyne, C₃ alkylyne, C₄ alkylyne, C₅ alkylyne, C₆ alkylyne, or the like. In some aspects, which can be combined with any other aspect described herein, R⁹ is azole. In some aspects, R⁹ is an oligomer of guandine, e.g., diguanidine. In some aspects, which can be combined with any other aspect described herein, R⁹ is a diguanidine represented by the structure:

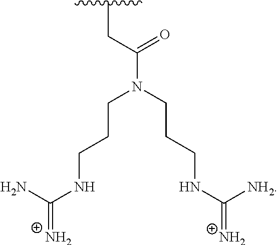 [SMILES: *CC(=O)N(CCCNC(N)=[NH2+])CCCNC(N)=[NH2+]]

In some aspects, which can be combined with any other aspect described herein, R⁹ of Formula (I) is a polysachharide, such as a polygalactose. In some aspects, which can be combined with any other aspect described herein, polygalactose has the structure:

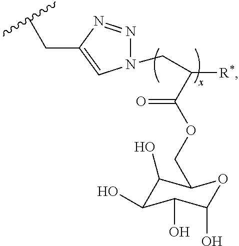

wherein x is an integer of 1 to 20, e.g., an integer of 10, and R* is hydrogen, —OH, or

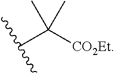 [SMILES: *C(C)(C)C(=O)OCC]

In some aspects, which can be combined with any other aspect described herein, R⁹ of Formula (I) is coumarin, such as 7-hydroxycoumarin. In some aspects, which can be combined with any other aspect described herein, R⁹ is a combination of azole and polygalactose (e.g., polygalactose-substituted azole). In some aspects, which can be combined with any other aspect described herein, R⁹ is a combination of azole and coumarin (e.g., 3-azido-7-hydroxycoumarin), having the formula:

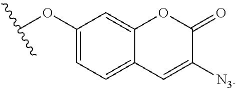 [SMILES: *Oc1ccc2cc(N=[N+]=[N-])c(=O)oc2c1]

In at least one aspect, which can be combined with any other aspect described herein, q is 1 and R⁹ is diguanidine.

In some aspects, which can be combined with any other aspect described herein, each of R¹⁰ and R¹¹ of Formula (I) is independently hydrogen or C₁-C₂₀ alkyl, where at least one of R¹⁰ or R¹¹ is C₁-C₂₀ alkyl, such as methyl, ethyl, n-propyl, or isopropyl. In at least one aspect, which can be combined with any other aspect described herein, at least one of R¹⁰ or R¹¹ is isopropyl.

In some aspects, which can be combined with any other aspect described herein, the nanostructure can be represented by formula (II):

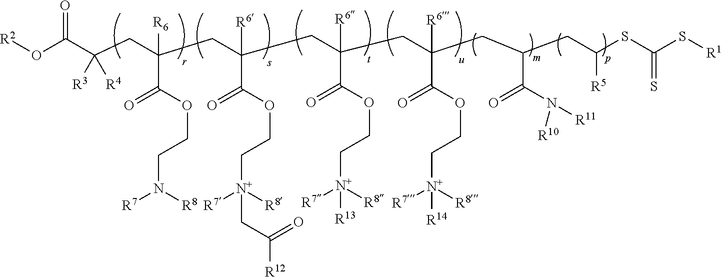

(II), or a pharmaceutically acceptable salt thereof. In some aspects, which can be combined with any other aspect described herein, each of r, s, t, u, m, and p of Formula (II) are independently 1-100. In some aspects, which can be combined with any other aspect described herein, r is an integer of 1 to 100, e.g., 5 to 40, 5 to 15, or the like. In some aspects, which can be combined with any other aspect described herein, r is 11 or 12. In some aspects, which can be combined with any other aspect described herein, s is an integer of 1 to 100, e.g., 5 to 40, 5 to 15, or the like. In some aspects, which can be combined with any other aspect described herein, s is 11 or 12. In some aspects, which can be combined with any other aspect described herein, t is an integer of 1 to 100, e.g., 1 to 20, 1 to 5, or the like. In some aspects, which can be combined with any other aspect described herein, t is 3 or 4. In some aspects, which can be combined with any other aspect described herein, u is an integer of 1 to 100, e.g., 1 to 20, 1 to 5, or the like. In some aspects, which can be combined with any other aspect described herein, u is 3 or 4. In some aspects, which can be combined with any other aspect described herein, m is an integer of 1 to 100, e.g., 25 to 60, 35 to 55, or the like. In some aspects, which can be combined with any other aspect described herein, m is 45. In some aspects, which can be combined with any other aspect described herein, p is an integer of 1 to 100, e.g., 30 to 70, 40 to 60, or the like. In some aspects, which can be combined with any other aspect described herein, p is 50.

In some aspects, which can be combined with any other aspect described herein, R¹ of Formula (II) is hydrogen or C₁-C₂₀ alkyl. In some aspects, which can be combined with any other aspect described herein, R¹ is butyl. In some aspects, which can be combined with any other aspect described herein, R², R³, and R⁴ are each independently hydrogen. In some aspects, which can be combined with any other aspect described herein, R², R³, and R⁴ are each independently C₁-C₂₀ alkyl, e.g., methyl, ethyl, propyl, butyl, pentyl, hexyl, heptyl, octyl, nonyl, decyl, or the like. In some aspects, which can be combined with any other aspect described herein, R² and R³ are hydrogen and R⁴ is C₁-C₂₀ alkyl, e.g., methyl, ethyl, propyl, butyl, pentyl, hexyl, heptyl, octyl, nonyl, decyl, or the like. In some aspects, which can be combined with any other aspect described herein, R² and R⁴ are hydrogen and R³ is C₁-C₂₀ alkyl, e.g., methyl, ethyl, propyl, butyl, pentyl, hexyl, heptyl, octyl, nonyl, decyl, or the like. In some aspects, which can be combined with any other aspect described herein, R³ and R⁴ are hydrogen and R² is C₁-C₂₀ alkyl, e.g., methyl, ethyl, propyl, butyl, pentyl, hexyl, heptyl, octyl, nonyl, decyl, or the like. In some aspects, which can be combined with any other aspect described herein, R² is hydrogen and R³ and R⁴ are independently C₁-C₂₀ alkyl, e.g., methyl, ethyl, propyl, butyl, pentyl, hexyl, heptyl, octyl, nonyl, decyl, or the like. In some aspects, which can be combined with any other aspect described herein, R³ is hydrogen and R² and R⁴ are independently C₁-C₂₀ alkyl, e.g., methyl, ethyl, propyl, butyl, pentyl, hexyl, heptyl, octyl, nonyl, decyl, or the like. In some aspects, which can be combined with any other aspect described herein, R² and R⁴ are methyl, and R³ is hydrogen. In some aspects, which can be combined with any other aspect described herein, R⁴ is hydrogen and R² and R³ are independently C₁-C₂₀ alkyl, e.g., methyl, ethyl, propyl, butyl, pentyl, hexyl, heptyl, octyl, nonyl, decyl, or the like. In some aspects, which can be combined with any other aspect described herein, R² and R³ are methyl, and R⁴ is hydrogen.

In some aspects, which can be combined with any other aspect described herein, R⁵ of Formula (II) is C₆ aryl. In some aspects, which can be combined with any other aspect described herein, R⁵ is phenyl. In some aspects, which can be combined with any other aspect described herein, phenyl can be substituted with between 1, 2, 3, 4, or 5 moieties, such as independently C₁-C₁₀ alkyl moieties.

In some aspects, which can be combined with any other aspect described herein, each of R⁶, R^{6′}, R^{6″}, and R^{6′″} of Formula (II) are each independently C₁-C₆ alkyl, e.g., methyl, ethyl, propyl, butyl, pentyl, hexyl, or the like. In some aspects, which can be combined with any other aspect described herein, R⁶, R^{6′}, R^{6″}, and R^{6′″} are each methyl. In some aspects, which can be combined with any other aspect described herein, each of R⁷, R^{7′}, R^{7″}, and R^{7′″} are each independently C₁-C₆ alkyl, e.g., methyl, ethyl, propyl, butyl, pentyl, hexyl, or the like. In some aspects, which can be combined with any other aspect described herein, R⁷, R^{7′}, R^{7″}, and R^{7′″} are each methyl. In some aspects, which can be combined with any other aspect described herein, each of R⁸, R^{8′}, R^{8″}, and R^{8′″} are each independently C₁-C₆ alkyl, e.g., methyl, ethyl, propyl, butyl, pentyl, hexyl, or the like. In some aspects, which can be combined with any other aspect described herein, R⁸, R^{8′}, R^{8″}, and R^{8′″} are each methyl.

In some aspects, which can be combined with any other aspect described herein, each of R¹⁰ and R¹¹ of Formula (II) is independently hydrogen or C₁-C₂₀ alkyl, where at least one of R¹⁰ or R¹¹ is C₁-C₂₀ alkyl, such as methyl, ethyl, n-propyl, or isopropyl. In at least one aspect, which can be combined with any other aspect described herein, at least one of R¹⁰ or R¹¹ is isopropyl.

In some aspects, which can be combined with any other aspect described herein, R¹² of Formula (II) is an oligomer of guandine, e.g., diguanidine. In some aspects, which can be combined with any other aspect described herein, R¹² is a diguanidine represented by the structure:

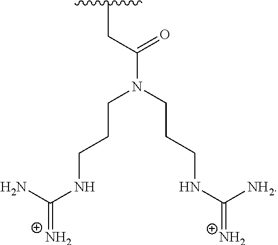 [SMILES: *CC(=O)N(CCCNC(N)=[NH2+])CCCNC(N)=[NH2+]]

In some aspects, which can be combined with any other aspect described herein, R¹³ of Formula (II) is C₁-C₆ alkylyne, e.g., C₁ alkylyne, C₂ alkylyne, C₃ alkylyne, C₄ alkylyne, C₅ alkylyne, C₆ alkylyne, or the like. In some aspects, which can be combined with any other aspect described herein, R¹³ is C₃ alkylyne. In some aspects, which can be combined with any other aspect described herein, R¹³ is a combination of azole and polygalactose (e.g., polygalactose-substituted azole) having the formula:

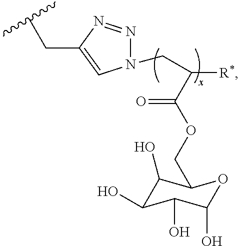

wherein x is an integer of 1 to 20, e.g., an integer of 10, and R* is hydrogen, —OH, or

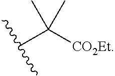 [SMILES: *C(C)(C)C(=O)OCC]

In some aspects, which can be combined with any other aspect described herein, R¹³ is a combination of azole and coumarin (e.g., 3-azido-7-hydroxycoumarin) having the formula:

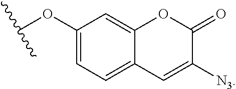 [SMILES: *Oc1ccc2cc(N=[N+]=[N-])c(=O)oc2c1]

In some aspects, which can be combined with any other aspect described herein, at least one instance of R¹⁴ (of the plurality) of Formula (II) is C₁-C₁₆ alkyl, e.g., methyl, ethyl, propyl, butyl, pentyl, hexyl, heptyl, octyl, nonyl, decyl, or the like. In some aspects, which can be combined with any other aspect described herein, R¹⁴ is octyl.

Although the aminoethylacrylate units of formula (II) are shown as blocks, it is to be understood that the unsubstituted and substituted aminoethylacrylate units can be dispersed randomly along the overall block of aminoethylacrylate units and that the integer values of r, s, t, and u correspond to the overall numbers of each unit not necessarily as a block. Random placement of aminoethylacrylate units and substituted aminoethylacrylate units can be obtained by functionalization methods described herein. Likewise, polyamide units of formula (II) are shown as blocks, but can be alternatively present as random units along with the aminoethyacrylate units. Random placement of polyamide units and aminoethylacrylate units (substituted or unsubstituted) can be obtained by polymerization methods described herein.

### Nanostructure Coating

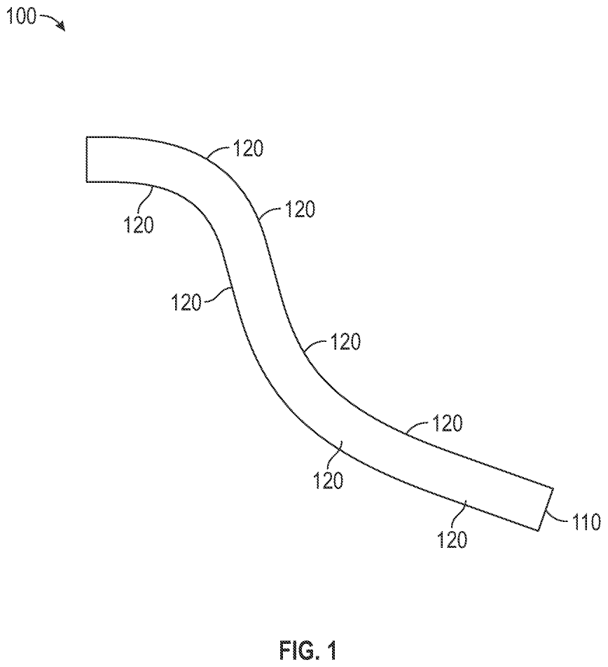

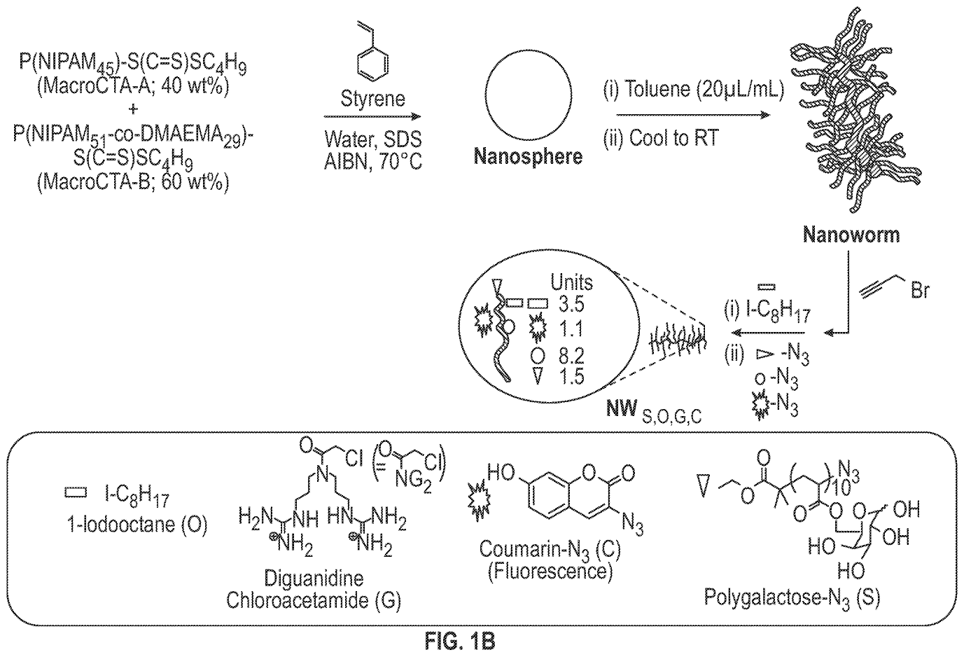

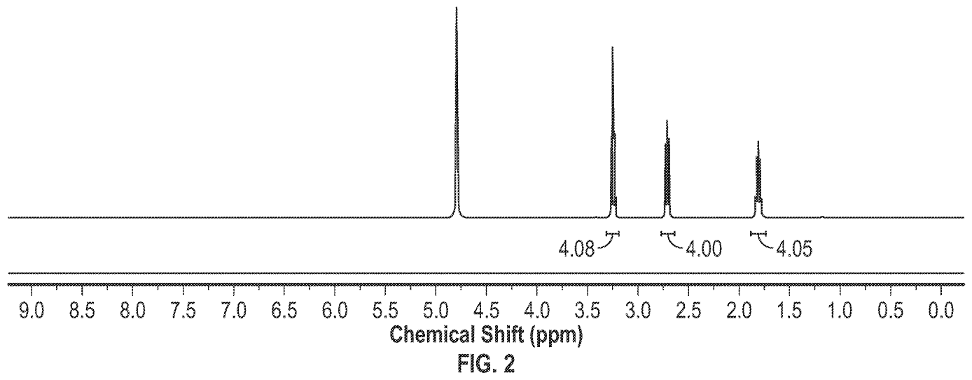

FIG. 1 is a schematic view illustrating a nanostructure, such as a nanoworm 100 according to certain aspects. A backbone or core 110 of the nanoworm 100 includes alkene units and the macroCTA polymer units. The nanoworm 100 includes functional groups 120 from the macroCTA polymer units. Each of the functional groups 120 groups is a component from a reversible addition-fragmentation chain-transfer (RAFT) agent, which can be pre-functionalized or post-functionalized. In some examples, each of the functional groups 120 groups is selected to modify the capture and inactivation/deactivation efficiency of the nanoworm 100 and/or to modify the responsiveness (e.g., temperature, pH, salinity concentration, light, and/or combinations thereof) of the nanoworm 100.

### Three Dimensional Structures of a Compound or Composition

Compounds or compositions (e.g., two or more different nanostructures) of the present disclosure can have a 3-dimensional structure that is a nanoworm or nanorod. A nanorod can have an aspect ratio (i.e., length:width ratio) of about 10:1 to about 1000:1, such as about 10:1 to about 100:1, such as about 25:1 to about 75:1. A nanorod can have a diameter of about 10 nm to about 20 nm and a length of about 100 nm to about 10 microns, such as about 1 micron to about 2 microns. A nanoworm has an aspect ratio of greater than about 1000:1.

Compounds and compositions of the present disclosure can also have a three-dimensional structure that is a sphere, vesicle, donut or lamella sheet. The three-dimensional structure of compositions of the present disclosure can be stable in water for long periods of time (e.g., a nanoworm stable for a year or more at room temperature) and can also be freeze-dried and rehydrated without structural reorganization. For example, a nanoworm solution can be freeze-dried to give dry powder. The freeze-dried product can be rehydrated in Milli-Q water at −8 wt % for 2 h. The ability of a composition of the present disclosure to be freeze-dried provides stable transportation of compositions of the present disclosure.

### Synthesis of the Nanoworm

Methods of forming a nanostructures is provided. In some aspects, the polymer nanostructures having nanoworm morphology can be produced directly in water using an emulsion polymerization method. The method includes introducing, in a reactor, a styrene monomer with (1) a first polymer having N-alkylacrylamide units and (2) a second polymer having N,N-(dialkylamino)(divalent alkyl)alkylacrylate units and N-alkylacrylamide units to form a mixture. The polystyrene block can provide a high glass transition temperature (Tg) component (100% polystyrene has a Tg of about 100° C.). The high Tg provides stability to the nanostructures at body temperature. Furthermore, the poly(N-isopropylacrylamide) (poly-NIPAM) block can provide a nanoworm (or nanorod) three dimensional conformation under aqueous conditions, e.g. an aqueous solution containing sodium dodecyl sulfate (SDS). In some aspects, introducing the styrene monomer with the first polymer having N-alkylacrylamide units and the second polymer having N,N-(dialkylamino)(divalent alkyl)alkylacrylate units and N-alkylacrylamide units is performed at a temperature of about −10° C. to about 10° C. The first polymer can consist of: (1) the N-alkylacrylamide units as N-isopropylacrylamide units, (2) a moiety represented by the formula:

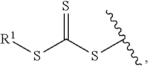

where R¹ is alkyl, and (3) a moiety represented by the formula:

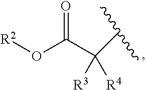

where R² is alkyl (branched or linear, substituted or unsubstituted) and R³ and R are independently hydrogen or alkyl (branched or linear, substituted or unsubstituted).

In some aspects, the first polymer is free of N,N-(dialkylamino)(divalent alkyl)alkylacrylate units. The second polymer consists of (1) the N,N-(dialkylamino)(divalent alkyl)alkylacrylate units as N,N-(dimethylamino)ethyl methacrylate units, the N-alkylacrylamide units as N-isopropylacrylamide units, a moiety represented by the formula:

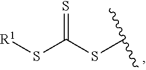

where R^{t} is alkyl, and (2) a moiety represented by the formula:

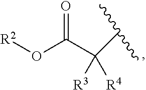

where R² is alkyl (branched or linear, substituted or unsubstituted) and R³ and R⁴ are independently hydrogen or alkyl (branched or linear, substituted or unsubstituted).

The method includes introducing an initiator compound to the mixture to form a second mixture having the nanostructure. The initiator compound is a peroxide, a hydroperoxide, or an azo initiator. In some examples, the initiator is azobisisobutyronitrile.

The nanostructures can be coupled with a variety of functional groups, including the hydrophobic octane (O), diguanidine (DG), a fluorescence probe (C) (e.g., coumarin), and polysaccharide, e.g., polygalactose (S) as shown in FIG. 1B. Binding to the highly glycosylated spike S protein targeted through (i) the strong multivalent binding with polygalactose, and (ii) electrostatic interactions between the negatively charged viral particles and the positively charged guanidine and N,N-(dimethylamino)ethyl methacrylate (DMAEMA) groups. The attached octane groups facilitate the rupture of the viral membrane, in which the viral mRNA can either be degraded by the diguanidine groups or electrostatically captured by the polymer coating. The polymer nanostructures described herein can be coated on surfaces, including a surgical mask, and readily inactivate sense RNA viruses, e.g., the influenza A virus, ancestral SARS-CoV-2 isolate, alpha variant, and omicron variant.

In certain aspects, the nanostructure includes a copolymer of a macro chain transfer agent (macroCTA) polymer units and alkene units. A macroCTA polymer is a polymer formed by RAFT using a RAFT agent in the polymerization of one or more ethylenically unsaturated monomers.

In some examples, two macro-chain transfer RAFT poly(N-isopropylacrylamide) (PNIPAM) agents can be produced from a single non-functional RAFT agent. The emulsion polymerization using the two macro-chain transfer agents in the presence of styrene (e.g., initiated by azobisisobutyronitrile (AIBN) at 70° C. in a 500 mL reactor) can produce spherical particles consisting of two block copolymers of MacroCTAs A and B with polystyrene at an approximately 8 wt % of polymer in water. After the addition of a small amount of plasticizer for polystyrene, the spherical nanoparticles can transform into nanoworms upon cooling to room temperature. The synthesis process is denoted as the temperature directed morphology transformation (TDMT) method, and can be used to produce a wide range of polymer nanoparticles including worms, rods, vesicles, toroids, tadpoles, stacked toroidal nanorattles, other morphologies, or combinations thereof.

The polymer nanoworms can then be coupled to the functional groups (0, G) via quaternization, dialyzed, freeze-dried and rehydrated with water to make a 1.5 wt % polymer/water dispersion. The polymer nanoworms can then be coupled to the functional groups (S and C), via a copper catalyzed azide alkyne cycloaddition (CuAAC) reaction. The CuAAC can use a combination of CuSO₄ and sodium ascorbate. The samples can then be dialyzed, free-dried and rehydrated with water to make a 1.5 wt % polymer/water dispersion. The polymer (NW_{S,O,C,G}) dispersion can then be coated onto surfaces ranging from 1 to 5 sprays. The amount of polymer per area can be determined by measuring the dry weight of polymer on the surface of a glass slide using a microbalance.

### Synthesis of the Nanorod

Nanorods can be obtained by temperature directed morphology transformation (TDTM) and ultrasound cutting of the nanoworms. In at least one aspect, a 6 mL latex solution of a nanoworm can be transferred to 2 hot vials (3 mL each) with 60 μL of toluene in each vial. These vials can then be sealed and shaken. The suspensions in these vials can be cooled to 23° C. The solutions can be cooled from 70° C. to 15° C. for about 30 minutes. The nanostructure can be characterized by transmission electron microscopy (TEM) to confirm the formation of worm-like nanostructures. To form the rods, the worms can be diluted by adding 10 mL of Milli-Q water, and cut using an ultrasound probe (with the pulse of 3 s on and 2 s off as one pulse cycle) for 3 minutes in an ice-bath at 35% amplitude (3 mm Tapered Micro Tip, VC-750 system from Sonics & Materials). After ultrasound cutting, the nanostructure can be characterized by TEM again to confirm the formation of rods.

Ultrasonic cutting of nanoworms to nanorods can also be carried out by applying probed ultrasound with different pulse cycles (15 seconds on and 10 seconds off as one pulse cycle), (B) 12 cycles (3 min), (C) 36 cycles (9 min) and (D) 48 cycles (12 min).

In at least one aspect, heating a nanoworm or nanorod composition of the present disclosure above the lower critical solution temperature (LCST) (e.g., about 37° C.) of the PNIPAM block can produce a gel that when cooled can dissociate back to a sol; a process that is reversible. Nanoworms can form gels at a minimum weight fraction of about 0.1 wt % to about 10 wt % of nanoworms of the total volume of the aqueous solution, such as about 1 wt % to about 8 wt %, in an aqueous solution. Nanorods can form gels at a minimum weight fraction of about 2 wt % to about 16 wt % of nanorods in an aqueous solution. There is a distribution of lengths (aspect ratios) of nanostructures in a nanostructure sample, and gel formation can depend on the aspect ratio(s) present the nanostructure sample. Without being bound by theory, gels are advantageous because they can be dissociated with increased temperature (such as from room temperature to body temperature of a subject, such as a human) to allow the worm 3-dimensional structure to dissociate and move through the blood.

The weight percentages of the nanorods in water at which the gel can be formed at 37° C. can be measured as follows: generally, the freeze-dried nanorods (e.g., 20 mg) can be redispersed in Milli-Q water by vortexing at 30 wt % of the nanorod in the water in a 1.5 ml Eppendorf tube at 25° C. The tube can then be capped and immersed in a water bath at 37° C. for 2 min. The tube can then be flipped under the water bath to observe the gel formation. Gel formation is defined as no observable flowing of the fluid within 30 seconds. The weight percentage can be lowered by adding more Milli-Q water and vortexing. The gel formation can then be checked again. The minimum weight percentage of the nanorods, for example, in water to form the gel at 37° C. is defined as wt % to form the gel.

### Methods for Depositing Compounds and Compositions

Compounds and compositions of the present disclosure can be deposited onto a surface of an object by any suitable deposition method. A surface of an object can be any suitable surface of any suitable object. A surface can be porous or nonporous. Deposition methods can include one or more of painting, dipping, spraying, marking, taping, brush coating, spin coating, roll coating, doctor-blade coating. Before deposition, a compound or composition of the present disclosure can be diluted in an aqueous solvent, such as a polar solvent, a protic solvent, an aprotic solvent, or the like, e.g., water. After deposition, the solvent can then evaporate at room temperature forming a compound/composition layer on the object.

In at least one aspect, the object is an interior surface of an aircraft/spacecraft/boat or an air filter surface of an aircraft/spacecraft/boat, such as a surface of an air-conditioning or filtration system. The object can be a floor surface, seat surface, including but not limited to the arm/head rest, seat buckle, seat pocket, tray table, overhead bin surface, ceiling surface, trim surface, screen surface, window surface, door surface and/or door handle surface of the interior of an aircraft.

In at least one aspect, a compound or composition of the present disclosure is applied, (e.g., sprayed, deposited, printed, etc.) onto a surface of an object for about 1 second to about 10 minutes, such as about 30 seconds to about 2 minutes. In at least one aspect, a compound or composition is applied (e.g., sprayed) onto a surface of an object in an amount of about 1 mL to about 25 kL, such as about 100 L to about 1 kL. The compound or composition of the present disclosure can be applied, in which the surface will appear wet due to the solvent of the composition.

Compounds or compositions of the present disclosure disposed on an object prevents, reduces, and/or eliminates the presence of bacteria and viruses (such as SARS-CoV-2), which can prevent, reduce, and/or eliminate human contact with such bacteria and viruses. The compounds or compositions of the present disclosure bind to the bacteria and/or virus as described herein, in which a conformational change of the nanoworm and/or nanorod occurs such that the membrane of the bacteria and/or virus is ruptures causing inactivation of the bacteria and/or virus. The inactivation reduces the amount of human contact with the bacteria and/or virus.

Compositions can have any suitable pH, such as a pH of between about 6.5 to about 7.4. For example, a pH of about 6.5 mimics the pH of a mucosal droplet. The composition can have a pH that is capable of interacting with a human, in which the pH is within biological limitations for a human. Accordingly, the composition can be suitable for administration on a biological membrane, such as a mucosal membrane of a human. Without wishing to be bound by theory, the pH of the composition can assist in the antibacterial or antiviral capabilities of the composition, in which a pH that mimics the pH of the mucosal droplet may assist in reducing the presence of a bacteria or virus.

Compositions comprising nanostructures (e.g., nanorods or nanoworms) of the present disclosure are advantageous to deposit onto a surface because, for example, an antibacterial and antiviral compound can be applied as a single layer, maintaining efficacy of both compounds. Applying a composition having a nanostructure as a single layer also reduces cost and time of applying the compounds to a surface, as compared to application of two or more layers. By using a water-based solution, end-user safety is achieved and thus time savings and cost savings for application to a surface will be realized. Alternatively, in some examples, thicker layers and/or multiple layers can be applied. In some examples, a surface is refreshed or replenished with one or more additional layers of nanostructure composition at a time after application of a first application (one layer or multiple layers) based on a desired amount of antibacterial or antiviral protection.

In some aspects, a method includes impregnating a fabric or fiber, e.g., woven or non-woven. In some aspects, methods of disposing a nanostructure onto a surface are described herein. In some aspects, a method includes disposing a layer of a solution comprising the nanostructure on the surface. The nanostructure includes a compound or salt thereof.

The surface to be treated with the coating can be any suitable surface capable of being coated or impregnated of any suitable object capable of being coated or impregnated. In some non-limiting aspects, an object is a mask and a surface is an interior portion of a fuselage of an aircraft, or any other suitable surface. In some examples, a surface is a surface (interior or exterior) of an aircraft, a ship, a train, a terminal (e.g., bus, train, airport, etc.), or a spacecraft.

In some aspects, the emulsion or solution has a concentration of the nanostructure of about 0.5 wt % to about 3 wt % of nanostructure in the total volume of the solution.

### Methods for Use as a Pharmaceutical Drug

In some aspects, the present disclosure further provides methods for treating a condition in a subject having or susceptible to having such a condition, by administering to the subject a therapeutically-effective amount of one or more compounds or compositions of the present disclosure. In at least one aspect, the treatment is preventative treatment. In another aspect, the treatment is palliative treatment. In another aspect, the treatment is restorative treatment.

A method for treating a condition can include administering to a subject a therapeutically effective amount of a nanostructure, or pharmaceutically acceptable salt thereof (or a composition having a nanostructure, or pharmaceutically acceptable salt thereof).

Methods for treating a condition are described herein. In some aspects, a method includes administering to a subject a therapeutically effective amount of a nanostructure.

A coating described herein can be scaled and applied directly to surfaces as a water solution to act as an effective virucidal agent that renders SARS-CoV-2 variants of concern non-infectious. The design of the polygalactose (e.g., about 2 to about 20 galactose units) attached to the polymer nanostructure and potential specific bonding interactions with highly glycosylated SARS-CoV-2 provide a binding motif independent of the virus variant and mutations found in the virus spike attachment glycoprotein. In some aspects, a polygalactose has greater than 20 galactose units, e.g., up to about 1,000 galactose units. The polygalactose binding in combination with the octane moieties and the responsive nature of the nanostructures that mechanically attach to and disrupt the viral particles, rendering them non-infectious. Without being bound by theory, SARS-CoV-2 viral RNA genome can either degrade as a result of the diguanidine groups or be electrostatically captured by the cationic groups attached to the polymer that then allows natural degradation. It has been discovered that the viral RNA genome cannot be detected after interaction of the viruses with the polymer coated surfaces which demonstrates complete virucidal activity of the polymer. It is believed that the polymer coating provides inactivation of newly emerging SARS-CoV-2 variants of concern while still maintaining the ability to be re-designed via functionalization to target other viruses. Finally, the polymer was found to be non-toxic by oral ingestion in rats and had little or no skin sensitization when applied on the skin of mice, indicating the potential safe use as a component of personal protective equipment or high touch-point surfaces that comes into contact with skin. The nanostructure composition can also be administered to subjects as a therapeutic treatment.

### 1. Conditions

The conditions that can be treated in accordance with the present disclosure include, but are not limited to, conditions caused by a toxin (such as an antigen) and inflammatory disorders such as septic shock. The conditions that can be treated in accordance with the present disclosure include, but are not limited to viral infections, bacterial infections, chronic inflammatory disorders, acute inflammatory disorders, and cancers. In some aspects, the condition to be treated includes a bacterial infection, a viral infection, or a cancer immunotherapy. Cancer immunotherapy can include cervical cancers such as those resulting from an infection of the cervix with human papillomavirus.

Viral infections can include those caused by Ebola, influenza, SARS (such as SARS CoV-2), Noro (gastro), or Zika. Viral infections can include viral respiratory infections (e.g., of the nose, throat, upper airways, or lungs) such as pneumonia, laryngotracheobronchitis, bronchiolitis. Viral infections can include viral gastrointestinal infections such as gastroenteritis caused by a norovirus or rotavirus. Viral infections can include viral liver infections such as hepatitis. Viral infections can include viral nervous system infections such as encephalitis caused by rabies or West Nile virus. Viral infections include warts and/or infections caused by human papilloma virus (HPV). Viral infections can include infections that cause cancer such as infections caused by Epstein-Barr virus, Hepatitis B, Hepatitis C, Herpesvirus 8, or Human papillomavirus. Symptoms of viral infections can include fever, muscle aches, coughing, sneezing, runny nose, headache, chills, diarrhea, vomiting, rash, or weakness.

Bacterial infections can include pneumonia, meningitis, food poisoning, and bacterial skin infections such as those caused by Staphylococcus or Streptococcus, cellulitis, folliculitis, impetigo, and boils. Bacterial infections (e.g., by food poisoning) can include infections caused by Escherichia coli (E. coli), Campylobacter jejuni (C. jejuni), Clostridium botulinum (C. botulinum), Listeria monocytogenes (L. monocytogenes), Salmonella, and Vibrio. Bacterial infections can include bacterial meningitis, otitis media, urinary tract infection, and respiratory tract infections such as sore throat, bronchitis, sinusitis, and pneumonia. Symptoms of bacterial infections can include nausea, vomiting, diarrhea, fever, chills, and abdominal pain.

In some aspects, the methods described herein are used to treat patients with disorders arising from dysregulated cytokine, enzymes and/or inflammatory mediator production, stability, secretion, posttranslational processing. Examples of cytokines that can be dysregulated include interleukins 1, 2, 6, 8, 10, 12, 17, 22, and 23 along with tumor necrosis factor alpha and interferons alpha, beta, and gamma. Examples of inflammatory mediators that can be dysregulated include nitric oxide, prostaglandins, and leukotrienes. Examples of enzymes include cyclo-oxygenase, nitric oxide synthase, and matrixmetalloprotease.

Examples of inflammatory conditions relevant to the technology include, but are not limited to, sepsis, septic shock, endotoxic shock, exotoxin-induced toxic shock, gram negative sepsis, and toxic shock syndrome. Inflammatory conditions can include those experienced by immunosuppressed individuals, and can also include “superbugs”, including bacterial and viral strains resistant to current therapeutics.

### 2. Subjects

Suitable subjects to be treated according to the present disclosure include mammalian subjects. Mammals according to the present disclosure include, but are not limited to, human, canine, feline, bovine, caprine, equine, ovine, porcine, rodents, lagomorphs, primates, and the like, and encompass mammals in utero. Subjects may be of either gender and at any stage of development.

### 3. Administration and Dosing

Compounds or compositions of the present disclosure can be administered to a subject in a therapeutically effective amount.

Compounds or compositions of the present disclosure can be administered by any suitable route in the form of a pharmaceutical composition adapted to such a route, and in a dose effective for the treatment intended. An effective dosage is typically in the range of about 0.001 to about 100 mg per kg body weight per day, such as about 0.01 to about 30 mg/kg/day, in single or divided doses. Depending on age, species and condition being treated, dosage levels below the lower limit of this range can be suitable. In other cases, still larger doses can be used without side effects. Larger doses can also be divided into several smaller doses, for administration throughout the day.

### Pharmaceutical Compositions

For the treatment of the conditions referred to above, the compounds described herein can be administered as follows:

### Oral Administration

Compounds or compositions of the present disclosure can be administered orally, including by swallowing, so that the compound enters the gastrointestinal tract, or absorbed into the blood stream directly from the mouth (e.g., buccal or sublingual administration).

Suitable compositions for oral administration include solid formulations such as tablets, lozenges and capsules, which can contain liquids, gels, or powders. Compositions for oral administration can be formulated as immediate or modified release, including delayed or sustained release, optionally with enteric coating.

Liquid formulations can include solutions, syrups and suspensions, which can be used in soft or hard capsules. Such formulations can include a pharmaceutically acceptable carrier, for example, water, ethanol, polyethylene glycol, cellulose, or an oil. The formulation can also include one or more emulsifying agents and/or suspending agents.

In a tablet dosage form the amount of a compound present can be from about 0.05% to about 95% by weight, such as about 2% to about 50% by weight of the dosage form. In addition, tablets can contain a disintegrant, comprising about 0.5% to about 35% by weight, such as about 2% to about 25% of the dosage form. Examples of disintegrants include: methyl cellulose, sodium or calcium carboxymethyl cellulose, croscarmellose sodium, polyvinylpyrrolidone, hydroxypropyl cellulose, or starch.

Suitable lubricants, for use in a tablet, can be present in amounts of about 0.1% to about 5% by weight. Lubricants can include calcium, zinc or magnesium stearate, or sodium stearyl fumarate.

Suitable binders, for use in a tablet, include gelatin, polyethylene glycol, sugars, gums, starch, hydroxypropyl cellulose and the like. Suitable diluents, for use in a tablet, include mannitol, xylitol, lactose, dextrose, sucrose, sorbitol, or starch.

Suitable surface-active agents and glidants, for use in a tablet, can be present in amounts from about 0.1% to about 3% by weight of surface-active agent in the tablet. Surface-active agents and glidants can include polysorbate 80, sodium dodecyl sulfate, talc, or silicon dioxide.

### Parenteral Administration

Compounds and compositions of the present disclosure can be administered directly into the blood stream, muscle, or internal organs. Suitable methods for parenteral administration can include intravenous, intra-muscular, subcutaneous intraarterial, intraperitoneal, intrathecal, or intracranial. Suitable devices for parenteral administration include injectors (including needle and needle-free injectors) and infusion methods.

Compositions for parenteral administration can be formulated as immediate or modified release, including delayed or sustained release.

Most parenteral formulations are aqueous solutions containing excipients, including salts, buffering agents and carbohydrates. A parenteral formulation can include a non-aqueous solution or organic solution containing excipients, including salts, buffering agents and carbohydrates.

Parenteral formulations can also be prepared in a dehydrated form (e.g., by lyophilization) or as sterile non-aqueous solutions. These formulations can include water. Solubility-enhancing agents can also be used in preparation of parenteral solutions.

### Topical Administration

Compounds and compositions of the present disclosure can be administered topically to the skin or transdermally. Formulations for this topical administration can include lotions, solutions, creams, gels, hydrogels, ointments, foams, implants, patches and the like. Pharmaceutically acceptable carriers for topical administration formulations can include water, alcohol, mineral oil, glycerin, polyethylene glycol and the like. Topical administration can be performed by electroporation, iontophoresis, or phonophoresis.

Compositions for topical administration can be formulated as immediate or modified release, including delayed or sustained release.

### Combinations and Combination Therapy

The compounds and compositions of the present disclosure can be used, alone or in combination with other pharmaceutically active compounds, to treat conditions such as those previously described above. The compound(s)/composition(s) of the present disclosure and other pharmaceutically active compound(s) can be administered simultaneously (either in the same dosage form or in separate dosage forms) or sequentially. Accordingly, in at least one aspect, the present disclosure includes methods for treating a condition by administering to the subject a therapeutically-effective amount of one or more compounds of the present disclosure and one or more additional, different pharmaceutically active compounds.

In another aspect, there is provided a pharmaceutical composition comprising one or more compounds of the present disclosure, one or more additional pharmaceutically active compounds, and a pharmaceutically acceptable carrier.

In another aspect, the one or more additional, different pharmaceutically active compounds is one or more anti-inflammatory drugs, anti-atherosclerotic drugs, immunosuppressive drugs, immunomodulatory drugs, cytostatic drugs, anti-proliferative agents, angiogenesis inhibitors, kinase inhibitors, cytokine blockers, or inhibitors of cell adhesion molecules.

Compounds and compositions of the present disclosure can also be used in combination with other therapeutic reagents that are selected for their therapeutic value for the condition to be treated. In general, the compounds and compositions described herein and, in aspects where combinational therapy is employed, other agents do not have to be administered in the same pharmaceutical composition, and, because of different physical and chemical characteristics, are optionally administered by different routes. The initial administration is generally made according to established protocols, and then, based upon the observed effects, the dosage, modes of administration and times of administration subsequently modified. In certain instances, it is appropriate to administer a compound of the present disclosure as described herein in combination with another, different therapeutic agent. By way of example only, if one of the side effects experienced by a patient upon receiving a compound of the present disclosure is rash, then it is appropriate to administer an anti-histamine agent in combination with the initial therapeutic agent. Or, by way of example only, the therapeutic effectiveness of a compound of the present disclosure is enhanced by administration of another therapeutic agent (which also includes a therapeutic regimen) that also has therapeutic benefit. Regardless of the disease, disorder or condition being treated, the overall benefit experienced by the patient is either simply additive of the two therapeutic agents or the patient experiences a synergistic benefit.

Therapeutically effective dosages vary when the drugs are used in treatment combinations. Methods for experimentally determining therapeutically effective dosages of drugs and other agents for use in combination treatment regimens are documented methodologies. Combination treatment further includes periodic treatments that start and stop at various times to assist with the clinical management of the patient. In any case, the multiple therapeutic agents (one of which is a compound of the present disclosure) are administered in any order, or even simultaneously. If simultaneously, the multiple therapeutic agents are optionally provided in a single, unified form, or in multiple forms (by way of example only, either as a single pill or as two separate pills).

In some aspects, one of the therapeutic agents is given in multiple doses, or both are given as multiple doses. If not simultaneous, the timing between the multiple doses optionally varies from more than zero weeks to less than twelve weeks.

In addition, the combination methods, compositions and formulations are not to be limited to the use of only two agents, the use of multiple therapeutic combinations are also envisioned. It is understood that the dosage regimen to treat, prevent, or ameliorate the condition(s) for which relief is sought, is optionally modified in accordance with a variety of factors. These factors include the disorder from which the subject suffers, as well as the age, weight, sex, diet, and medical condition of the subject. Thus, the dosage regimen actually used can vary widely, in some aspects, and therefore can deviate from the dosage regimens set forth herein.

The pharmaceutical agents which make up the combination therapy disclosed herein are optionally a combined dosage form or in separate dosage forms intended for substantially simultaneous administration. The pharmaceutical agents that make up the combination therapy are optionally also administered sequentially, with either agent being administered by a regimen calling for two-step administration. The two-step administration regimen optionally calls for sequential administration of the active agents or spaced-apart administration of the separate active agents. The time period between the multiple administration steps ranges from, a few minutes to several hours, depending upon the properties of each pharmaceutical agent, such as potency, solubility, bioavailability, plasma half-life and kinetic profile of the pharmaceutical agent. Circadian variation of the target molecule concentration is optionally used to determine the optimal dose interval.

Compounds of the present disclosure or compositions having a compound of the present disclosure can be used (e.g., administered) in combination with drugs from the following classes: NSAIDs, immunosuppressive drugs, immunomodulatory drugs, cytostatic drugs, anti-proliferative agents, angiogenesis inhibitors, biological agents, steroids, vitamin D3 analogs, retinoids, other kinase inhibitors, cytokine blockers, corticosteroids and inhibitors of cell adhesion molecules. Where a subject is suffering from or at risk of suffering from atherosclerosis or a condition that is associated with atherosclerosis, a compound or composition of the present disclosure can be optionally used together with one or more agents or methods for treating atherosclerosis or a condition that is associated with atherosclerosis in any combination. Examples of therapeutic agents/treatments for treating atherosclerosis or a condition that is associated with atherosclerosis include, but are not limited to any of the following: torcetrapib, aspirin, niacin, HMG CoA reductase inhibitors (e.g., atorvastatin, fluvastatin, lovastatin, pravastatin, rosuvastatin and simvastatin), colesevelam, cholestyramine, colestipol, gemfibrozil, probucol and clofibrate.

Where a subject is suffering from or at risk of suffering from an inflammatory condition, a compound or composition of the present disclosure is optionally used together with one or more agents or methods for treating an inflammatory condition in any combination. Examples of therapeutic agents/treatments for treating an autoimmune and/or inflammatory condition include, but are not limited to any of the following: corticosteroids, nonsteroidal antiinflammatory drugs (NSAID) (e.g. ibuprofen, naproxen, acetaminophen, aspirin, Fenoprofen (NALFON®), Flurbiprofen (ANSAID®), Ketoprofen, Oxaprozin (DAYPRO®), Diclofenac sodium (VOLTAREN®), Diclofenac potassium (CATAFLAM®), Etodolac (LODINE®), Indomethacin (INDOCIN®), Ketorolac (TORADOL®), Sulindac (CLINORIL®), Tolmetin (TOLECTIN®), Meclofenamate (MECLOMEN®), Mefenamic acid (PONSTEL®), Nabumetone (RELAFEN®), Piroxicam (FELDENE®), cox-2 inhibitors (e.g., celecoxib (CELEBREX®))), immunosuppressants (e.g., methotrexate (RHEUMATREX®), leflunomide (ARAVA®), azathioprine (IMURAN®), cyclosporine (NEORAL®, SANDIMMUNE®), tacrolimus and cyclophosphamide (CYTOXAN®), CD20 blockers (RITUXIMAB®), Tumor Necrosis Factor (TNF) blockers (e.g., etanercept (ENBREL®), infliximab (REMICADE®) and adalimumab (HUMIRA®)), Abatacept (CTLA4-Ig) and interleukin-1 receptor antagonists (e.g. Anakinra (KINERET®), interleukin 6 inhibitors (e.g., ACTEMRA®), interleukin 17 inhibitors (e.g., AIN457), Janus kinase inhibitors (e.g., Tasocitinib), syk inhibitors (e.g. R788), chloroquine and its derivatives.

For use in cancer and neoplastic diseases a compound or composition of the present disclosure is optionally used together with one or more of the following classes of drugs: wherein the anti-cancer agent is an EGFR kinase inhibitor, MEK inhibitor, VEGFR inhibitor, anti-VEGFR2 antibody, KDR antibody, AKT inhibitor, PDK-1 inhibitor, PI3K inhibitor, c-kit/Kdr tyrosine kinase inhibitor, Bcr-Abl tyrosine kinase inhibitor, VEGFR2 inhibitor, PDGFR-beta inhibitor, KIT inhibitor, Flt3 tyrosine kinase inhibitor, PDGF receptor family inhibitor, Flt3 tyrosine kinase inhibitor, RET tyrosine kinase receptor family inhibitor, VEGF-3 receptor antagonist, Raf protein kinase family inhibitor, angiogenesis inhibitor, Erb2 inhibitor, mTOR inhibitor, IGF-1R antibody, NFkB inhibitor, proteosome inhibitor, chemotherapy agent, or glucose reduction agent.

### EXAMPLES

Reagents: Unless otherwise stated, all chemicals were used as received. The solvents used were of either HPLC or AR grade; these included dichloromethane (DCM, Aldrich AR grade), DMSO (Aldrich, 99.9%), n-hexane (Emsure, ACS), chloroform (Emsure, ACS), methanol (Merck, Emsure, ACS), acetonitrile (LiChrosolv, hypergrade for LC-MS), petroleum spirit (BR 40-60° C., Univar, AR), toluene (Merck, for analysis EMSURE ACS, ISO, Reag. Ph Eur), ethyl acetate (ChemSupply, AR), ethanol (ChemSupply, AR), N,N-dimethylformamide (DMF: Labscan, AR grade), and N,N-dimethylacetamide (Aldrich, >99%). Activated basic alumina (Aldrich: Brockmann I, standard grade, ˜150 mesh, 58 Å), silica gel (Aldrich, 230-400 mesh, 60 Å), magnesium sulphate (anhydrous, Aldrich), Milli-Q water (Biolab, 18.2 MΩm), sodium dodecyl sulphate (SDS, Aldrich, 99%), 1-butanethiol (Aldrich, 99%), D-(+)-galactose (Aldrich, ≥99%), propargyl bromide solution (Aldrich, 80 wt. % in toluene, contains 0.3% magnesium oxide as stabilizer), lithium chloride (Aldrich, 99%), tripotassium phosphate (Aldrich, ≥98%), potassium hydroxide (Aldrich), 3-chloropropylamine hydrochloride (Aldrich, 98%), triethylamine (Aldrich, ≥99.5%), acryloyl chloride (Merck, stabilized with phenothiazine), sodium hydrogen carbonate (Aldrich, 99.5%), sodium azide (Aldrich, ≥99.5%), hydrochloric acid (36%, Ajax, AR), sulfuric acid (Aldrich, 98%), trifluoroacetic acid (Merck, >99%), carbon disulfide (Aldrich, >99.9%), methyl-2-bromopropionate (MBP, Aldrich, 98%), 2-ethyl-2-thiopseudoureahydrobromide (Aldrich, 98%), iodooctane (Aldrich, 98%), copper (II) sulfate (Aldrich, 99%), copper (II) sulfate anhydrous powder (Aldrich, ≥99.99% trace metals basis), Cu(0) powder (Aldrich, <425 m, 99.5% trace metals basis), and L-ascorbic acid (Aldrich, 99%) were used as received.

Monomers, initiator, and ligand: N-isopropylacrylamide (NIPAM, Aldrich, 97%) and N,N-(dimethylamino)ethyl methacrylate (DMAEMA, Aldrich, 98%) were dissolved in ethanol with activated basic alumina and after filtration used directly for the synthesis of macro chain transfer agents (MacroCTAs). Styrene (STY, Aldrich, >99%) was passed through a basic alumina column to remove inhibitor. Azobisisobutyronitrile (AIBN, Riedel-de Haen) was recrystallized from methanol twice prior to use. Tris(2-(dimethylamino)ethyl)amine (Me₆TREN),1 Cu(II)Br₂/Me₆TREN complex,₂ 3-azido-7-hydroxycoumarin azide (coumarin azide)₃ were synthesized according to literature procedures.

RAFT agent: Methyl 2-(butylthiocarbonothioylthio) propanoate (MCEBTTC) RAFT agent was synthesized according to the literature procedure.

Nuclear Magnetic Resonance (NMR) All NMR spectra were recorded on either Bruker DRX 400 or 500 MHz spectrometers using an external lock (CDCl₃, DMSO-d6 or D₂O).

Size Exclusion Chromatography (SEC) and Triple Detection-Size Exclusion Chromatography (TD-SEC): Analysis of the molecular weight distributions of the polymers was determined using a Polymer Laboratories GPC50 Plus equipped with differential refractive index detector. Absolute molecular weights of polymers were determined using a Polymer Laboratories GPC50 Plus equipped with dual angle laser light scattering detector, viscometer, and differential refractive index detector. HPLC grade N,N-dimethylacetamide (DMAc, containing 0.03 wt % LiCl) was used as the eluent at a flow rate of 1.0 mL/min. Separations were achieved using two PLGel Mixed B (7.8×300 mm) SEC columns connected in series and held at a constant temperature of 50° C. InfinityLab EasiVial polystyrene standards were used for SEC column calibration. Samples of known concentration were freshly prepared in DMAc+0.03 wt % LiCl and passed through a 0.45 m PTFE syringe filter prior to injection. The absolute molecular weights and dn/dc values were determined using Polymer Laboratories Multi Cirrus software based on the quantitative mass recovery technique.

Dynamic Light Scattering (DLS): The size and zeta potential of particles was measured by DLS which was performed using a Malvern Zetasizer Nano Series running DTS software and operating a 4 mW He—Ne laser at 633 nm. Analysis was performed at an angle of 173° and a constant temperature of 25° C. The number-average hydrodynamic particle size and PDI_{(DLS)} are reported. The PDI_{(DLS)} was used to describe the width of the particle size distribution, and calculated from a Cumulants analysis of the DLS measured intensity autocorrelation function and is related to the standard deviation of the hypothetical Gaussian distribution (i.e., PDI_{(DLS)}=ρ₂/Z_{D2}, where σ is the standard deviation and Z_{D} is the Z average mean size).

Transmission Electron Microscopy (TEM) The nanostructure appearance was determined using a HT-7700 transmission electron microscope utilizing an accelerating voltage of 80 kV with spot size 1 at ambient temperature. A typical TEM grid preparation was as follows: A sample was diluted with Milli-Q water to approximately 0.02-0.05. wt % of the total volume of the sample at room temperature. A formvar precoated copper TEM grid was dipped into the solution, the excess aliquot was blotted and then allowed to air dry prior imaging on TEM.

Attenuated Total Reflectance-Fourier Transform Spectroscopy (ATR-FTIR) ATR-FTIR spectra were obtained using a horizontal, single bounce, diamond ATR accessory on a Nicolet Nexus 870 FT-IR. Spectra were recorded between 4000 and 500 cm⁻¹ for 32 scans at 4 cm⁻¹ resolution with an OPD velocity of 0.6289 cm/s⁻¹. Solids were pressed directly onto the diamond internal reflection element of the ATR without further sample preparation.

### Synthesis of 1,1′-(azanediylbis(propane-3,1-diyl))diguanidine dihydrobromide

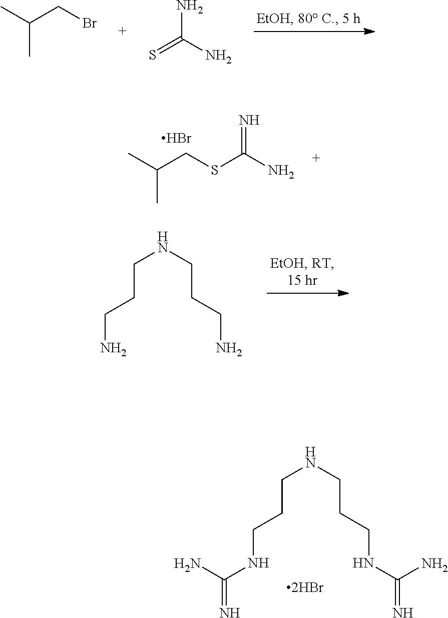

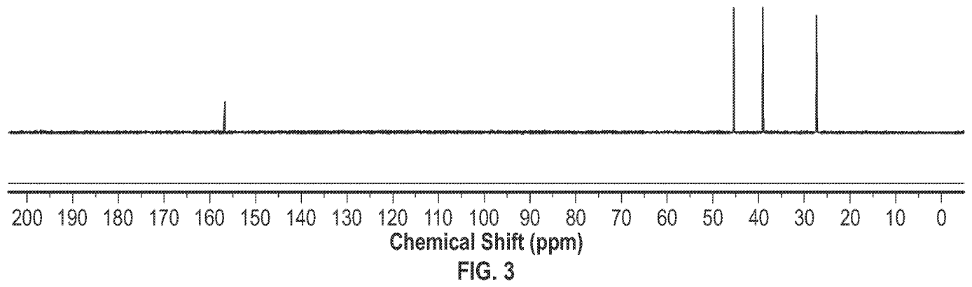

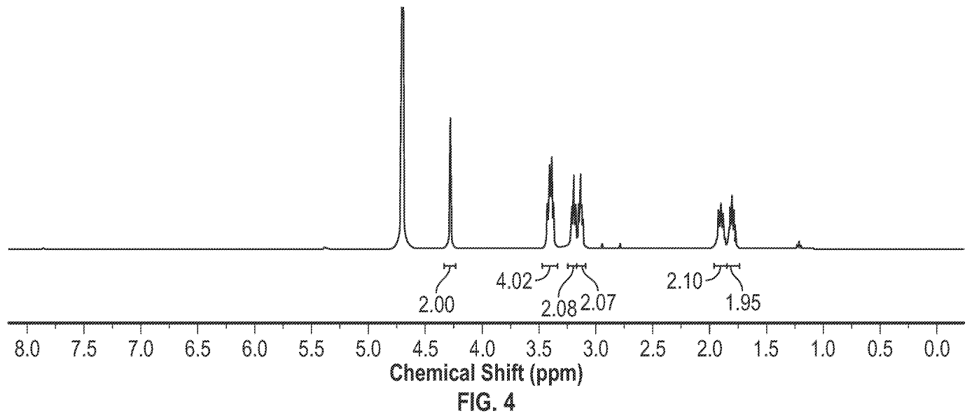

Isobutyl bromide (34.26 g, 2.50×10⁻¹ mol) was added to a suspension of thiourea (19.03 g, 2.50×10⁻¹ mol) in 100 mL of EtOH and the mixture was refluxed at 80° C. for 5 h. Overtime, the heterogeneous mixture became homogenous, then the solution was cooled down to room temperature. Bis(3-aminopropyl)amine (13.12 g, 1.00×10⁻¹ mol) was added and the solution was stirred at room temperature for 15 h. Initially, the heterogeneous solution became homogeneous after stirring for 45 min, then precipitates were observed after 60 min of stirring. To the stirring solution, 300 mL of diethyl ether was added and the suspension was stirred for another 30 min, followed by filtration and washing with diethyl ether (100 mL×2). The residue was dried under high vacuum to obtain 1,1′-(azanediylbis(propane-3,1-diyl))diguanidine dihydrobromide as a white solid in near quantitative yields. 1H NMR (400 MHz, D2O) δ 3.25 (t, J=6.9 Hz, 4H), 2.68 (t, J=7.5 Hz, 4H), 1.80 (p, J=7.0 Hz, 4H); 13C NMR (101 MHz, D2O) δ 156.8, 45.5, 39.1, 27.5. As shown in FIGS. 3 and 4.

### Synthesis of 2-Chloro-N,N-bis(3-guanidinopropyl)acetamide dihydrobromide

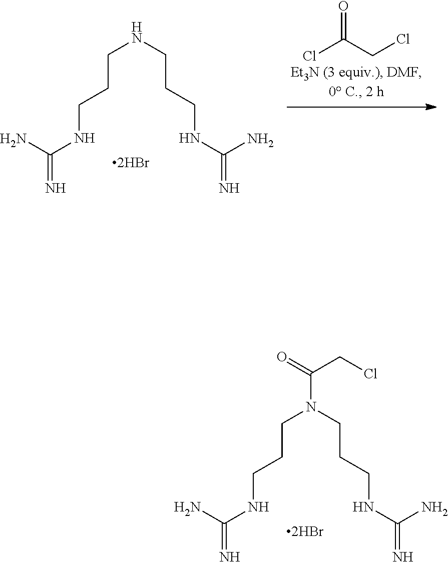 [SMILES: N=C(N)NCCCNCCCNC(=N)N ; O=C(Cl)CCl ; N=C(N)NCCCN(CCCNC(=N)N)C(=O)CCl]

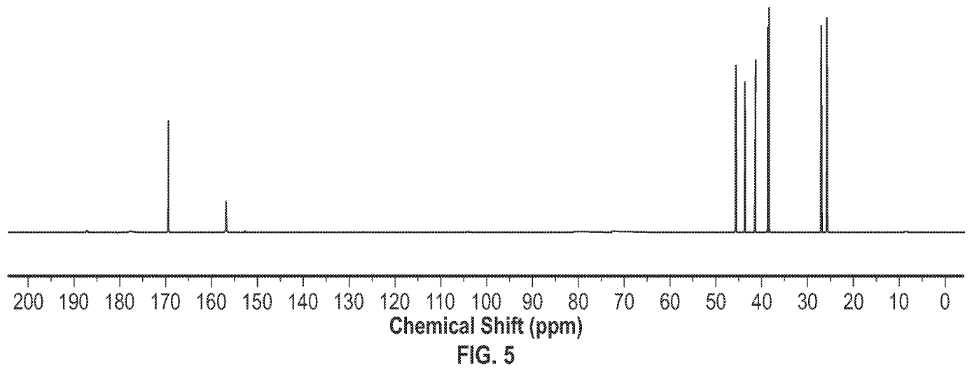

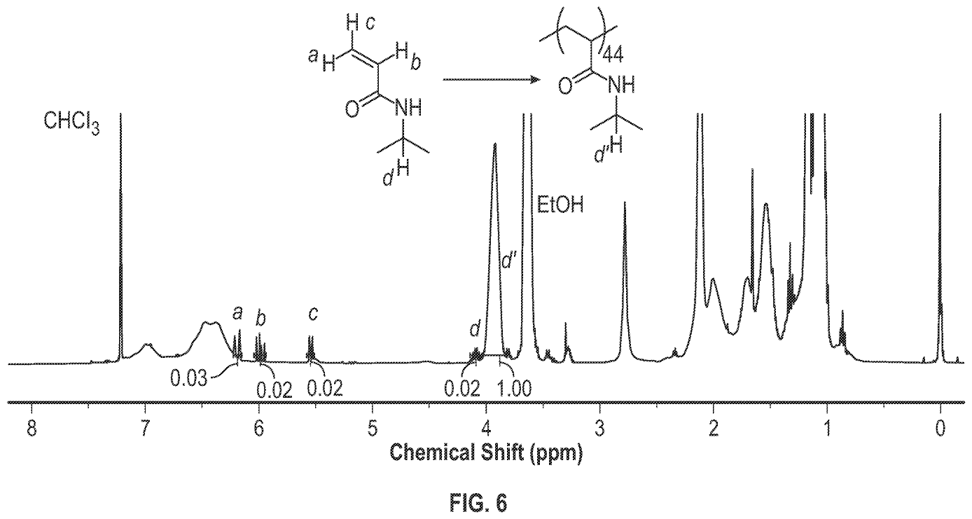

To a suspension of 1,1′-(azanediylbis(propane-3,1-diyl))diguanidine dihydrobromide (22.63 g, 6.00×10⁻² mol) in 200 mL of dry DMF at 0° C., triethylamine (18.22 g, 1.80×10⁻¹ mol) was added, followed by the addition of 2-chloroacetyl chloride (20.33 g, 1.80×10⁻¹ mol). The reaction was stirred at 0° C. for about 1 h, then warmed up to room temperature. To the solution, 4.85 mL of methanol was added to quench the excess acyl chloride. The solution was further stirred for 30 min, then filtered to remove triethylamine salt. The dark filtrate was then concentrated via distillation with a short-path distillation apparatus (65° C., <1 mBar) to remove excess DMF. The viscous residue was precipitated from methanol with excess DCM (500 mL×2). The precipitated was filtered, washed with additional DCM, and dried under vacuum to give 2-Chloro-N,N-bis(3-guanidinopropyl)acetamide dihydrobromide as an off-white solid (Yield=57%, 15.6 g, 3.44×10⁻² mol); ¹H NMR (400 MHz, D₂O) δ 4.28 (s, 2H), 3.44-3.35 (m, 4H), 3.20 (t, J=6.8 Hz, 2H), 3.13 (t, J=6.8 Hz, 2H), 1.90 (p, J=7.0 Hz, 2H), 1.80 (p, J=6.8 Hz, 2H); ¹³C NMR (101 MHz, D₂O) δ 169.4, 156.8, 156.8, 45.6, 43.6, 41.3, 38.6, 38.4, 27.0, 25.7, as shown in FIGS. 5 and 6.

### Synthesis of MacroCTAs—MacroCTA-A (PNIPAM44-S(C═S)SC4H9)

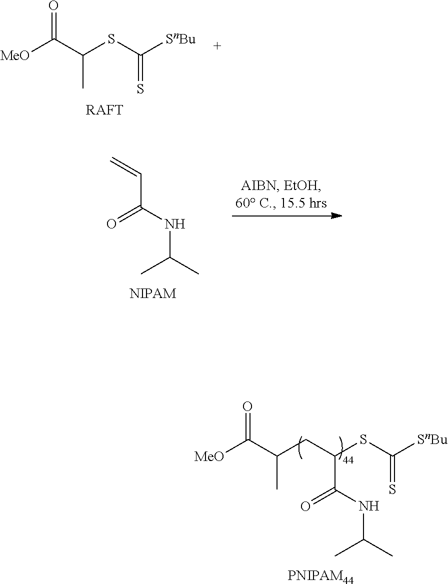

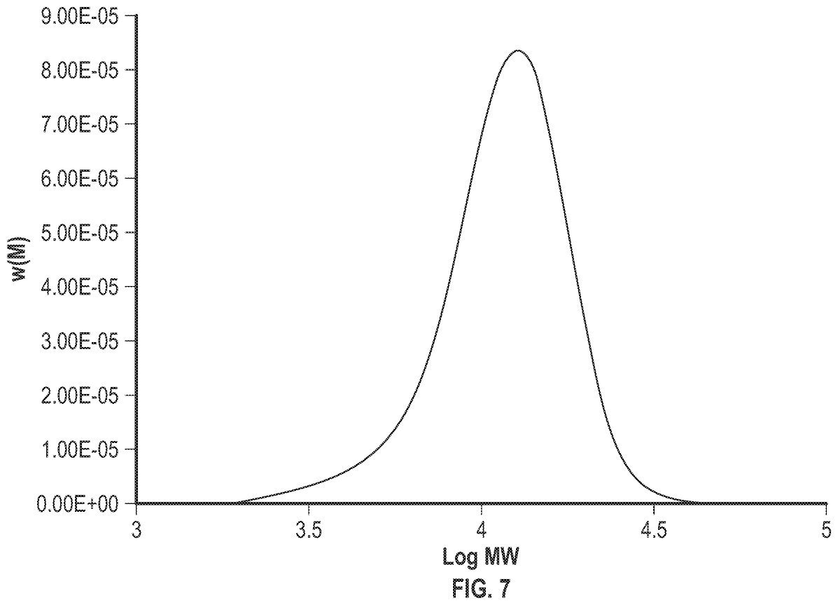

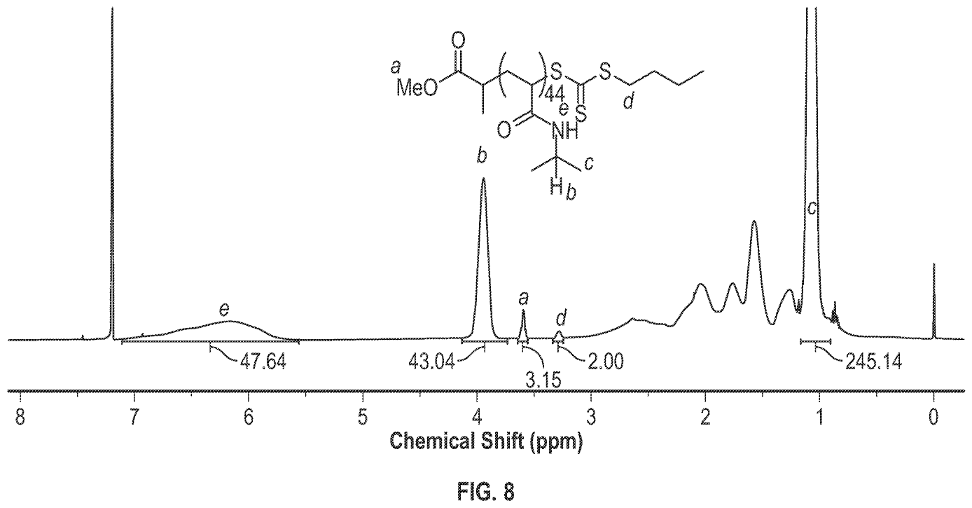

To a clean and dried round-bottom flask was added recrystalized NIPAM (106.8 mmol) and AIBN (0.238 mmol) as solids, followed by addition of RAFT agent (2.38 mmol) dissolved in 25 mL of EtOH. The mixture was stirred until all components dissolved, and the resulting solution degassed with argon(g) for ˜1 h. The polymerization mixture was placed in a preheated oil bath at 60° C. and left to polymerize for 15.5 h. Samples were taken to determine conversion by ¹H NMR, as shown in FIG. 6. Another sample was taken and purified by dialysis (MWCO 3.5 kDa, against tap water, 24 h, 5 buffer changes) for molecular weight analysis by SEC, as shown in FIG. 7. The purified sample was subsequently analyzed by ¹H NMR, as shown in FIG. 8.

Molecular weight characterization of MacroCTA-A (PNIPAM₄₄) by triple detection (TD) and refractive index (RI) detection SEC was determined, shown below in Table 1.

TABLE 1

| | | Mn | Mn | Mn | | NIPAM |
|---|---|---|---|---|---|---|
| Sample | Conversion | (theory) | (NMR) | (TD) | Ð_{RI} | units |
| 1 | 98% | 5231 | 5118 | 5559 | 1.16 | 44 |

### Synthesis of MacroCTA-A: P(NIPAM₄₅)

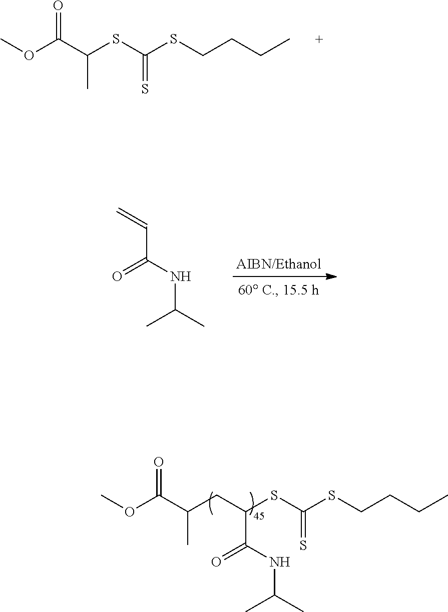

MacroCTA-A was synthesized as follows: The concentration ratio of NIPAM/MCEBTTC RAFT agent/AIBN was 45/1/0.15, and the ratio of ethanol to NIPAM was kept at 2/1 (v/w). NIPAM (20.22 g, 1.79×10⁻¹ mol) was dissolved in 38.9 mL of ethanol and stirred with basic alumina (150 mg) for 30 min to remove inhibitor. The mixture was filtered, then MCEBTTC RAFT agent (1.02 g, 4.04×10⁻³ mol) and AIBN (98 mg, 5.97×10⁻⁴ mol) were added to the solution and degassed by bubbling with argon for 60 min. Polymerization of MacroCTA-A was carried out at 60° C. for 15.5 h. The reaction was quenched by exposure to air and used directly in the emulsion polymerization step. Molecular weight characterization of MacroCTA-A (PNIPAM45) by TD and RI detection SEC was determined, shown below in Table 2.

TABLE 2

| | | Mn | Mn | Mn | | NIPAM |
|---|---|---|---|---|---|---|
| Sample | Conversion | (theory) | (NMR) | (TD) | Ð_{RI} | units |
| 1 | 99% | 5200 | 5345 | 5670 | 1.10 | 45 |

### MacroCTA-B (P(NIPAM₅₁-co-DMAEMA₂₉)-S(C═S)SC₄H₉)

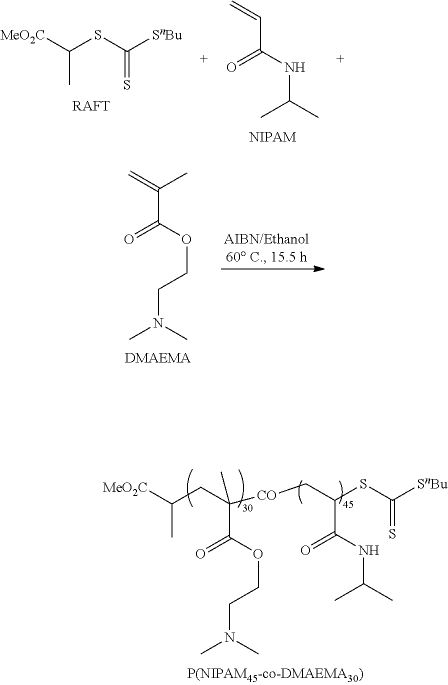

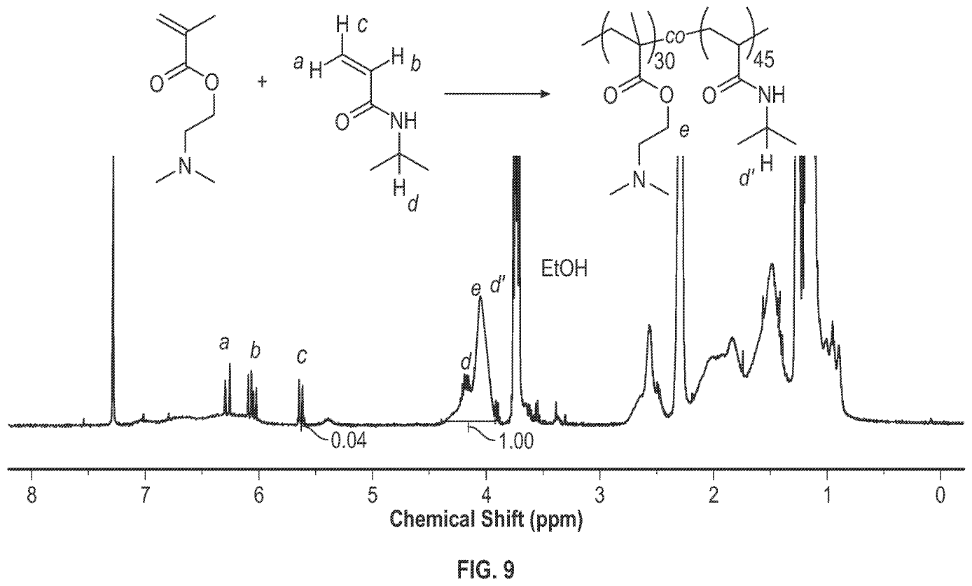

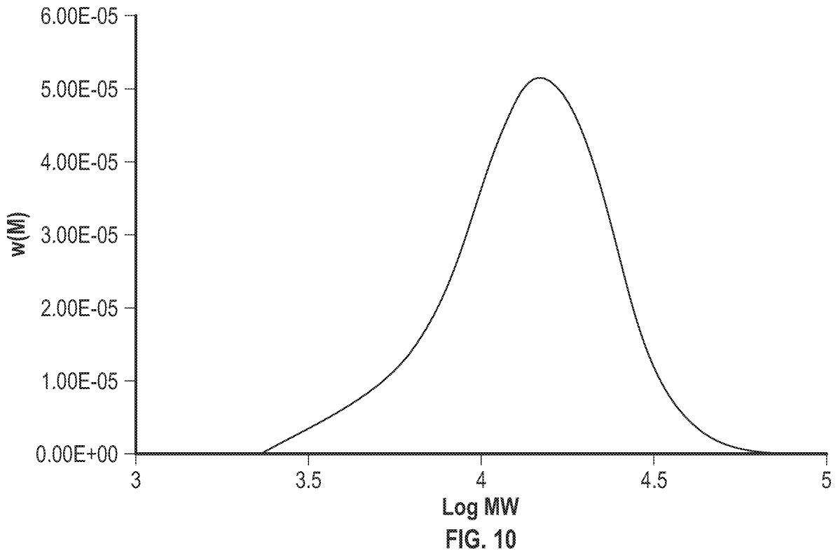

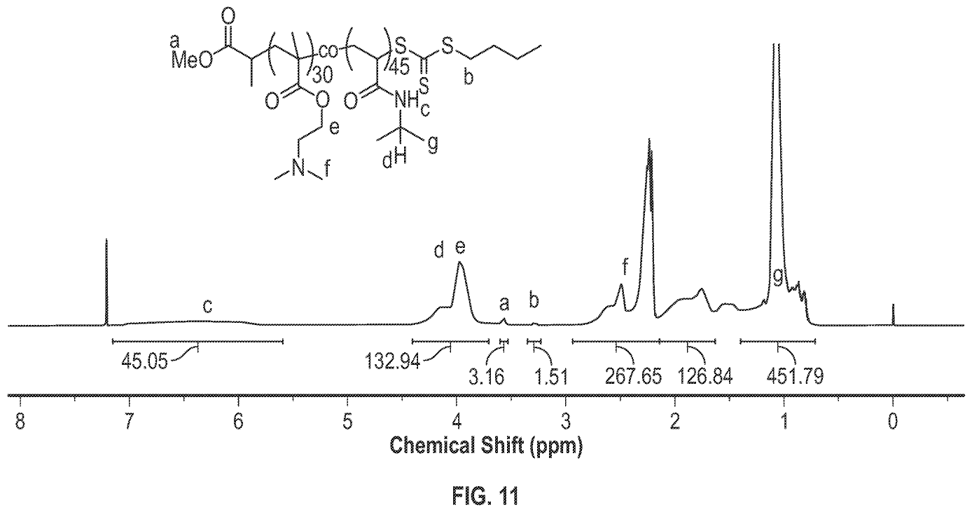

Recrystallized NIPAM, purified DMAEMA (by passing through basic Al₂O₃ column) and AIBN initiator were added to a round bottom flask, followed by addition of RAFT agent dissolved in 25 mL of EtOH. The mixture was stirred until all components dissolved, and the resulting solution degassed with argon (g) for ˜1 h. The polymerization mixture was placed in a preheated oil bath at 70° C. and left to polymerize for 15.5 h. Samples were taken to determine conversion by ¹H NMR, as shown in FIG. 9. Another sample taken and purified by dialysis (MWCO 3.5 kDa, against tap water, 24 h, 5 buffer changes) for molecular weight analysis by SEC, as shown in FIG. 10. The purified sample was subsequently analyzed by ¹H NMR, as shown in FIG. 11.

Molecular weight characterization of MacroCTA-B (P(NIPAM₄₄-co-DMAEMA₃₀)-RAFT) by triple detection (TD) and refractive index (RI) detection SEC was determined, shown below in Table 3.

TABLE 3

| | Conv. | Conv. | Mn | Mn | Mn | | NIPAM/DMAEMA |
|---|---|---|---|---|---|---|---|
| Sample | NIPAM | DMAEMA | (theory) | (TD) | (NMR) | Ð_{RI} | units |
| 1 | 91% | 100% | 10128 | 11579 | 10061 | 1.28 | 45/30 |

### Synthesis of MacroCTA-B: P(NIPAM₅₀-co-DMAEMA₃₀)

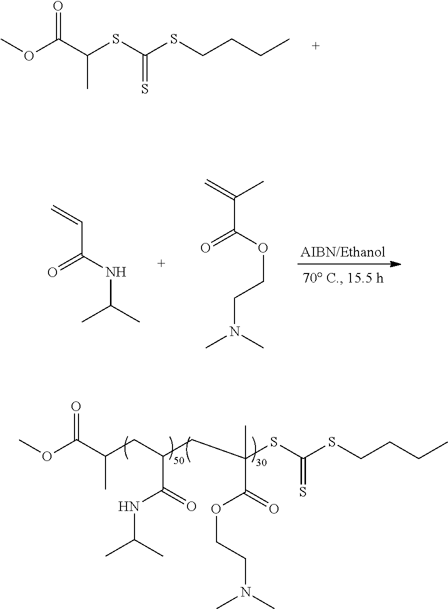

MacroCTA-B was synthesized as follows: The concentration ratio of NIPAM/DMAEMA/MCEBTTC RAFT agent/AIBN was 50/30/1/0.15, and the ratio of ethanol to NIPAM was kept at 2/1 (v/w). NIPAM (22.49 g, 1.99×10⁻¹ mol) and DMAEMA (18.77 g, 1.19×10⁻¹ mol) was dissolved in 52.5 mL of ethanol and stirred with basic alumina (150 mg) for 30 min to remove inhibitor. The mixture was filtered, then MCEBTTC RAFT agent (1.02 g, 4.03×10⁻³ mol) and AIBN (101 mg, 6.15×10⁻⁴ mol) were added to the solution and degassed by bubbling with argon for 60 min. Polymerization of MacroCTA-B was carried out at 70° C. for 15.5 h. The reaction was quenched by exposure to air and used directly in the emulsion polymerization step. Molecular weight characterization of MacroCTA-B P(NIPAM50-co-DMAEMA30) by TD and RI detection SEC was determined, shown below in Table 4.

TABLE 4

| | Conv. | Conv. | Mn | Mn | Mn | | NIPAM/DMAEMA |
|---|---|---|---|---|---|---|---|
| Sample | NIPAM | DMAEMA | (theory) | (TD) | (NMR) | Ð_{RI} | units |
| 1 | 94% | 100% | 10290 | 10760 | 10510 | 1.3 | 49/30 |

### Synthesis A of Multifunctional Nanoworms (NWs)—Synthesis of Base Nanoworms (Nanoworm)

Now referring to FIG. 8, the emulsion polymerization of styrene with MacroCTA-A and MacroCTA-B was as follows: MacroCTA-A (2.38 mmol) and MacroCTA-B (1.72 mmol) dissolved in ethanol (i.e. directly from the above polymerization and without purification) were transferred to a 1 L round-bottom flask. Ice-water (506 mL) mixture was added, and the polymerization mixture placed in ice-water bath under vigorous stirring. Surfactant (SDS) (4.28 mmol) was added as powder and the mixture stirred for an additional 30 min while degassing with argon. AIBN (0.614 mmol) dissolved in styrene (229.4 mmol) was then added to the mixture, followed by degassing with argon (g) for another 1 h, during which time an emulsion formed. The polymerization mixture was placed in a preheated oil bath at 70° C., and left to polymerize for 7 h. A sample was taken to determine conversion by ¹H NMR (CDCl₃), showing that styrene conversion reached 90%. The remaining polymerization was opened to air for ˜4 h to remove unpolymerized styrene. The resulting latex was then placed on rotatory evaporator to remove ethanol (60 mBar, 60° C. bath, 4 h), and then stored in Schott bottle. The weight percentage of the polymer was determined to be 9.7% from three freeze-dried samples. An aliquot of the latex was dialyzed (MWCO 3.5 kDa, against tap water, 5 buffer changes in 24 hours) and freeze-dried for NMR and SEC analysis. Samples of the crude mixture of the emulsion polymerization were analyzed by ¹H NMR, as noted in FIG. 9. Another sample taken and purified by dialysis (MWCO 3.5 kDa, against tap water, 24 h, 5 buffer changes) and freeze-dried (RI detector, DMAc as eluent) was analyzed for molecular weight analysis by SEC, as noted in FIG. 10. The purified sample was subsequently analyzed by ¹H NMR, as noted in FIG. 11.

Molecular weight characterization of block copolymer formed after the emulsion polymerization by triple detection (TD) and refractive index (RI) detection SEC was determined, shown below in Table 5.

TABLE 5

| | Conv. | Mn | | NIPAM/DMAEMA/ |
|---|---|---|---|---|
| Sample | styrene | (TD) | Ð_{RI} | Styrene units |
| 1 | 90% | 19389 | 1.36 | 45/30/50 |

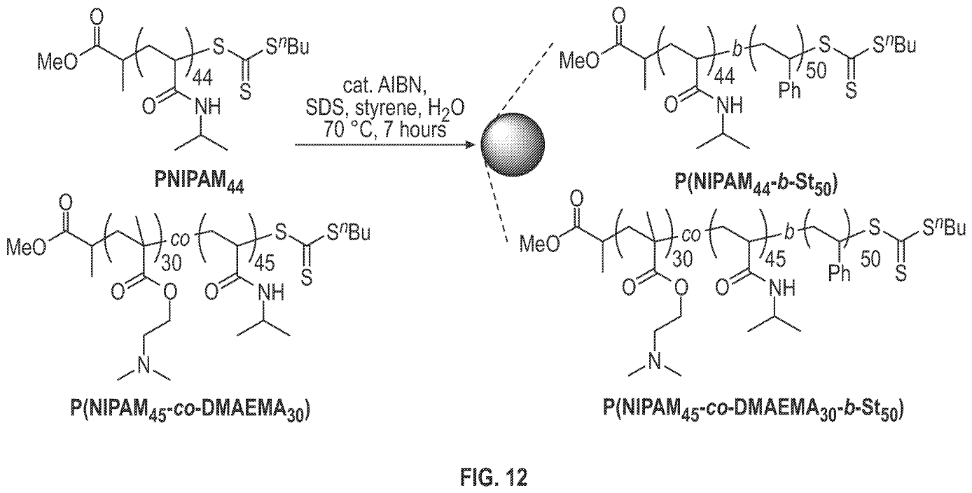

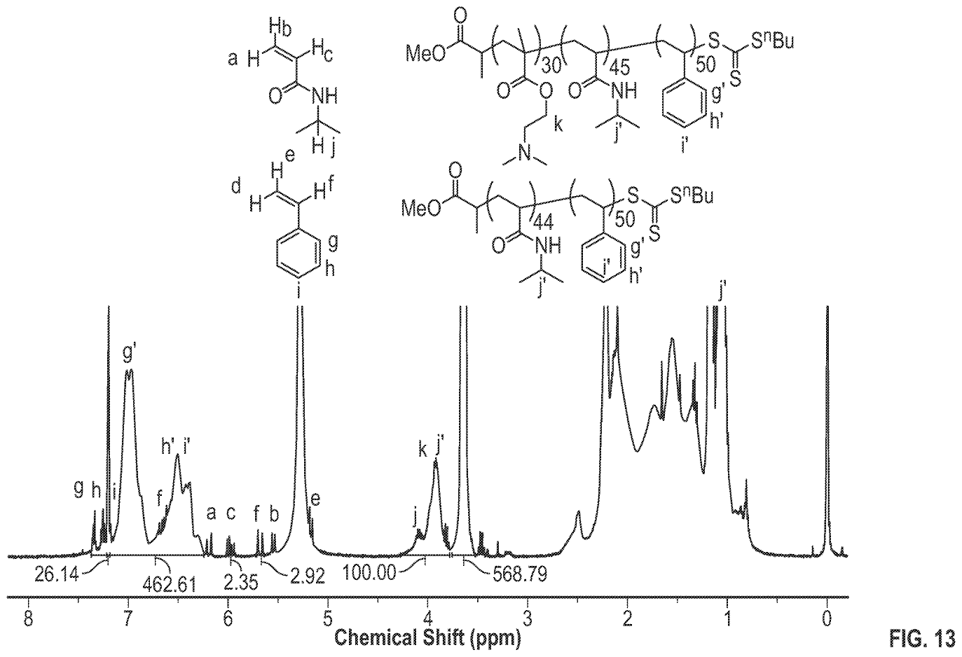

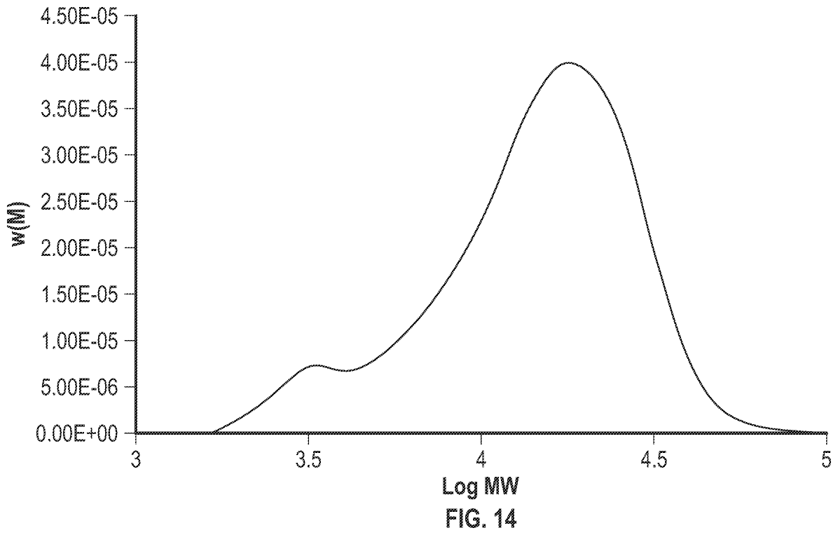

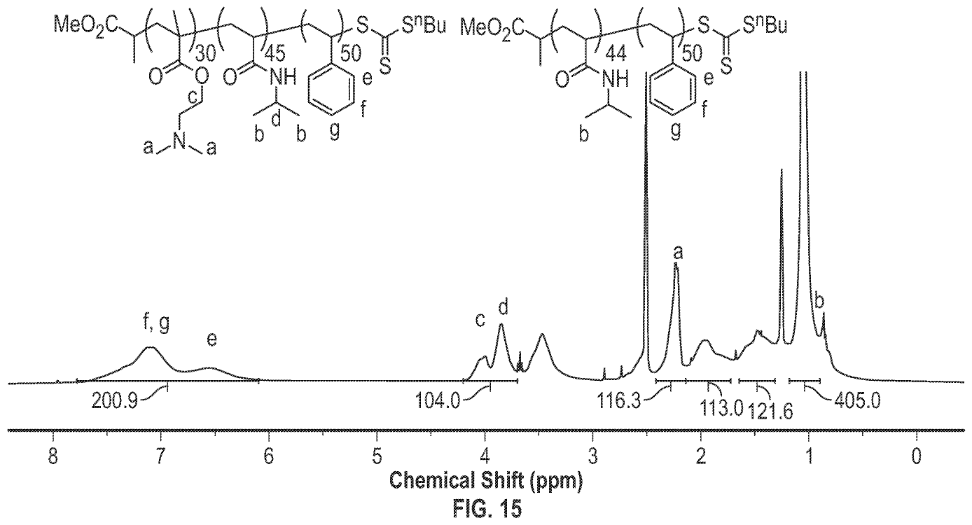

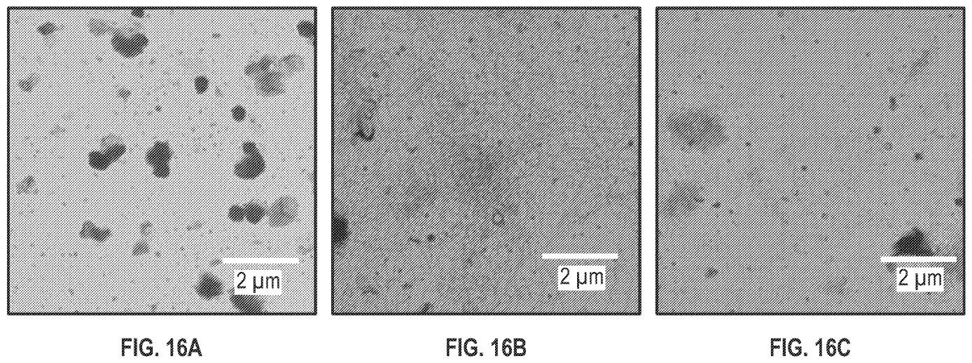

The resulting latex was analyzed by TEM. A sample was cooled from 70° C. to room temperature and then diluted with H₂O (4 μL/mL v/v latex:H₂O), shown in FIG. 12A. Another sample was taken after the addition of toluene (20 μL toluene was added to 1 mL latex) at 70° C. and cooled to room temperature while shaking, shown in FIG. 12B. Then toluene was removed on a rotovap (<22° C., 30 mBar, 4 h), shown in FIG. 12C. Then the NW latex were diluted to 8.2 wt % of nanoworms in aqueous solution and stored in fridge. The pH of the nanoworm latex was 9.5.

### Synthesis B of Multifunctional Nanoworms (NWs)—Synthesis of Base Nanoworms (Nanoworm)

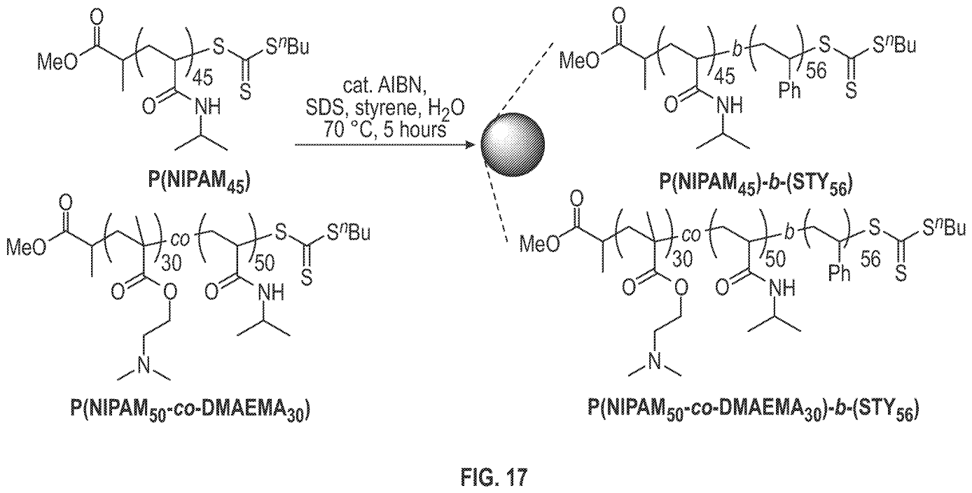

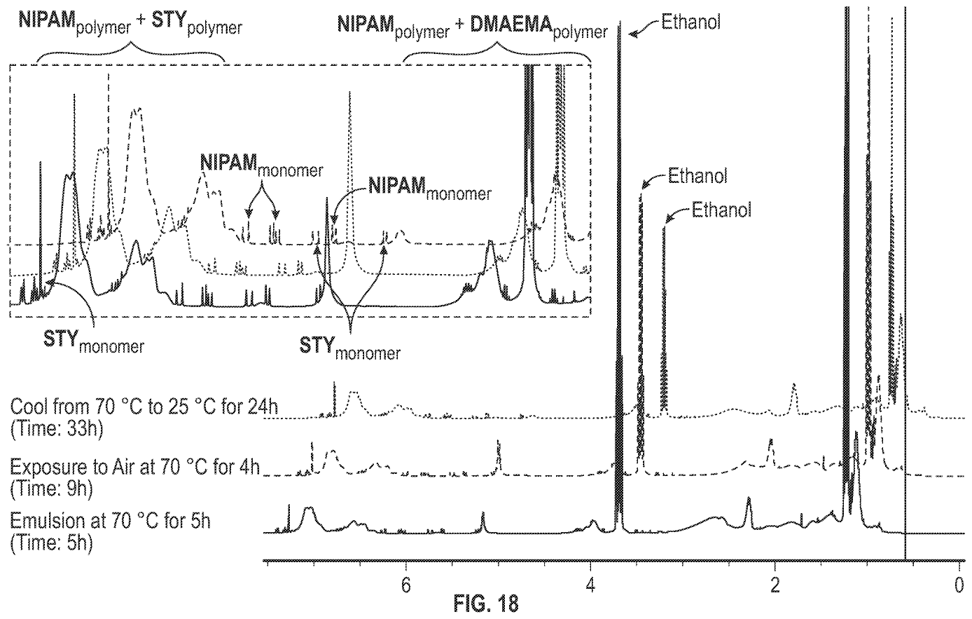

Now referring to FIG. 17, the emulsion polymerization of styrene with MacroCTA-A and MacroCTA-B was as follows: MacroCTA-A solution (18.56 g_{(MacroCTA-A+EtOH)}, 7.52 g_{(MacroCTA-A)}, 1.45×10⁻³ mol_{(MacroCTA-A)}), MacroCTA-B (23.53 g_{(MacroCTA-B+EtOH)}, 11.25 g_{(MacroCTA-B)}, 1.13×10⁻³ mol_{(MacroCTA-B)}) and SDS (0.77 g, 2.66×10⁻³ mol) were dissolved in 300 mL of cold water at 4° C. for 24 h. The solution was degassed by bubbling with argon for 45 min. Then, solution of AIBN (64 mg, 3.87×10⁻⁴ mol) and styrene (15.17 g, 1.44×10⁻¹ mol) was injected into the polymerization mixture. The mixture was further degassed by bubbling with argon for 15 min, then polymerized at 70° C. for 5 h. The reaction was stopped by exposure to ambient air at 70° C. for 4 h, then the polymer latex was cooled to 25° C. and left to stand for 24 h to give a ˜11.5 wt % polymer latex. The polymer was analyzed by ¹H NMR, as noted in FIG. 18 and Table 6.

TABLE 6

| | Reac- | | | | |
|---|---|---|---|---|---|
| | tion | | | | |
| Reaction | Time | Temp. | STY_{polymer} | STYₘₒₙₒₘₑᵣ | EtOH |
| Condition | (h) | (° C.) | (unit) | (%) | (%) |
| (a) Emulsion | 5 | 70 | 57 | 3.0 | 71.7 |
| Polymerization | | | | | |
| at 70° C. | | | | | |
| for 5 h | | | | | |
| (b) Exposing | 9 | 70 | 58 | 2.4 | 48.9 |
| Emulsion to Air | | | | | |
| at 70° C. | | | | | |
| for 4 h | | | | | |
| (c) Cool Emulsion | 33 | 25 | 58 | 2.0 | 22.7 |
| from 70 to 25° C. | | | | | |
| for 24 h | | | | | |

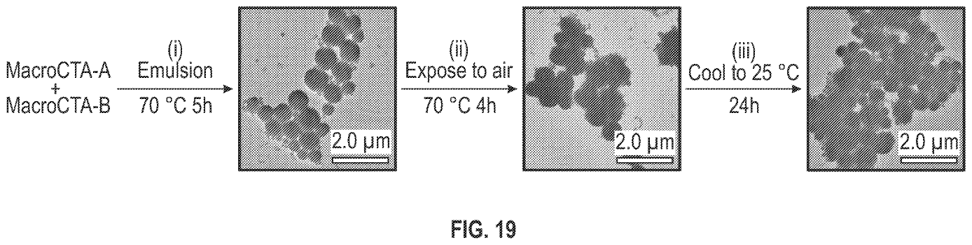

The resulting latex was analyzed by TEM. A sample was cooled from 70° C. to room temperature, e.g., about 20° C. to about 25° C., and then diluted with H₂O (4 μL/mL v/v latex:H₂O), shown in FIG. 19.

### Nanoworm Morphology at 50° C.

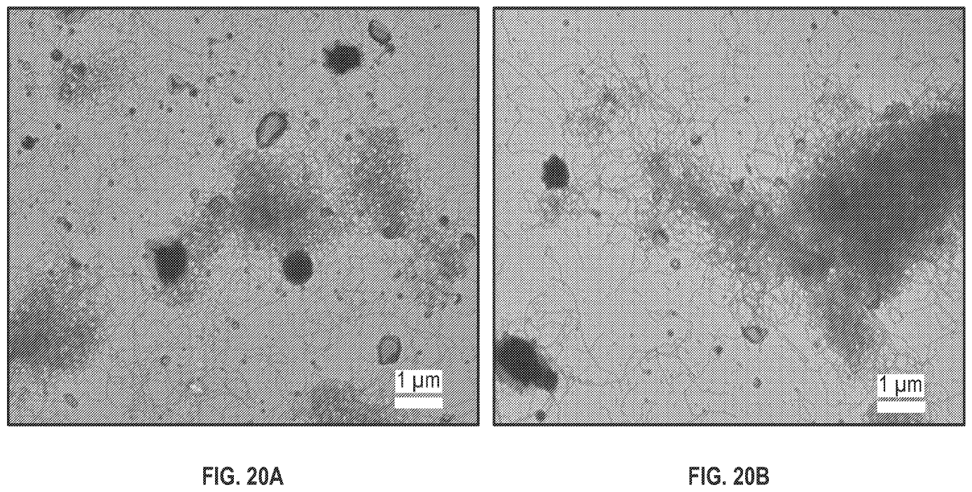

Nanoworms were tested for functionalization at 50° C. in water. First, the stability of the nanoworms at 50° C. was tested. 1 mL of nanoworm latex (8.2 wt %) was heated to 50° C., stirred for 1 h and then cooled to room temperature. The resulting latex was checked by TEM, shown in FIG. 20A. The latex (1 mL) was then diluted with water (1 mL) to 4.1 wt %, heated to 50° C. for 1 h. The resulting latex was then cooled to room temperature and a TEM taken, shown in FIG. 20B. The nanoworm morphology at the two weight fractions of the nanoworm dispersions was maintained and stable under these experimental conditions.

### Nanostructure Synthesis from Diguanidine Functionalized Nanoworms

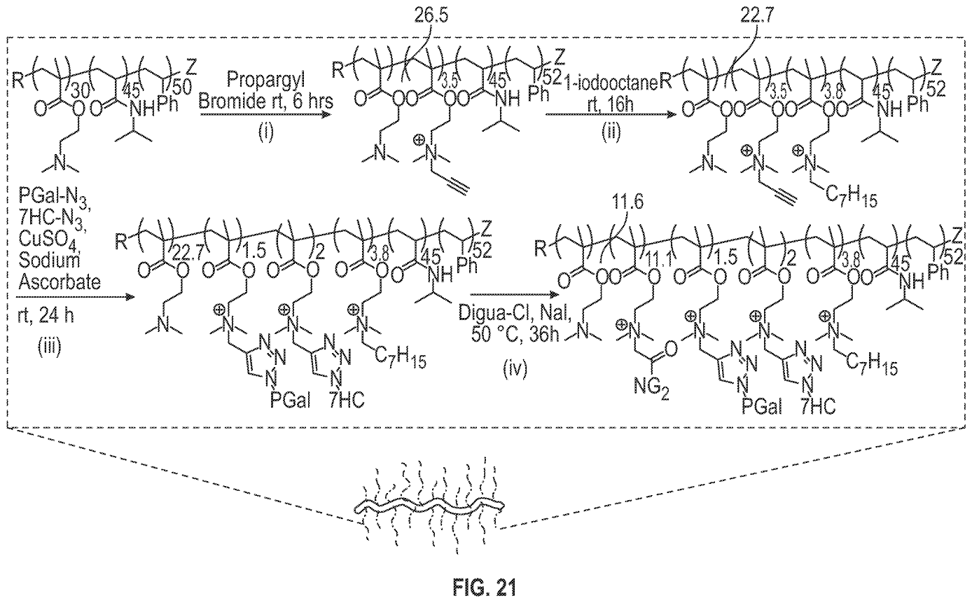

Now referring to FIG. 21, a synthetic pathway toward the nanostructure is described. A stepwise quaternization and ‘click’ method at room temperature was as follows: (i) propargyl bromide, (ii) 1-iodooctane, (iii) CuAAC with coumarin azide, (iv) and CuAAC with polysugar azide. The CuAAC used a combination of CuSO₄ and sodium ascorbate. Then the last step would be quaternization with digua-Cl by heating the functional nanoworms to 50° C. Two replicate experiments were conducted to test reproducibility, denoted as reaction A and reaction B.

### Quaternization of Nanoworm with Diguanidine Chloroacetamide at 60° C.

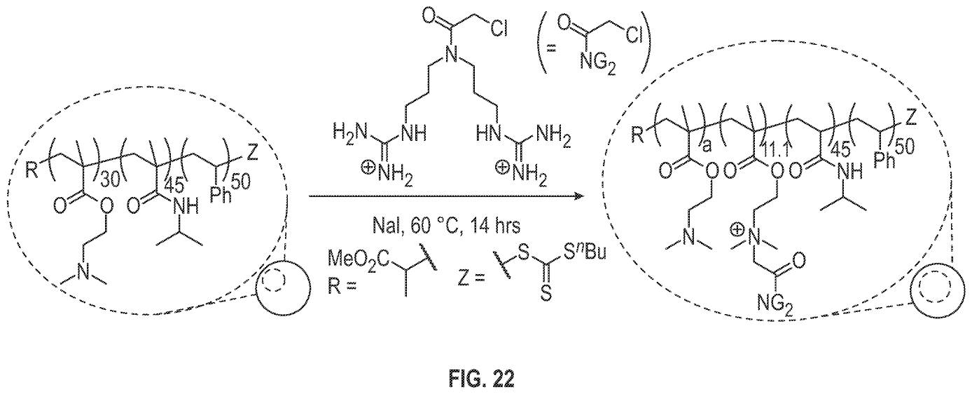

Now referring to FIG. 22, a latex was obtained from each of reaction A and reaction B with spheres (9.7 wt %, 7.84 g of latex, 760 mg of polymer and 1.0 mmol DMAEMA units) and was weighed in a round bottom flask with a stirrer bar. To this mixture was added a solution of NaI (56 mg, 0.37 mmol) in H₂O (2 mL) and digua-Cl (178 mg, 0.37 mmol) as a solid. After samples (200 μL) were taken for NMR analysis, as shown in FIG. 23, and before reaction to track the changes of digua-Cl, the reaction flask was placed into a preheated oil bath at 60° C. A loss of α-protons (a) of digua-Cl after 14 h, and loss of CH₃ protons (b) from the DMAEMA side groups is shown. The reaction was stirred for 14 h before an aliquot (200 μL) was taken for NMR analysis.

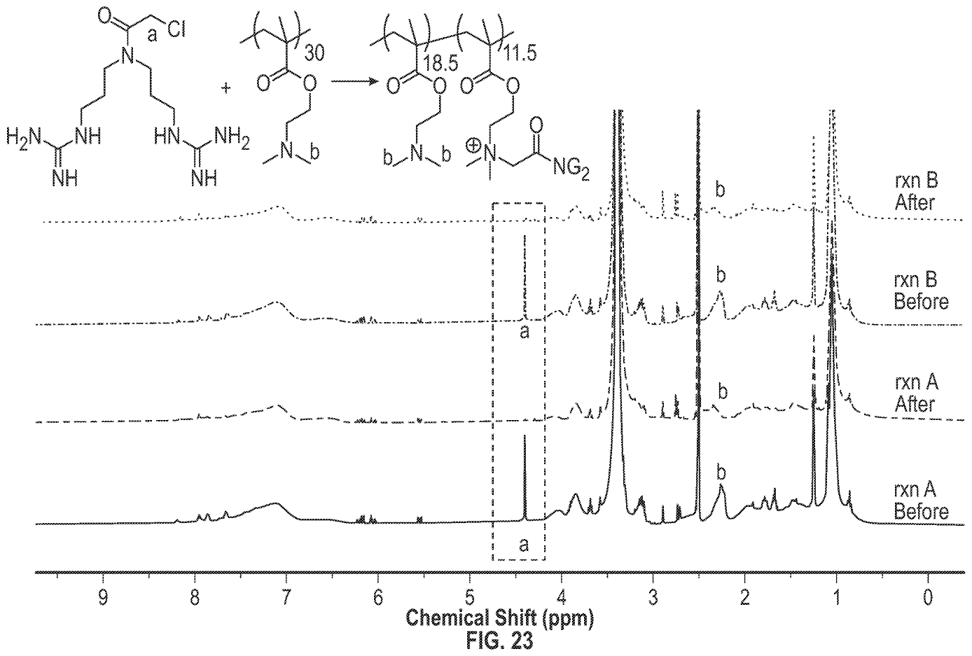

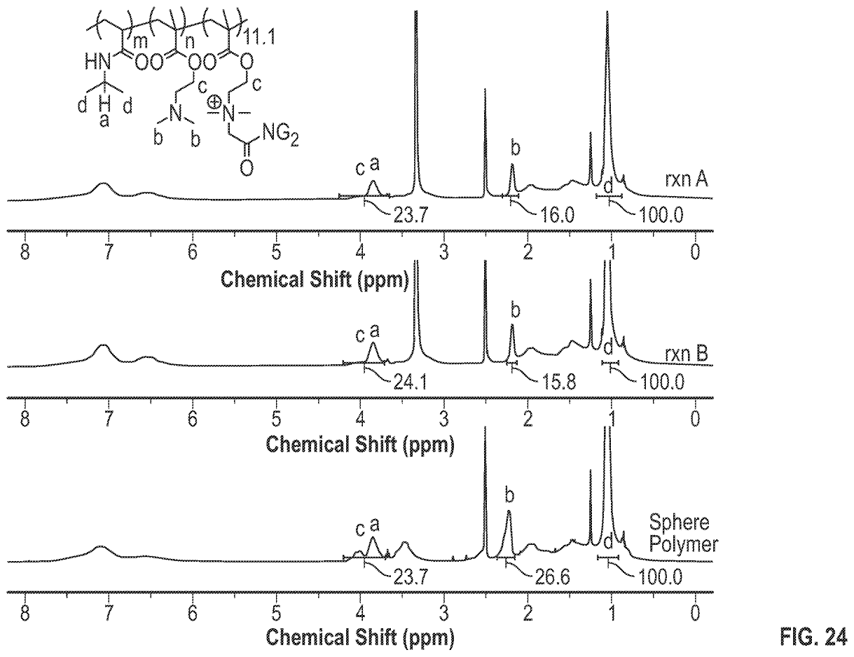

Samples were taken from both reactions, e.g., reaction A and reaction B, and dialyzed (MWCO 3.5 kDa, against tap water, 24 h, 5 buffer changes) and freeze-dried for NMR analysis, shown in FIG. 24.

Coupling efficiency for reaction A and reaction B of diguanidine-chloroacetamide to spheres is shown in Table 7.

TABLE 7

| | Reaction A | Reaction B |
|---|---|---|
| Units coupled | $30 \times ( 1 - \frac{16.0}{26.6} ) = 12$ | $30 \times ( 1 - \frac{15.8}{26.6} ) = 12.2$ |
| Coupling efficiency | = 12/11.1 = 108%. | = 12.2/11.1 = 110% |

### Quaternization of Nanoworm with Diguanidine Chloroacetamide at 50° C. Prior to Functionalization with Propargyl Bromide, 1-Iodooctane, Polysugar Azide and Coumarin Azide

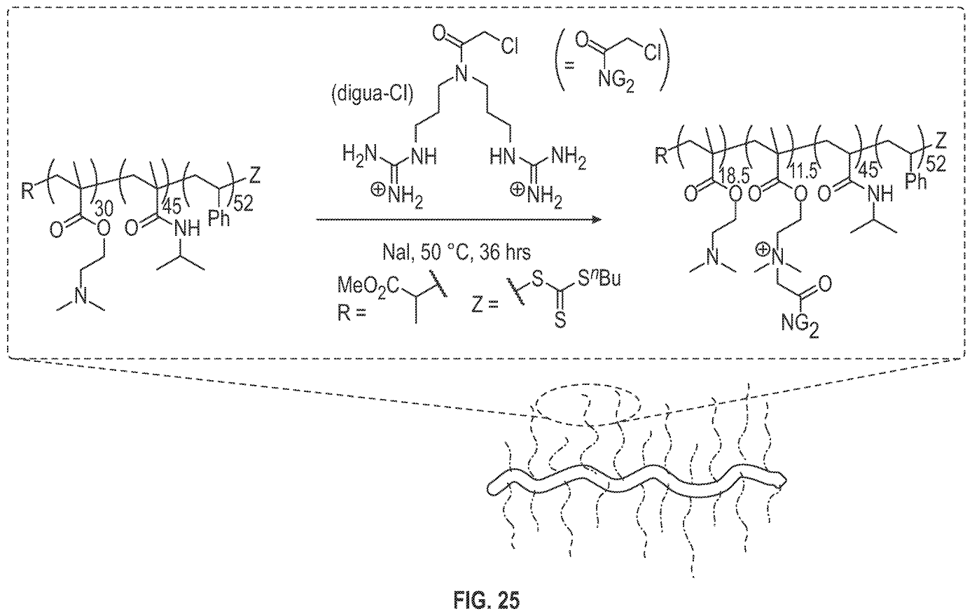

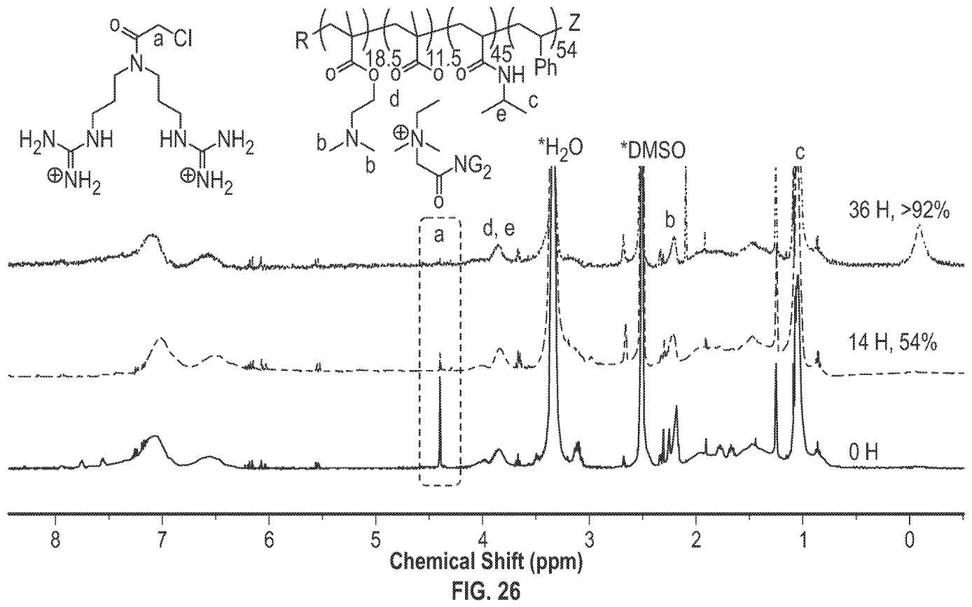

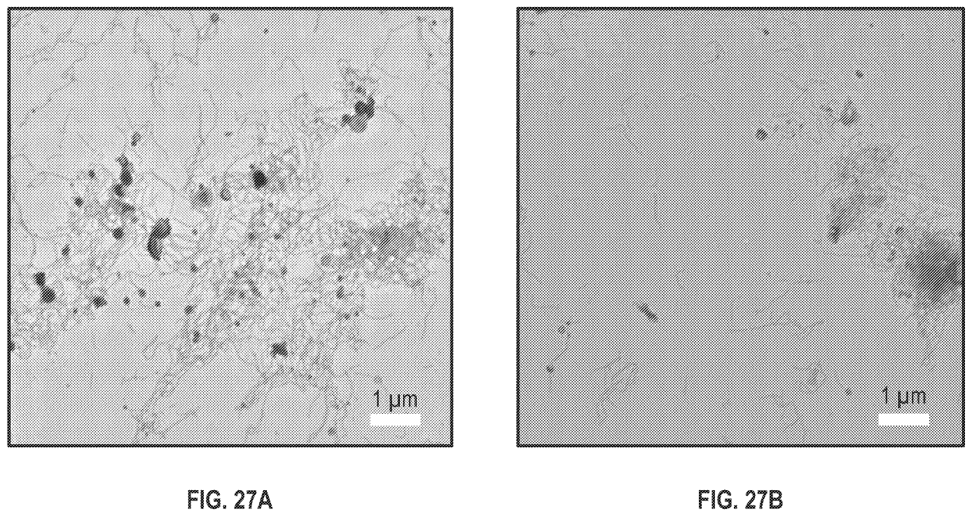

Now referring to FIG. 25, the nanoworm latex (8.2 wt %, 3.2 g, 0.3 mmol DMAEMA units) and H₂O (3 mL) was added to obtain a 4.1 wt % of nanoworm latex in water latex solution at room temperature. Diguanidine chloroacetamide (digua-Cl solid, 52.1 mg, 0.115 mmol) and NaI (17.3 mg, 0.115 mmol) was added the latex and then placed in an oil bath at 50° C. and stirred at 100 rpm for 14 h (i.e. overnight). The conversion of digua-Cl to quaternization of nanoworm with diguanidine was 54% (after 14 h), which increased to 92% after 36 h based on NMR analysis of the crude mixture, shown in FIG. 26. The morphologies after quaternization showed no change to the nanoworm structure, as shown in FIGS. 27A and 27B.

### Quaternization of Nanoworm with Propargyl Bromide

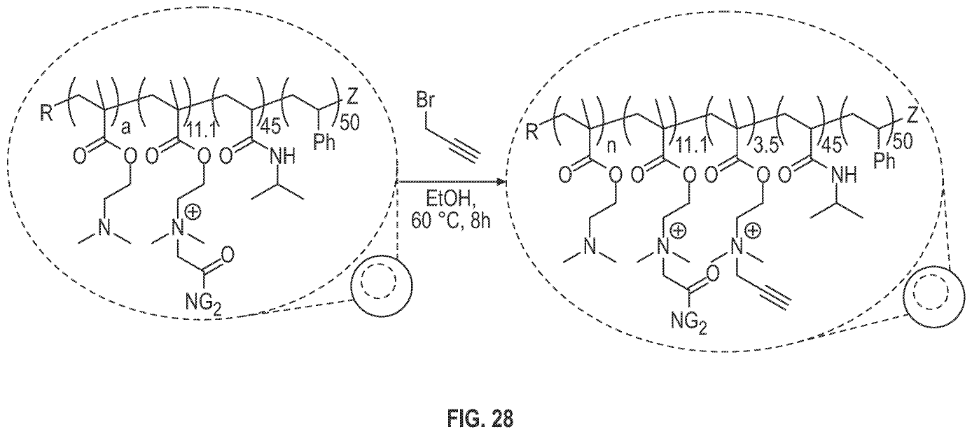

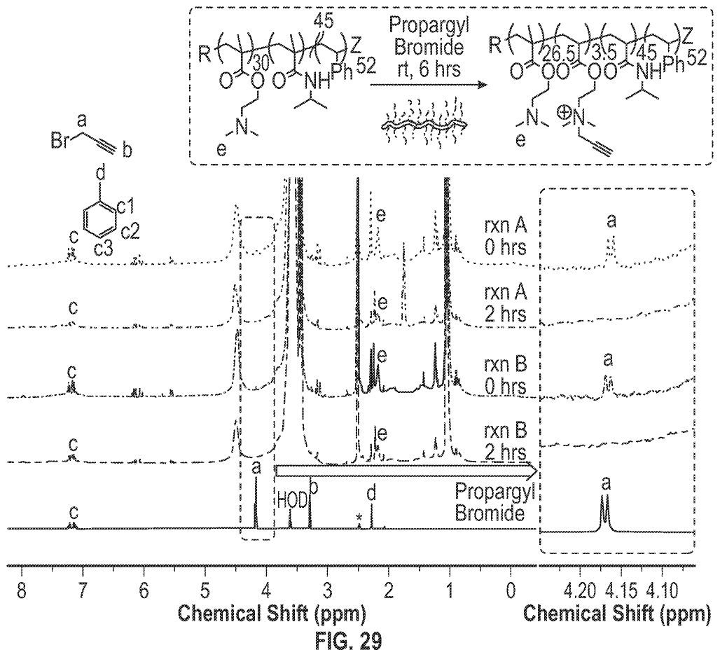

Now referring to FIG. 28, to each of the mixtures of each of reaction A and reaction B described above was added propargyl bromide solution in toluene (80 wt %, 17.4 mg in 500 μL EtOH) and the reactions were stirred at room temperature at a stirring speed of <50 rpm). The ¹H NMR showed that in 2 h, propargyl bromide was fully consumed at below NMR detection, shown in FIG. 29. The reactions was left for another 4 h before carrying out the next step.

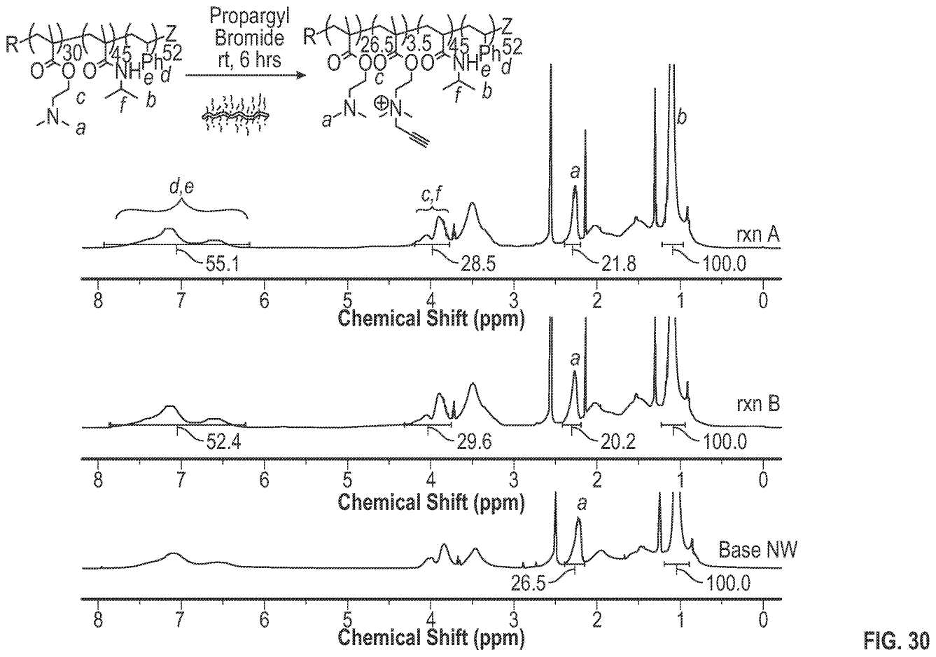

Samples were taken and purified via dialysis (MWCO 3.5 kDa, against tap water, 24 h, 5 buffer changes) and freeze-dried to determine coupling efficiency. Without being bound to a particular theory, possibly due to protonation of the DMAEMA units after quaternization, coupling efficiency based on integrations of DMAEMA shows higher than 100%, as shown in FIG. 30.

Coupling efficiency for reaction A and reaction B of propargyl bromide to spheres is shown in Table 8.

TABLE 8

| | Reaction A | Reaction B |
|---|---|---|
| Units coupled | $30 \times ( 1 - \frac{21.8}{26.5} ) = 5.3$ | $30 \times ( 1 - \frac{20.2}{26.5} ) = 7.1$ |
| Coupling efficiency | = 5.3/3.5 = 151%. | = 7.1/3.5 = 203% |

### Quaternization of Nanoworm with 1-Iodooctane

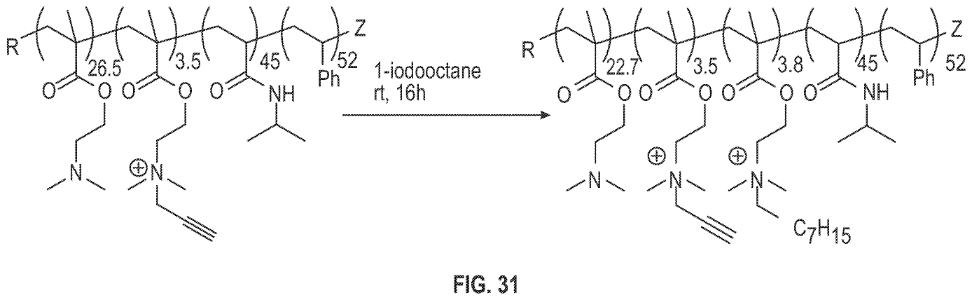

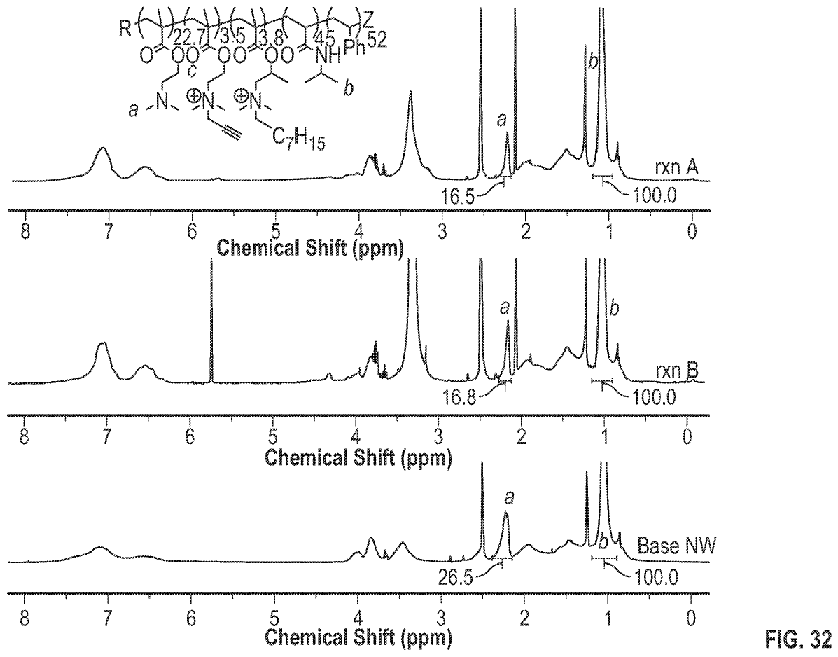

Now referring to FIG. 31, to the latex obtained from each of reaction A and reaction B was added 1-iodooctane in ethanol (30.4 mg in 0.395 mL) and the reaction was kept at room temperature overnight, e.g., about 8 hours to about 16 hours. Samples were taken and purified via dialysis (MWCO 3.5 kDa, against tap water, 24 h, 5 buffer changes) and analysed via ¹H NMR, shown in FIG. 32. The coupling efficiencies were above or at 100%. Coupling efficiency for reaction A and reaction B of 1-iodooctane to spheres is shown in Table 9.

TABLE 9

| | Reaction A | Reaction B |
|---|---|---|
| Units coupled | $30 \times \frac{21.8 - 16.5}{26.5} = 6.0$ | $30 \times \frac{20.2 - 16.8}{26.5} = 3.8$ |
| Coupling efficiency | = 6.0/3.8 = 158%. | = 3.8/3.8 = 100% |

### CuAAC Coupling with Polysaccharide Azide and Coumarin Azide

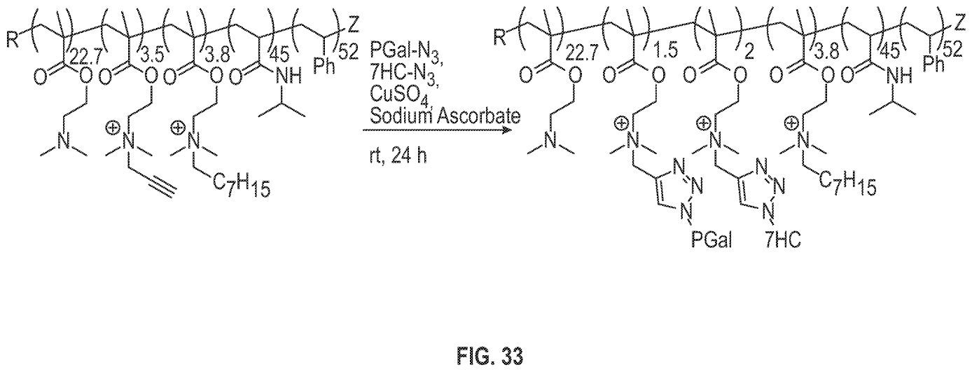

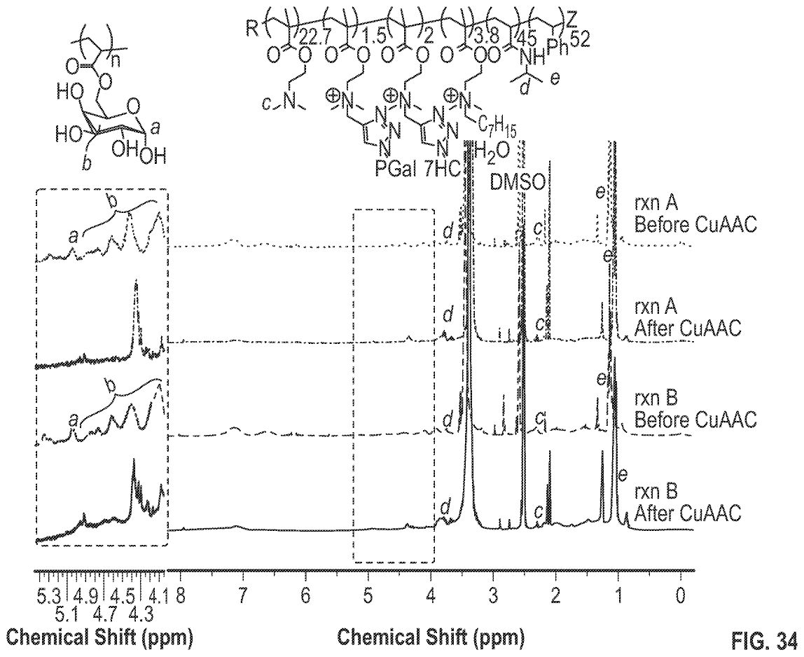

Now referring to FIG. 33, half the volume of each latex obtained was used to conduct the CuAAC reactions. To each latex was added sodium ascorbate (38 mg), polysaccharide azide solid (Mn 3200, 107 mg) and coumarin azide (5.1 mg in 250 μL EtOH). The resulting mixture was degassed with argon bubbling for 30 min. Then degassed CuSO₄·5H₂O solution in H₂O (48 mg, 0.19 mmol, 2.85 mL of 100 mg/6 mL solution) was added via syringe. The reactions were kept under argon for 24 h. After the CuAAC click reactions, the signals of polysugar were barely visible by ¹H NMR, as shown in FIG. 34. The samples for before CuAAC were from latex obtained from the last step with addition of polysugar-N₃ only. The samples after CuAAC were treated with neutral Al₂O₃ (stirred with a portion of the latex and then the supernatants were used). The addition of polysaccharide-N₃ to the latex without addition of copper catalyst showed the protons from the polysugar. The polysugar coupled to the nanoworms had reduced proton signals due to restricted mobility.

After the reaction, the mixtures were exposed to air, and an aqueous solution of EDTA trisodium salt was added to each reaction (0.5 M, 381 μL, 0.19 mmol, 1 equiv. to CuSO₄·5H₂O added above). The pH was found to be below 7.0 due to oxidated sodium ascorbate, and we therefore added solid K₂CO₃ (74 mg) to adjust basicity to be about pH 9-10 for the next step of reaction.

### CuAAC Click Reactions with poly(galactose)-azide and 3-azido-7-hydroxycoumarin

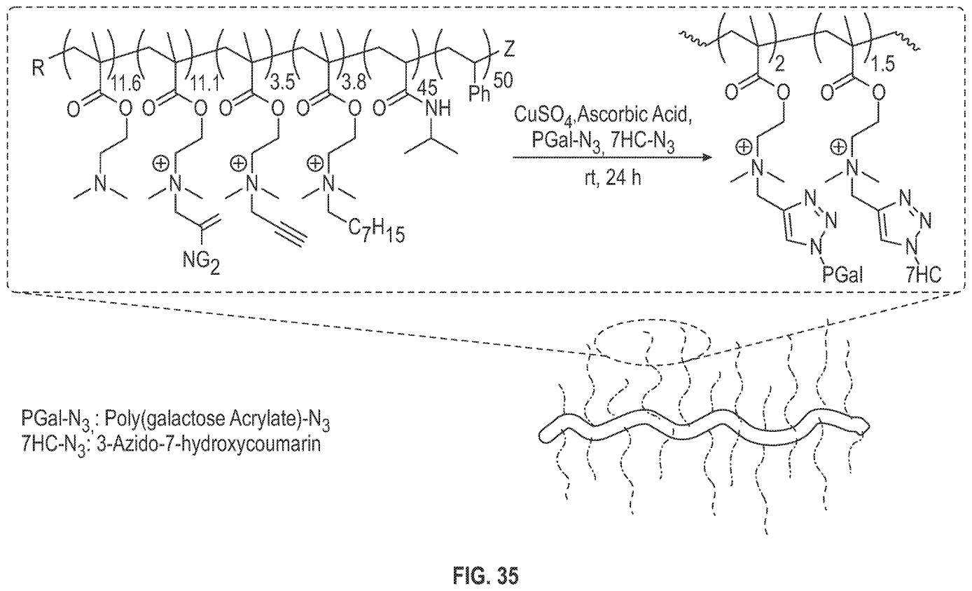

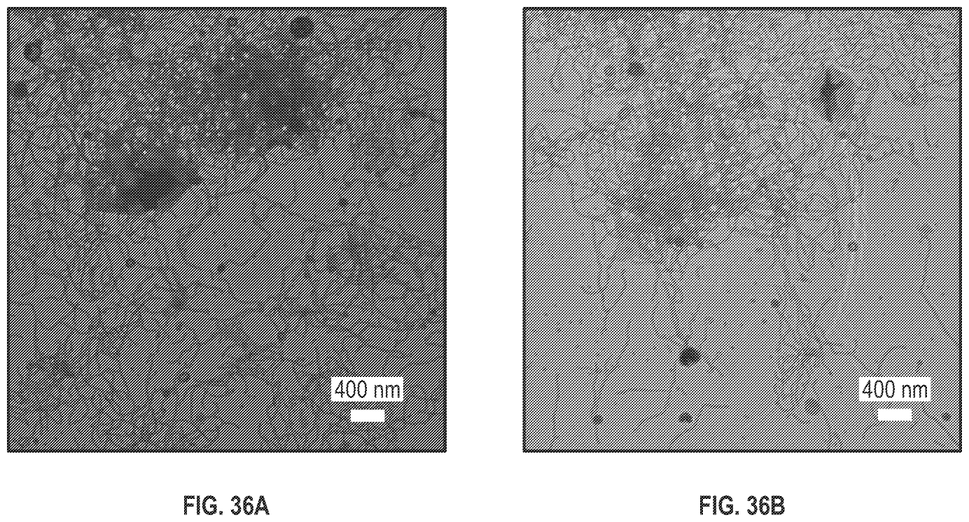

From the latex mixtures (i.e. after quaternizations), a 1 mL portion (with 0.015 mmol propargyl groups) was added with PGal-N₃ (Mn=3200, 27.2 mg, 0.0085 mmol) in H₂O (1 mL) and a solution of 7HC—N₃ (1.3 mg) in EtOH (100 μL), and were stirred to mix thoroughly, as shown in FIG. 35. Samples (200 μL) were immediately taken for NMR analysis of the crude mixture. Solid ascorbic acid (17 mg, 0.1 mmol, 6 equivalents to propargyl bromide added above) was added, and the mixtures were degassed under argon for −15 min. In another round bottom flask, CuSO₄ (24.2 mg, 6 equivalents to propargyl group) was dissolved in H₂O (2 mL), and the mixture degassed for −15 min. This CuSO₄ solution was transferred to the nanoworm latex via syringe. The reaction was stirred gently (at 50 rpm) under argon for 24 h before TEM analysis, shown in FIGS. 36A and 36B. The samples were then dialyzed (MWCO 10 kDa, against water with 0.2 wt % EDTA-Na₃ salt, 5 buffer changes in 48 h, then 4 hours with milli-Q water).

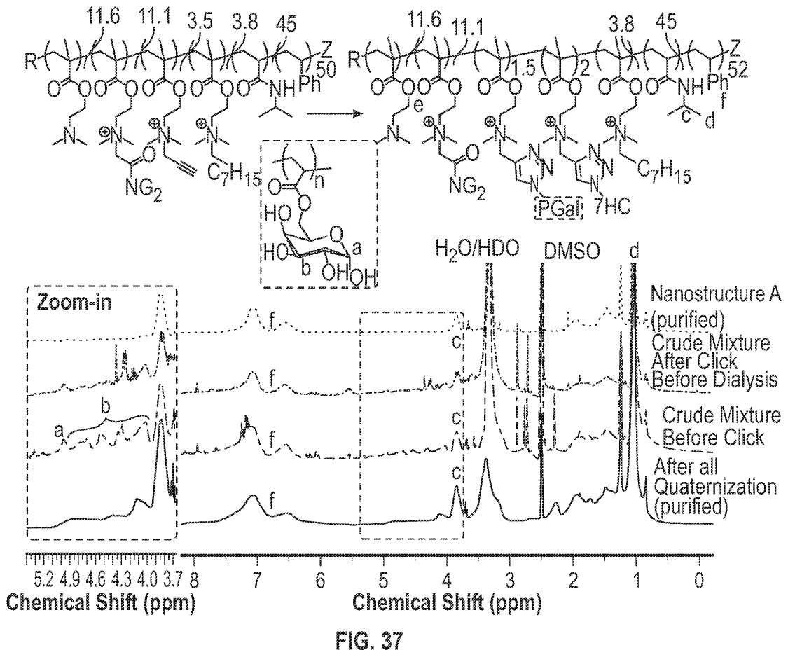

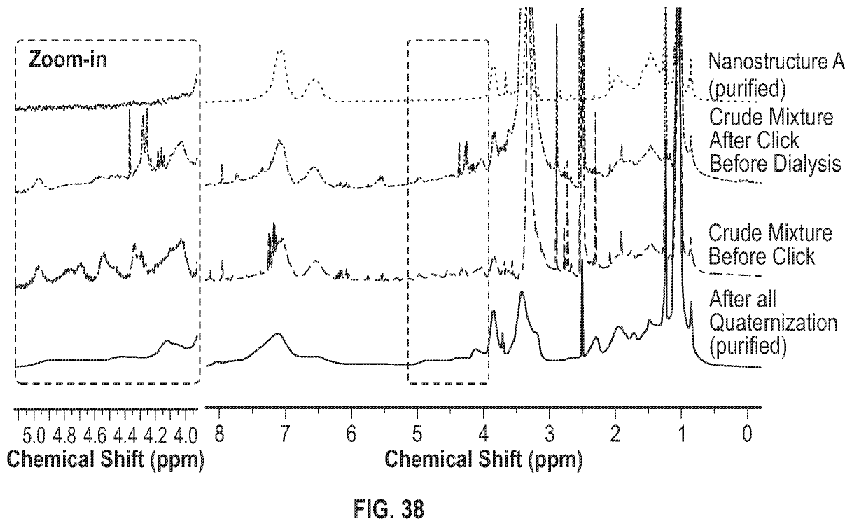

¹H NMR was conducted to determine the change of polysugar before and after the CuAAC ‘click’ reactions. Once coupled, the polysugar became much less visible in NMR of the crude mixture and not visible after purification, shown in FIGS. 37 and 38.

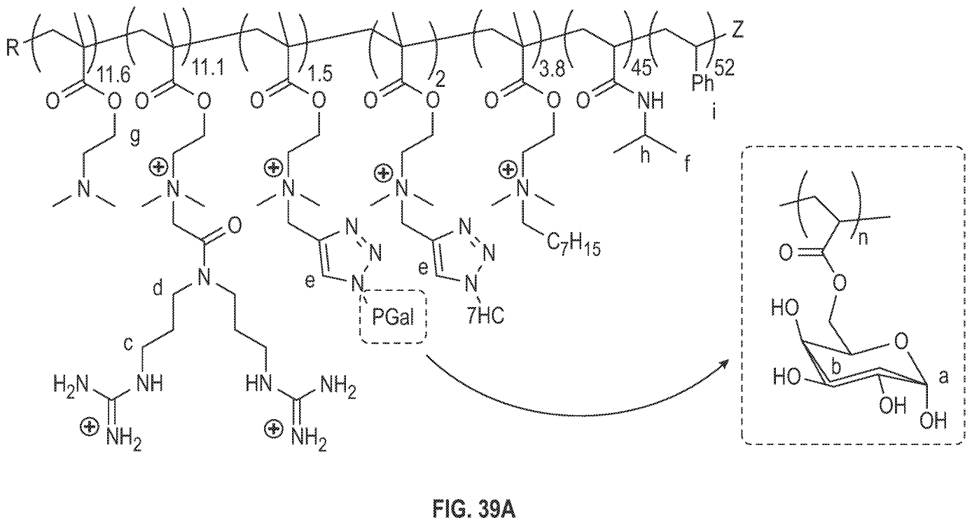

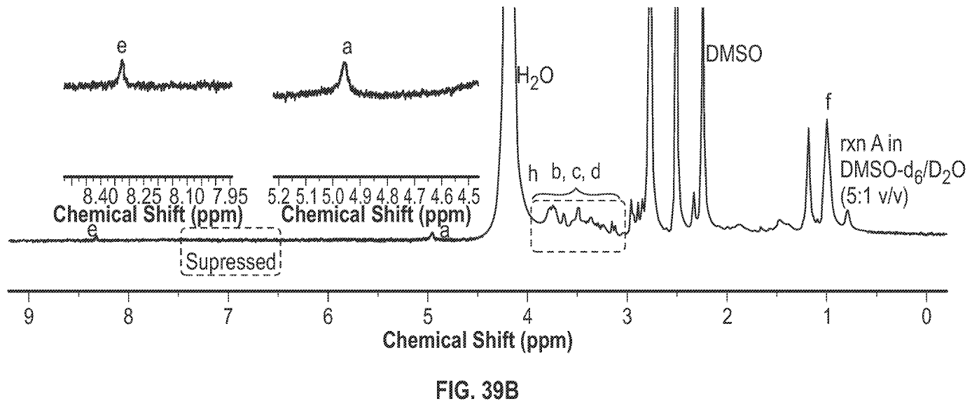

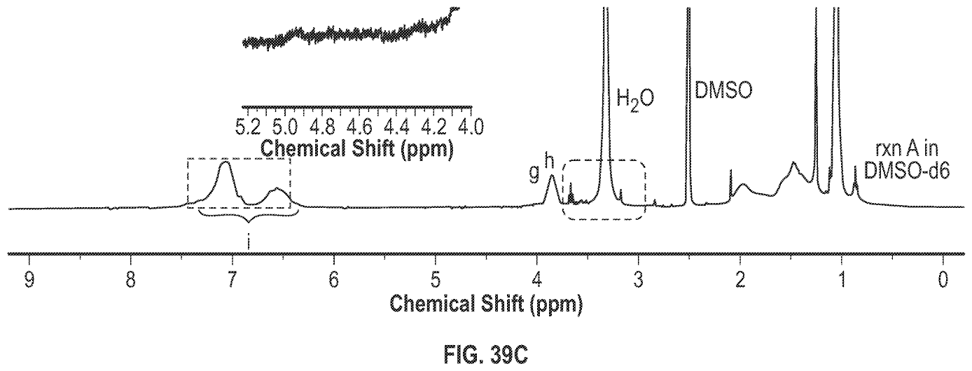

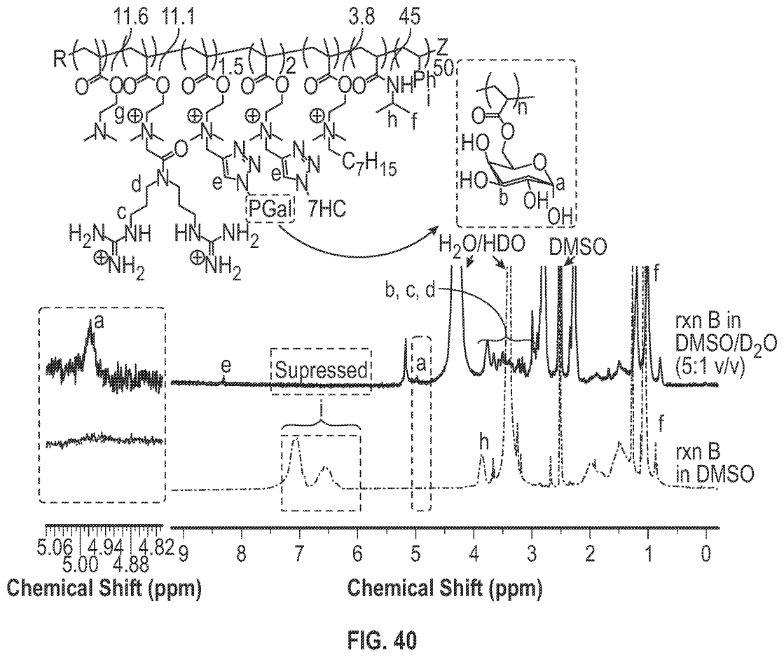

Upon addition of D₂O the polysugar protons were visible while at the same time suppressing polystyrene and others signals to make the triazole H-5 visible, shown in FIGS. 39 and 40.

### Quaternization of Nanoworm with Diguanidine Chloroacetamide at 50° C. After Functionalization with Propargyl Bromide, 1-Iodooctane, Polysugar Azide and Coumarin Azide

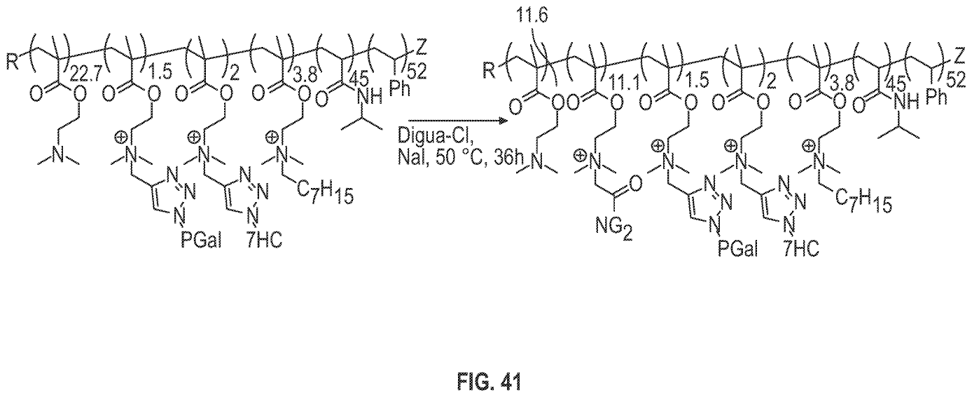

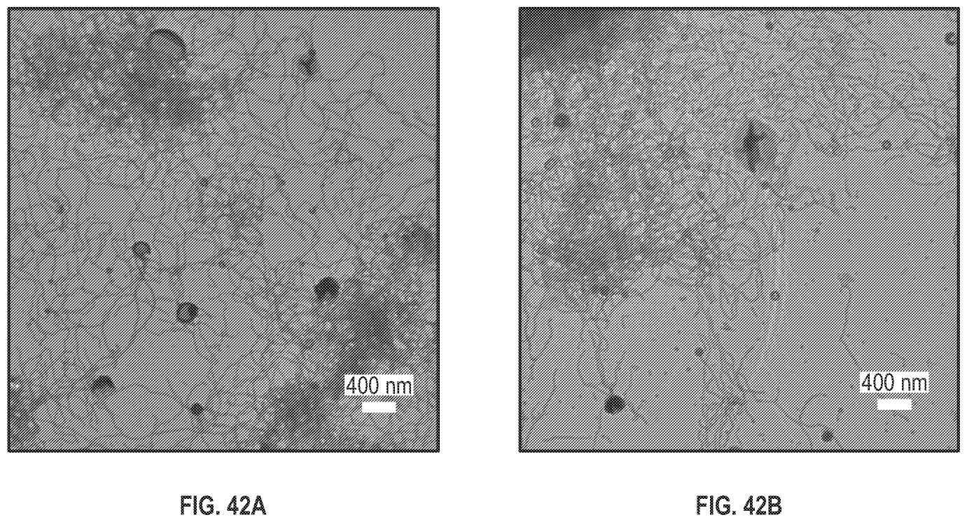

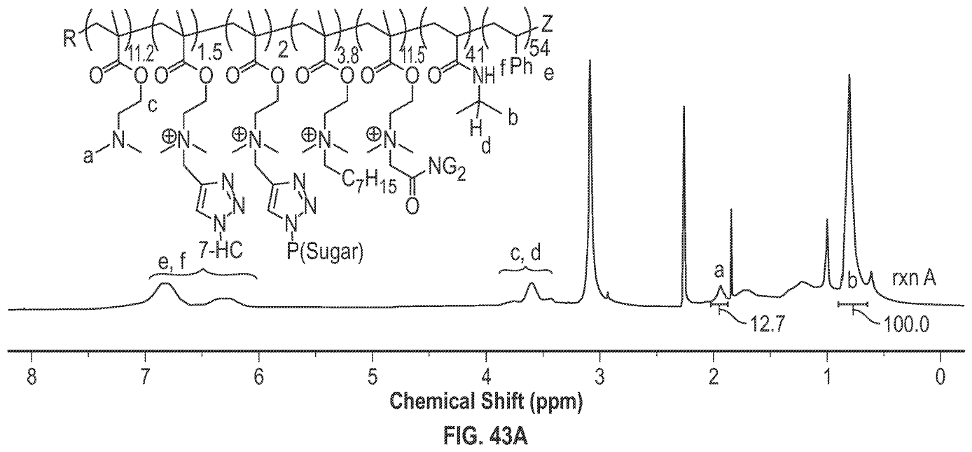

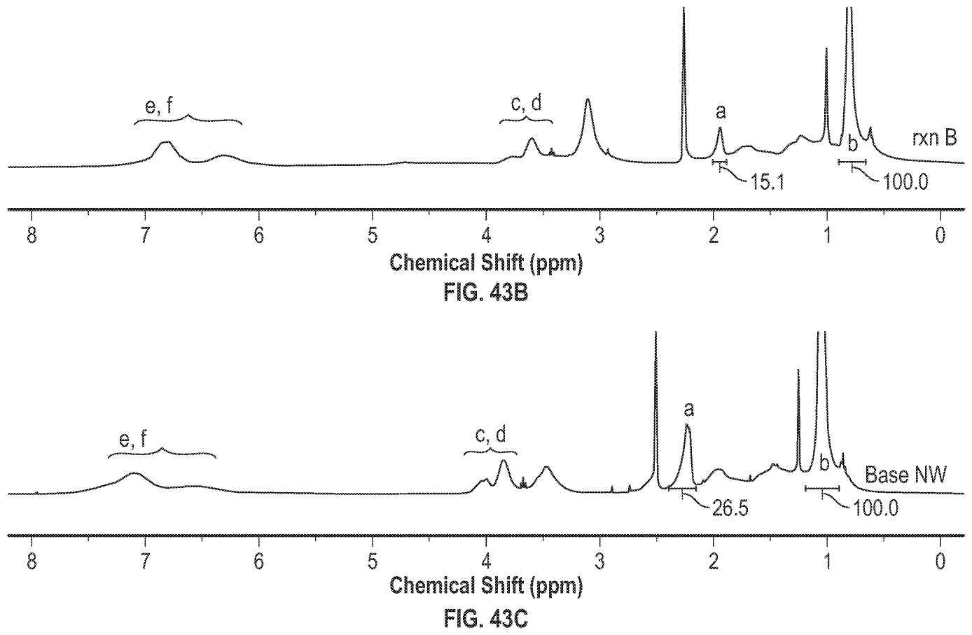

Now referring to FIG. 41, to the latex was added digua-Cl solid (87 mg, 0.19 mmol) and NaI (28.8 mg, 0.19 mmol). The reaction was then heated at 50° C. for 36 h. The TEM showed nanoworm structures were maintained after the reaction, shown in FIG. 42. Small sample portions were taken and purified via dialysis (MWCO 10 kDa, against tap water, 24 h, 5 buffer changes) for NMR analysis to determine coupling efficiency, shown in FIG. 43. The coupling efficiencies were 17% and 39% for the replicate experiments, e.g. reaction A and reaction B, shown in Table 10.

TABLE 10

| | Reaction A | Reaction B |
|---|---|---|
| Units coupled | $30 \times \frac{16.5 - 12.7}{26.5} = 4.3$ | $30 \times \frac{16.8 - 15.1}{26.5} = 1.9$ |
| Coupling efficiency | = 4.3/11.1 = 39%. | = 1.9/11.7 = 17% |

### Quaternizations of Nanoworm at Elevated Temperature with Polysugar Pseudo-Halide, Diguanidine Chloroacetamide and Iodooctane Components

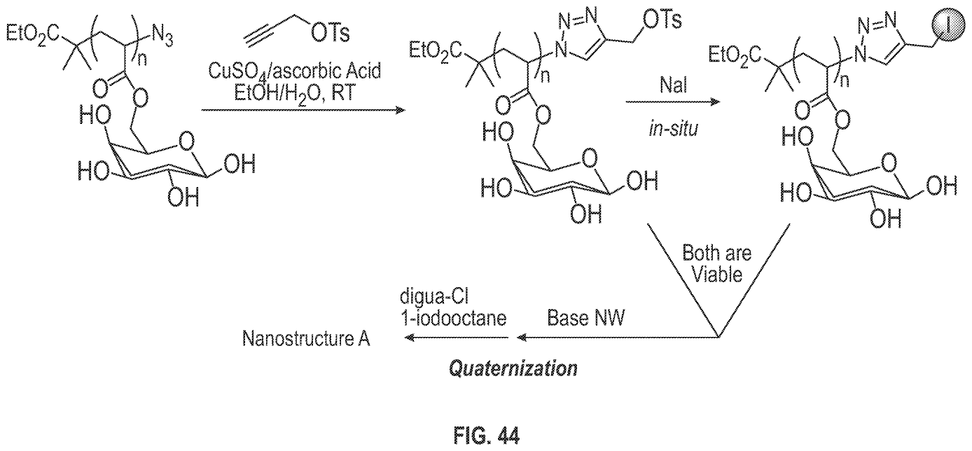

Now referring to FIG. 44, a method of coupling the polysugar via quaternization rather than CuAAC is described. The absence of ascorbate and EDTA can improve the coupling efficiency of the diguanidine chloroacetamide.

### Preparation of Quaternized Worms from Base Spheres (Nanostructure A Synthesis A-E, Small Scale, 10 mL)

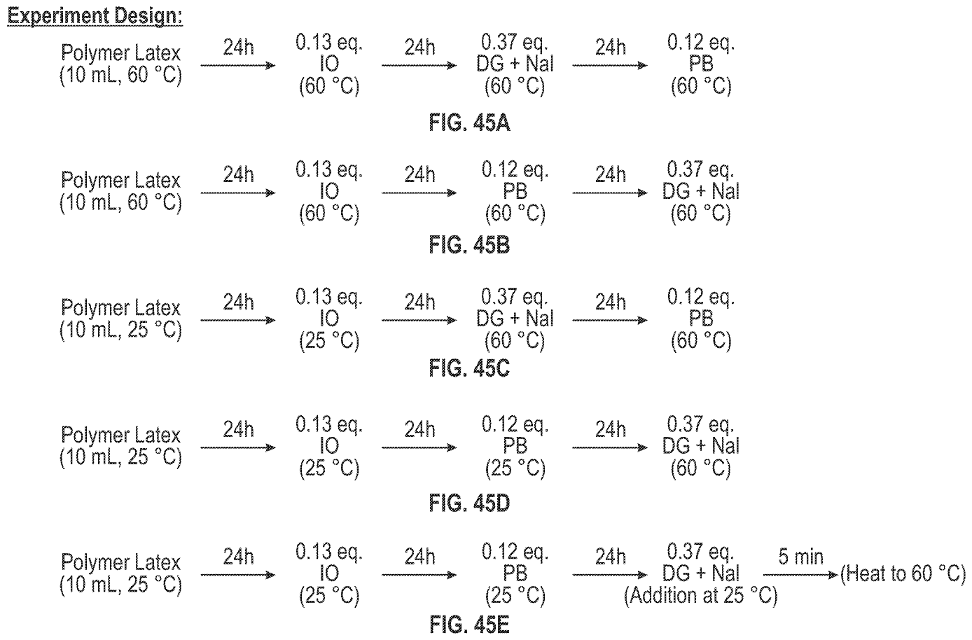

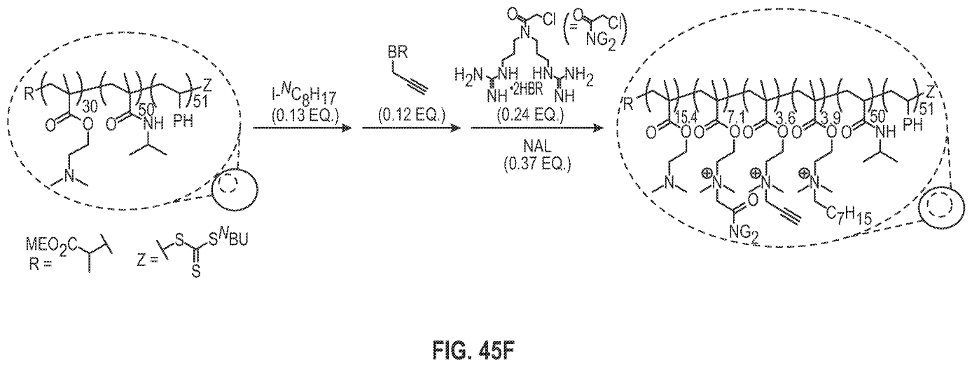

Now referring to FIGS. 45 A-F, nanostructure A was synthesized using a plurality of synthetic procedures, e.g., synthesis A, synthesis B, synthesis C, synthesis D, synthesis E, and synthesis F. Polymer latex (11.5 wt %, 11.4 g of latex, 1.3 g of polymer and 1.30 mmol of DMAEMA units) was placed in a 60° C. temperature-controlled water bath. To the mixture, iodooctane (40.6 mg, 1.69×10⁻⁴ mol) in 1.4 mL of EtOH was added and the reaction stirred for 24 h. Next, propargyl bromide (23.2 mg, 1.56×10⁻⁴ mol) in 1.4 mL of EtOH was added and the reaction stirred for 24 h. Finally, NaI (72 mg, 4.81×10⁻⁴ mol) in 0.36 mL of water and diguanidine-Cl (140.3 mg, 3.09×10⁻⁴ mol) in 0.70 mL of water was added and the reaction stirred for 24 h. After reaction completion, the polymer latex was cooled to 25° C. Visualization of colloidal stability during quaternization reactions is shown in Table 11.

TABLE 11

| | | |
|---|---|---|
| 1^{st} Addition | 2^{nd} Addition | 3^{rd} Addition |

| Expt. | Initial | 24 h | Initial | 24 h | Initial | 24 h |
|---|---|---|---|---|---|---|
| A | Yes | No | No | Yes | Yes | Yes |
| B | Yes | No | No | Yes | No | Yes |
| C | Yes | Yes | No | Yes | Yes | Yes |
| D | Yes | Yes | Yes | Yes | Semi | Yes |
| E | Yes | Yes | Yes | Yes | Yes | Yes |

Quaternization efficiency was determined by ¹H NMR, as shown in Table 12.

TABLE 12

| | Quaternization Efficiency (%) | | |
|---|---|---|---|
| Expt. | 1^{st} Addtion | 2^{nd} Addition | 3^{rd} Addition |
| A | 112 | 96 | 115 |
| B | 122 | 115 | 98 |
| C | 105 | 97 | 124 |
| D | 104 | 102 | 102 |
| E | 98 | 100 | 96 |

### Preparation of Quaternized Worms from Base Spheres ((Nanostructure A Synthesis A-E, Small Scale, 10 mL)

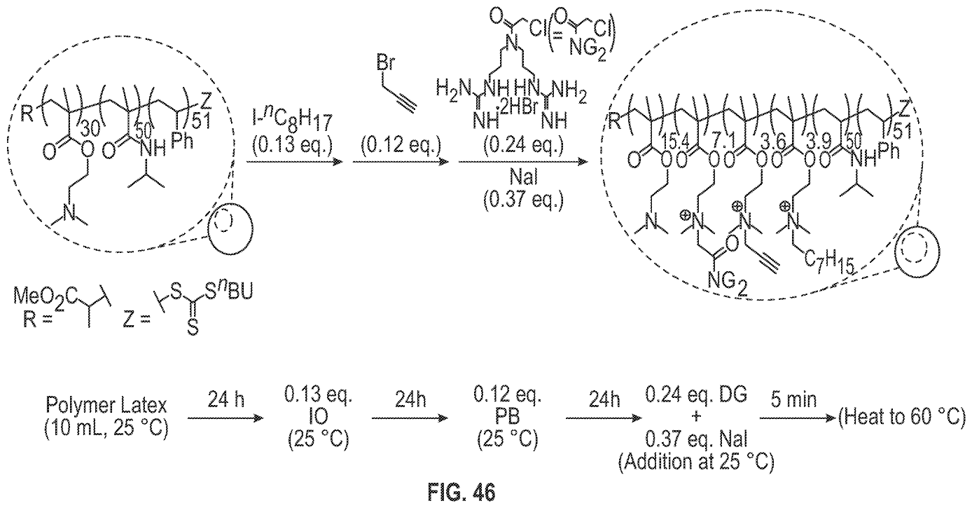

Now referring to FIG. 46, polymer latex (11.5 wt %, 11.4 g of latex, 1.3 g of polymer and 1.30 mmol of DMAEMA units) was placed in a 25° C. temperature controlled water bath. To the mixture, iodooctane (40.6 mg, 1.69×10⁻⁴ mol) in 1.4 mL of EtOH was added and the reaction stirred for 24 h. Next, propargyl bromide (23.2 mg, 1.56×10⁻⁴ mol) in 1.4 mL of EtOH was added and the reaction stirred for 24 h. Finally, NaI (72 mg, 4.81×10⁻⁴ mol) in 0.36 mL of water and diguanidine-Cl (140.3 mg, 3.09×10⁻⁴ mol) in 0.70 mL of water was added and the reaction stirred for 5 min. The reaction mixture was then heated to 60° C. and stirred for 24 h. After reaction completion, the polymer latex was cooled to 25° C. After reaching ambient temperature an increase in viscosity was observed for the polymer latex. TEM characterization showed the transformation of quaternized spheres to nanoworms without addition of toluene plasticizer. Visualization of colloidal stability during quaternization reactions is shown in Table 12.

TABLE 12

| | | |
|---|---|---|
| 1^{st} Addition | 2^{nd} Addition | 3^{rd} Addition |

| Initial | 24 h | Initial | 24 h | Initial | 24 h |
|---|---|---|---|---|---|
| Yes | Yes | Yes | Yes | Yes | Yes |

Quaternization efficiency was determined by ¹H NMR, as shown in Table 13.

TABLE 13
Quaternization Efficiency (%)

| 1^{st} Addtion | 2^{nd} Addition | 3^{rd} Addition |
|---|---|---|
| 98 | 100 | 96 |

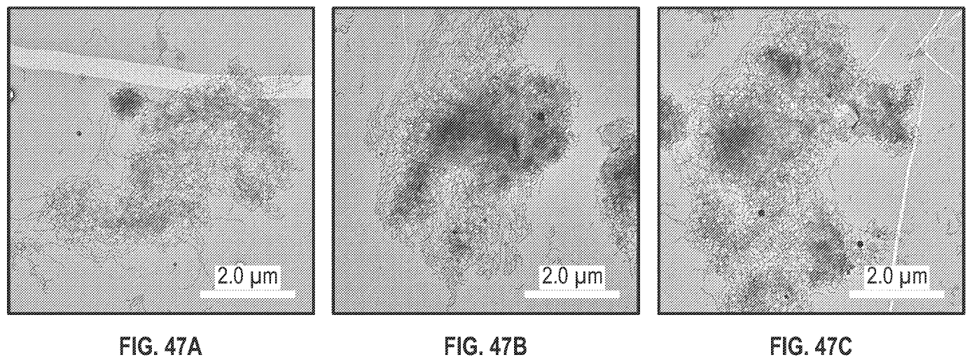

TEM micrographs after quaternization without addition of plasticizer are shown in FIGS. 47A-47C.

### Preparation of Quaternized Nanoworms by CuAAC

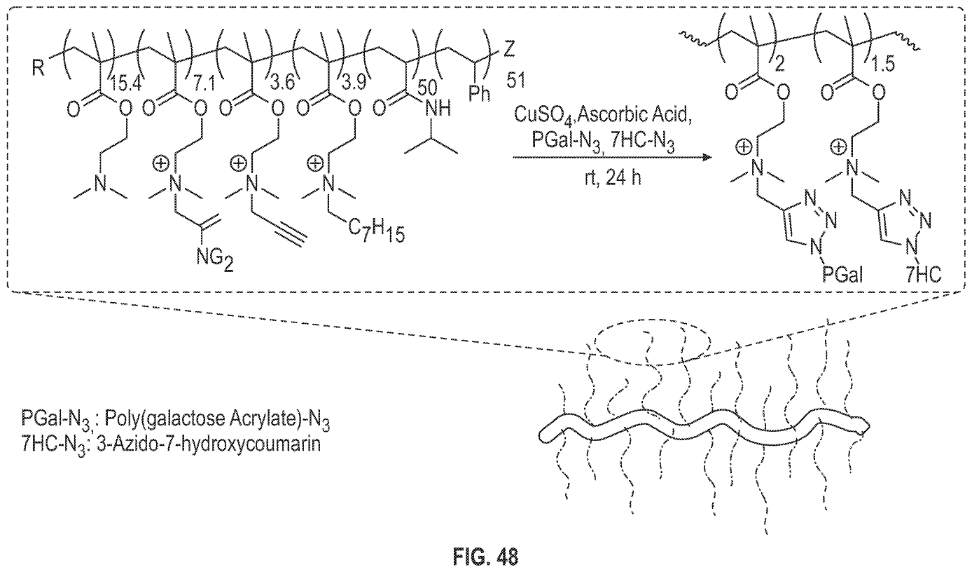

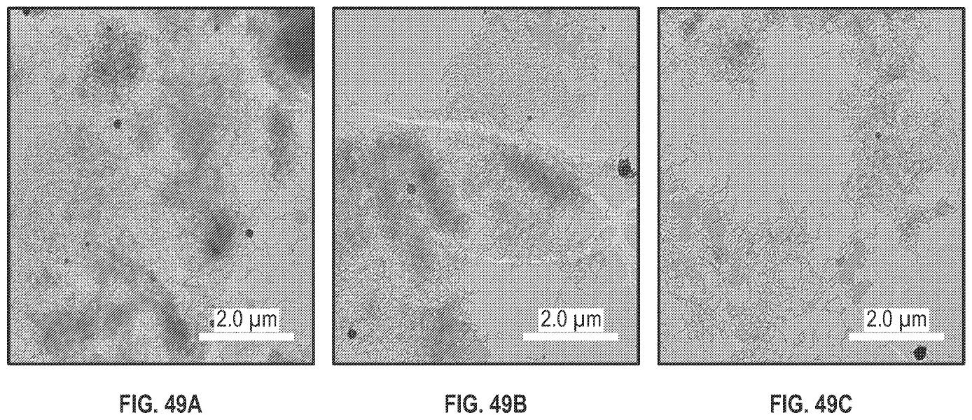

Now referring to FIG. 48, to the polymer latex (8 wt %, 11.4 g of latex, 1.3 g of polymer and 0.16 mmol of propargyl groups), P(galactose)-N₃ (153.3 mg, 6.13×10⁻⁵ mol) was added and degassed by bubbling with argon for 20 min. 3-azido-7-hydroxycoumarin (13.9 mg, 6.83×10⁻⁵ mol) was dissolved in 4.23 mL of EtOH, degassed by bubbling with argon for 20 min, then injected into the reaction mixture. Ascorbic acid (164.7 mg, 9.35×10⁻⁴ mol) was dissolved in 1 mL of water, degassed by bubbling with argon for 20 min, and then injected into the reaction mixture. CuSO₄ (149.3 mg, 9.35×10⁻⁴ mol) was dissolved in 1 mL of water, degassed by bubbling with argon for 20 min, and then injected into the reaction mixture. The CuAAC reaction was stirred under argon overnight, then purified by dialysis (MWCO 10 kDa) against water for 12 h. TEM images are shown in FIGS. 49A-49C.

### Transformation from Sphere to Nanoworm

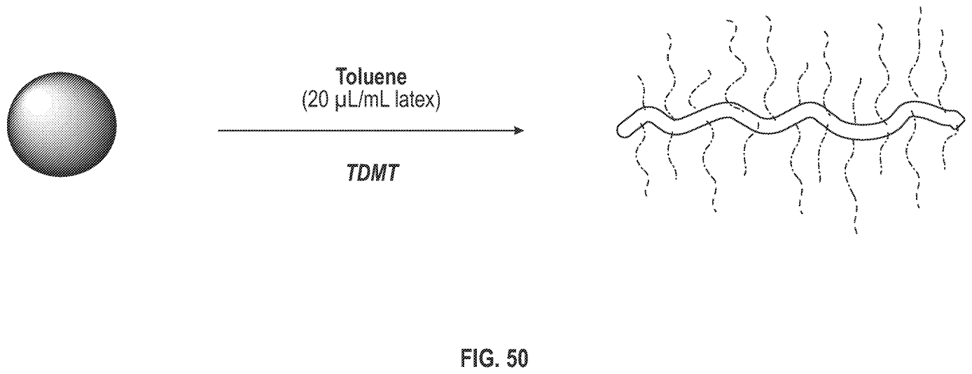

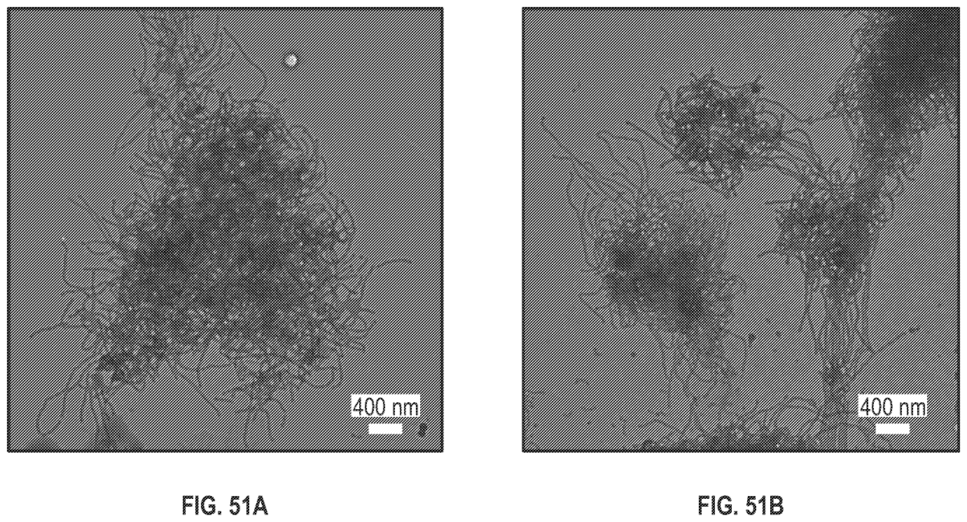

Now referring to FIG. 50, for each reaction mixture, samples (volumes of 200 μL×4=800 μL) were taken for analysis at each step, 7 mL latex was left from original latex (7.8 mL). Each of the latex mixtures was added toluene (140 μL, 20 μL/mL toluene:latex v/v) at 60° C. The resulting mixture was cooled to room temperature and allowed to stand still for 24 h at room temperature. The toluene was then removed by rotatory evaporator (20° C. water bath, 30 mBar, 2 h) and the mixtures were diluted back to 7 mL in volume due to water loss during removal of toluene. Upon cooling, TEM images were obtained and are shown in FIGS. 51A and 51B.

### Fluorescence Tests

Fluorescence tests were conducted on a fluorescence spectrophotometer to read fluorescent emissions at different concentrations of nanoworms. Controls were utilized for comparison.

The freeze-dried samples were weighed and then suspended in H₂O at room temperature to make a 1.5 wt % suspension. This mixture was placed in an ice-water bath for 1 h and shook at room temperature for 1 h. This suspension was then diluted to different concentrations. Samples at different concentrations were then added to a 96-well plate (200 μL each) prior fluorescent test, shown in Table 14.

TABLE 14

| | Weight percentage (wt %) | | | | | | |
|---|---|---|---|---|---|---|---|
| | 1.5 × | 1.5 × | 1.5 × | 1.5 × | 1.5 × | 1.5 × | Empty |
| Samples | 10⁰ | 10⁻¹ | 10⁻² | 10⁻³ | 10⁻⁴ | 10⁻⁵ | plate |
| Rxn A | 24603 | 9835 | 1363 | 146 | 30 | 12 | 3 |
| Rxn B | 23347 | 7363 | 920 | 99 | 18 | 8 | 3 |
| Control | 1439 | 1840 | 596 | 100 | 27 | 7 | 3 |
| Control | 697 | 1170 | 573 | 104 | 18 | 6 | 3 |
| repeat | | | | | | | |
| Control | 255 | 182 | 231 | 77 | 14 | 7 | 3 |
| Sodium | | | | | | | |
| Iodide | | | | | | | |

### Preparation of Nanostructure A (Large Scale, Reproduction)

### Synthesis of MacroCTA-A: P(NIPAM45)

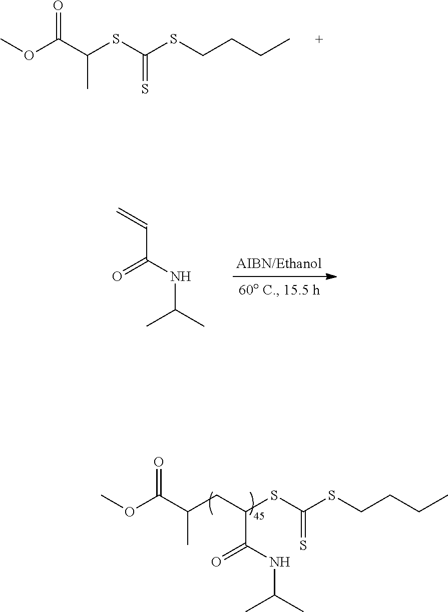

MacroCTA-A was synthesized as follows: The concentration ratio of NIPAM/MCEBTTC RAFT agent/AIBN was 45/1/0.15, and the ratio of ethanol to NIPAM was kept at 2/1 (v/w). NIPAM (7.20 g, 6.37×10⁻² mol) was dissolved in 14.4 mL of ethanol and stirred with basic alumina (50 mg) for 30 min to remove inhibitor. The mixture was filtered, then MCEBTTC RAFT agent (357.5 mg, 1.42×10⁻³ mol) and AIBN (35 mg, 2.13×10⁻⁴ mol) were added to the solution and degassed by bubbling with argon for 40 min. Polymerization of MacroCTA-A was carried out at 60° C. for 15.5 h. The reaction was quenched by exposure to air and used directly in the emulsion polymerization step. Molecular weight analysis was performed, results are shown in Table 15.

TABLE 15

| | Conv. (%) | Mₙ | Repeating Units |
|---|---|---|---|
| MacroCTA | NIPAM^{a} | Theory^{b} | NIPAM^{c} |
| MacroCTA-A | 99.2 | 5295 | 45 |

### Synthesis of MacroCTA-B: P(NIPAM₅₀-co-DMAEMA₃₀)

MacroCTA-B was synthesized as follows: The concentration ratio of NIPAM/DMAEMA/MCEBTTC RAFT agent/AIBN was 50/30/1/0.15, and the ratio of ethanol to NIPAM was kept at 2/1 (v/w). NIPAM (6.32 g, 5.58×10⁻² mol) and DMAEMA (5.27 g, 3.35×10⁻² mol) was dissolved in 12.6 mL of ethanol and stirred with basic alumina (50 mg) for 30 min to remove inhibitor. The mixture was filtered, then MCEBTTC RAFT agent (281.4 mg, 1.11×10⁻³ mol) and AIBN (27.8 mg, 1.69×10⁻⁴ mol) were added to the solution and degassed by bubbling with argon for 40 min. Polymerization of MacroCTA-B was carried out at 70° C. for 15.5 h. The reaction was quenched by exposure to air and used directly in the emulsion polymerization step. Molecular weight analysis was performed, results are shown in Table 16.

TABLE 16

| | Conv. (%)^{a} | | Mₙ | Repeating Units^{c} | |
|---|---|---|---|---|---|
| MacroCTA | NIPAM | DMAEMA | Theory^{b} | NIPAM | DMAEMA |
| MacroCTA-B | 97.2 | 100 | 10485 | 49 | 30 |

### Preparation of Base Spheres by Emulsion Polymerization (300 mL Scale)

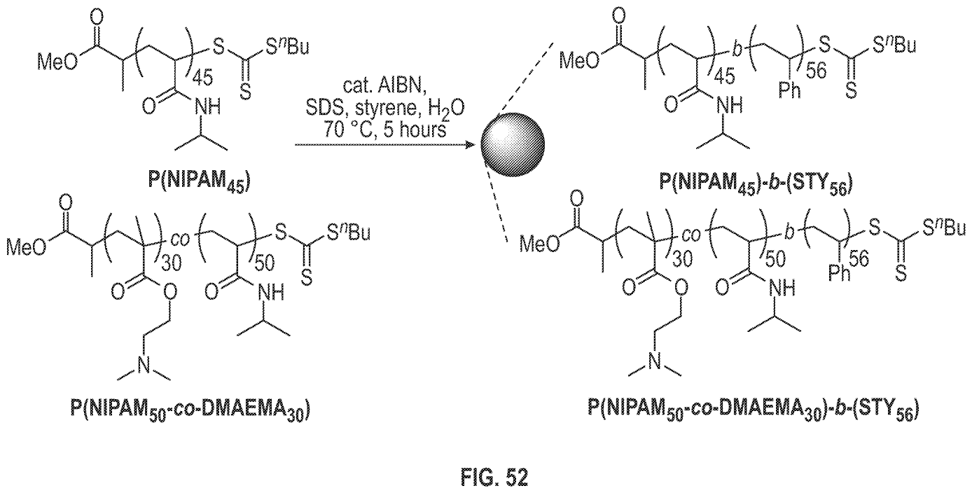

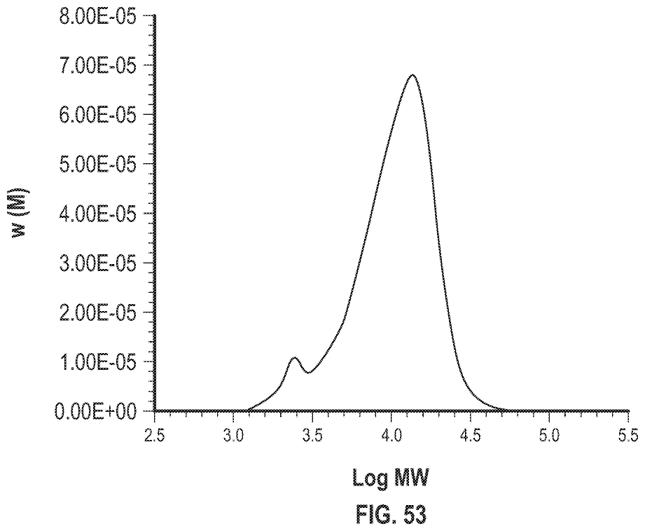

Now referring to FIG. 52, the emulsion polymerization of styrene with MacroCTA-A and MacroCTA-B was as follows: MacroCTA-A solution (18.96 g_{(MacroCTA-A+EtOH)}, 7.51 g_{(MacroCTA-A)}, 1.42×10⁻³ mol_{(MacroCTA-A)}), MacroCTA-B (21.87 g_{(MacroCTA-B+EtOH)}, 11.70 g_{(MacroCTA-B)}, 1.12×10⁻³ mol_{(MacroCTA-B)}) and SDS (0.77 g, 2.66×10⁻³ mol) were dissolved in 300 mL of cold water at 4° C. for 24 h. The solution was degassed by bubbling with argon for 45 min. Then, solution of AIBN (63 mg, 3.80×10⁻⁴ mol) and styrene (14.80 g, 1.42×10⁻¹ mol) was injected into the polymerization mixture. The mixture was further degassed by bubbling with argon for 15 min, then polymerized at 70° C. for 5 h. The reaction was stopped by exposure to air at 70° C. for 4 h, then the polymer latex was cooled to 25° C. and left to stand for 24 h. Molecular weight analysis and SEC trace analysis was performed, results are shown in Table 17 and FIG. 53.

TABLE 17

| Conv. | Styrene | | | SEC^{e} | | | |
|---|---|---|---|---|---|---|---|
| (%)^{a} | Units^{b} | M_{n (Theory)}_{^{c}} | M_{n (H NMR)}_{^{d}} | M_{n (RI)} | Ð_{(RI)} | M_{n (TD)} | Ð_{(TD)} |
| 93% | 51 | 12996 | 12892 | 12701 | 1.22 | 13029 | 1.21 |

### Preparation of Nanostructure A Quaternized Worms from Base Spheres (Large Scale, 300 mL)

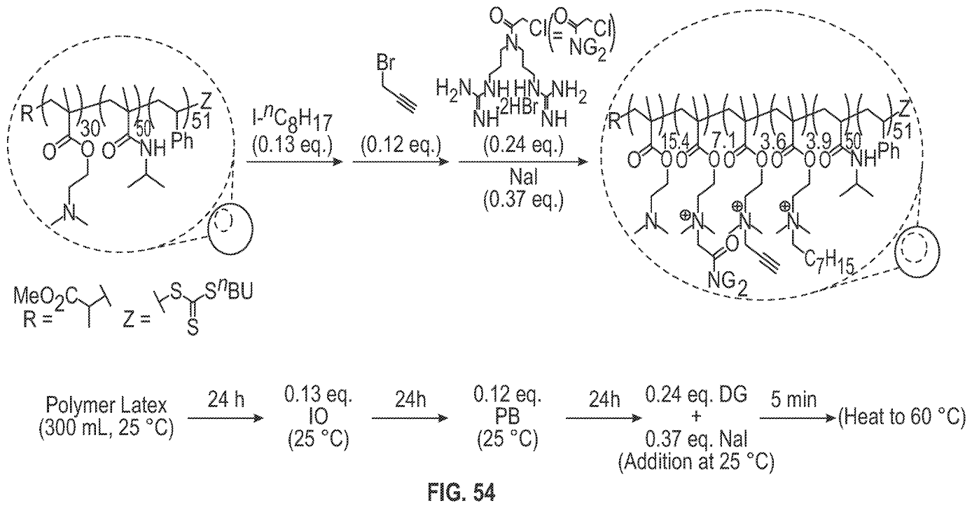

Now referring to FIG. 54, the polymer latex (300 mL, 3.35×10⁻² mol of DMAEMA units) was placed in a 25° C. temperature-controlled water bath. To the mixture, iodooctane (1.0453 g, 4.35×10⁻³ mol) in 27.5 mL of EtOH was added and the reaction stirred for 24 h. Next, propargyl bromide (0.5975 g, 4.02×10⁻³ mol) in 27.5 mL of EtOH was added and the reaction stirred for 24 h. Finally, NaI (1.8571 g, 1.24×10⁻² mol) in 9.3 mL of water and diguanidine-Cl (3.6152 g, 7.97×10⁻³ mol) in 18.1 mL of water was added and the reaction stirred for 5 min. The reaction mixture was then heated to 60° C. and stirred for 24 h. After reaction completion, the polymer latex was cooled to 25° C. After reaching ambient temperature an increase in viscosity was observed for the polymer latex. TEM characterization showed the transformation of quaternized spheres to nanoworms without addition of toluene plasticizer. Visualization of colloidal stability during quaternization reactions is shown in Table 18.

TABLE 18

| | | |
|---|---|---|
| 1^{st} Addition | 2^{nd} Addition | 3^{rd} Addition |

| Initial | 24 h | Initial | 24 h | Initial | 24 h |
|---|---|---|---|---|---|
| Yes | Yes | Yes | Yes | Yes | Yes |

Quaternization efficiency was determined by ¹H NMR, as shown in Table 19.

TABLE 19
Quaternization Efficiency (%)

| 1^{st} Addtion | 2^{nd} Addition | 3^{rd} Addition |
|---|---|---|
| 100 | 98.7 | 97.9 |

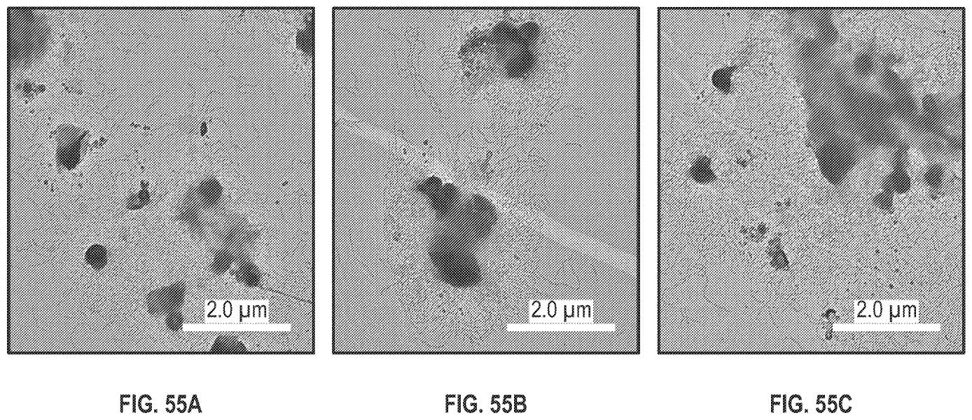

TEM micrographs after quaternization without addition of plasticizer are shown in FIGS. 55A-55C.

### Virucidal Activity

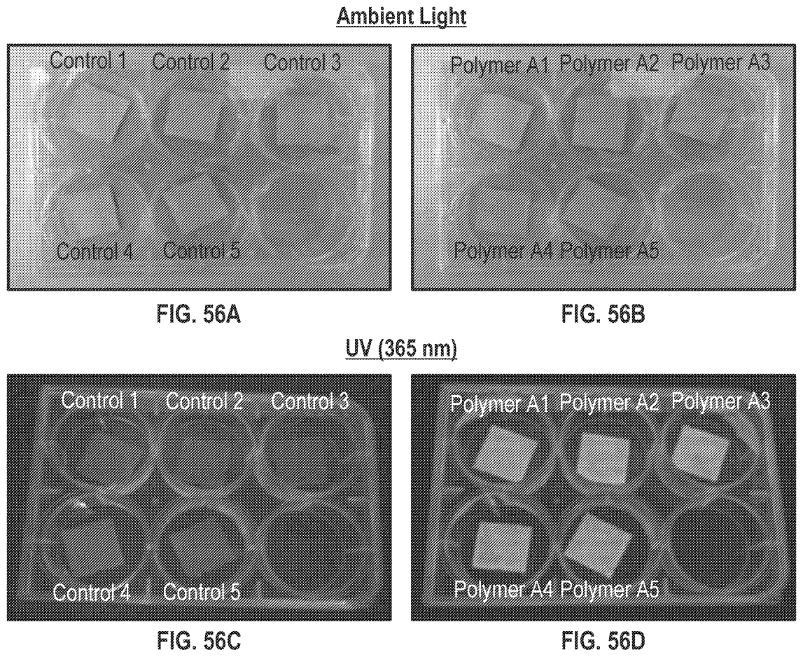

Now referring to FIGS. 56A-56D, tray table samples prepared for virus testing were uncoated or coated with 5 sprays of nanostructure A. The trays were analyzed under Ambient Light and UV light.

A plurality of samples were analyzed to determine virucidal activity, as shown in Table 20.

TABLE 20

| Sam- | | Viruses (# of surfaces) | | | |
|---|---|---|---|---|---|
| ple | New code | Influenza | alpha | delta | omicron |
| 1 | Comparative 1 - Rod | 5 | | | 5 |
| 2 | Comparative 2 - Worm | 5 | | | 5 |
| 3 | Nanostructure A - Rod | 5 | | | 5 |
| 4 | Nanostructure A - Worm (1) | 5 | 5 | | 5 |
| 5 | Nanostructure A - Worm (2) | 5 | | | 5 |
| 6 | Nanostructure A - Worm (3) | | | | |
| 7 | Nanostructure A - Worm (4) | | | 5 | |
| 8 | Nanostructure A - Worm (5) | | | 5 | |
| 9 | Nanostructure A - Worm (6) | | 5 | | |
| 10 | Control | 5 | 5 | 5 | 5 |

### Virucidal Activity of Nanostructure A for SARS-CoV-2

Inoculum was created by adding an equal volume of virus stocks to of filter sterilized Sorensen's pH buffer at pH=6.5. 50 μL of inoculum was added dropwise to the provided tray tables (2×2 cm). Samples were incubated for 30 min (at room temperature, lid on plate within the BSCII hood). After the 30 min incubation period (step 2), 0.5 mL infection media (MEM+antibiotics) was added to the sample and vigorously pipetted to remove unbound virions/virus debris from the coated surface. The pipetting did not scratch the surface. Media was collected for quantitation of infectious virus titre via TCID50 (for P13 and untreated samples only) and qRT-PCR (for all samples). The TCID50 was performed immediately upon sampling. For RNA extraction, samples were placed immediately in the lysis buffer, then RNA extracted. The RNA was stored at −80° C. until processed via qRT-PCR.

A 50% Tissue Culture Infectious Dose assay (TCID₅₀) was performed according to the following protocol. Plates to establish ˜95% monolayers of Vero cells were seeded 24 h prior to assay. After verification of quality/density of monolayer, the plates were washed using infection media (to remove any cell debris), then transferred into the PC3 laboratory. Samples were generated, serially diluted and a known volume inoculated into each well containing MEM infection media (containing pen/strep, glutamine, HEPES, but does not contain FBS)+TPCK trypsin (1 ug/mL). Plates were returned to incubator (37° C., 5% CO2) and microscopically examined for cytopathic effect (CPE) on cells at 5 days post infection (Omicron takes 48 h longer to induce CPE in Vero cells than the other VOC isolates). Samples were passaged a second time in Vero cells to confirm any virus induced CPE, or lack thereof. The TCID50/mL of infectious virus present in the original sample was then determined.

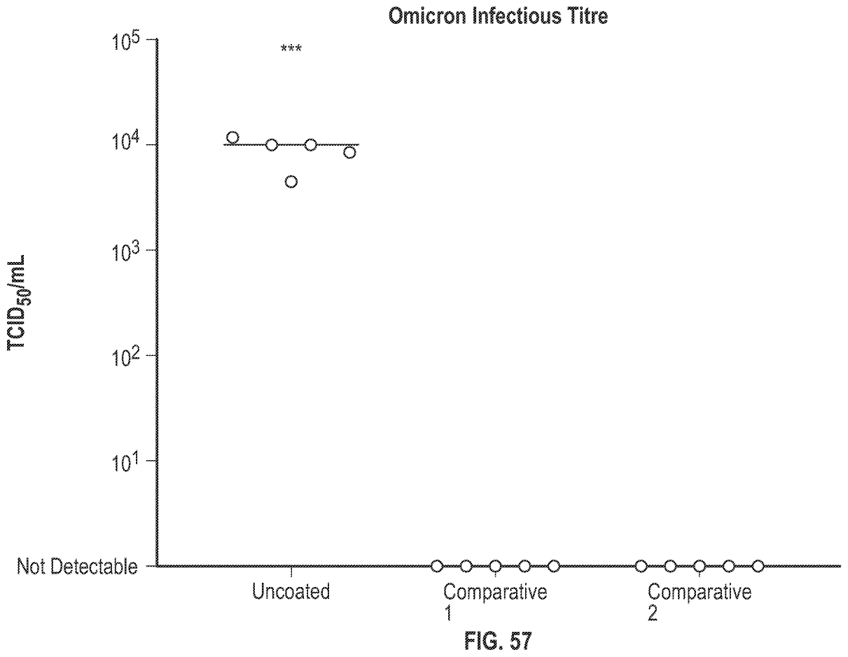

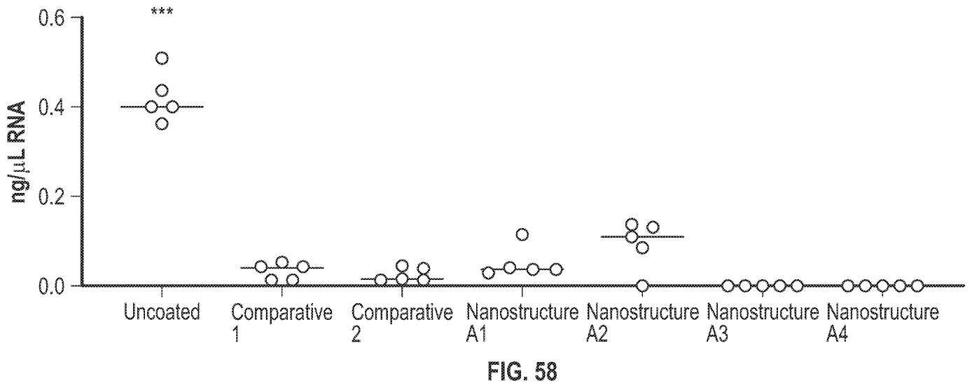

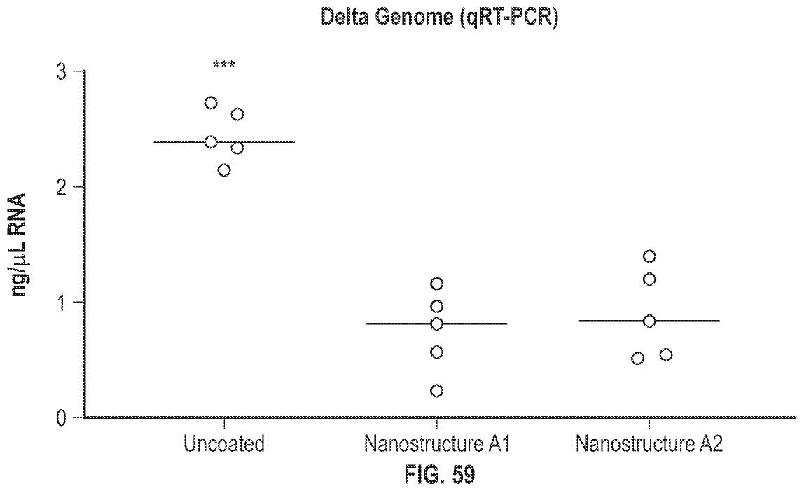

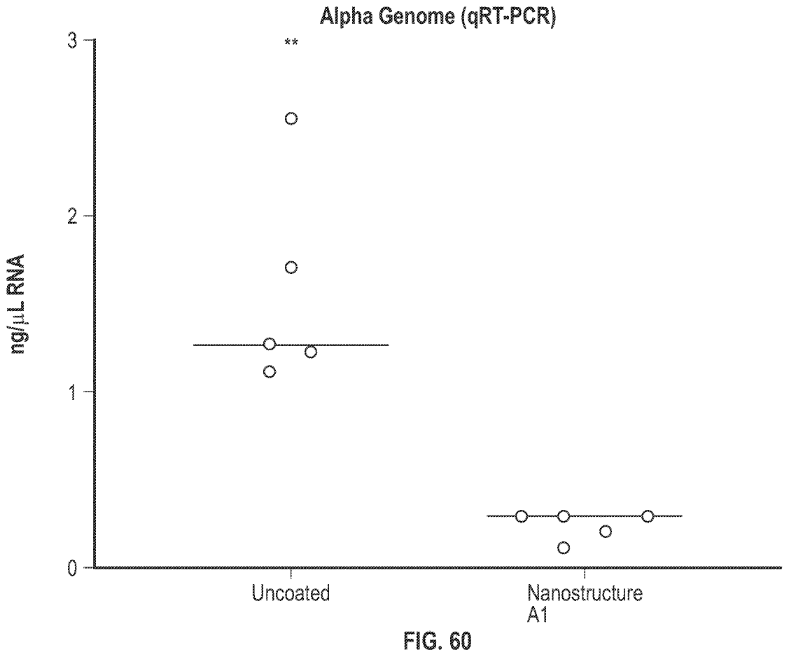

A Quantitative Real-Time Polymerase Chain Reaction (qRT-PCR) was performed for the Omicron variant, Delta Variant, and Alpha variant of SARS-CoV-2. RNA was extracted from samples using the QiaAmp Virus RNA mini extraction kit (commercially available from Qiagen) according to the manufacturer's instructions. Samples were stored at −80° C. until ready for processing. Reaction solutions specific for detection of SARS-CoV-2 Envelope (E) gene containing known volumes of standards, thawed samples and controls were set-up and processed using appropriate thermocycling conditions on an RT-PCR machine. The amount of genomic RNA material present in each sample was determined using CT (optical density) values and interpolated from the standard curve generated. Nanostructure A significantly degraded SARS-CoV 2 Omicron genome, Delta genome, and Alpha genome are shown in FIGS. 57-60.

### Virucidal Activity of Nanostructure A for Influenza A

Inoculum was created by diluting the highly concentrated egg stock of PR8 in filter sterilized Sorensen's pH buffer at pH=6.5. A 50 μL volume of inoculum was added dropwise to the provided tray tables (2×2 cm). Samples were incubated for 30 min (at room temperature, lid on plate within the BSCII hood). After the 30 min incubation period (step 2), 0.5 mL infection media (RPMI+antibiotics) was added to the sample and vigorously pipetted to remove unbound virions/virus debris from the coated surface. The pipetting did not scratch the surface. Media was collected for quantitation of infectious virus titre via TCID50 and qRT-PCR. The TCID50 was performed immediately upon sampling. For RNA extraction, samples were placed immediately in the lysis buffer, then RNA extracted. The RNA was stored at −80° C. until processed via qRT-PCR.

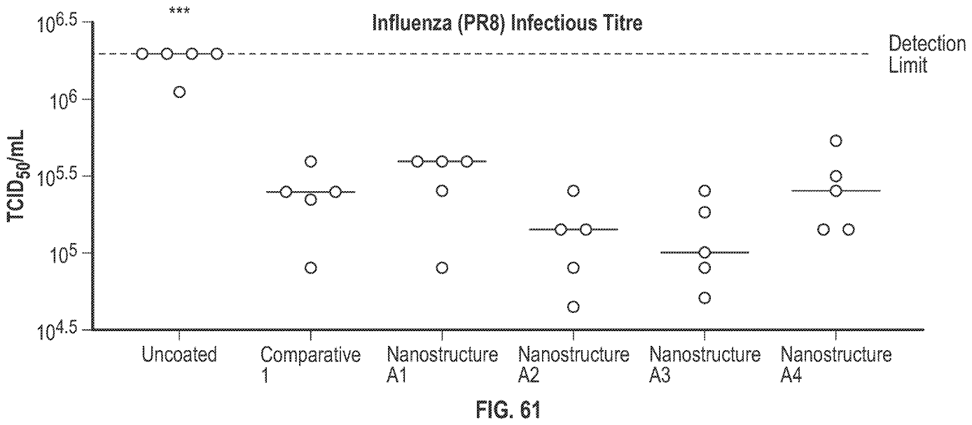

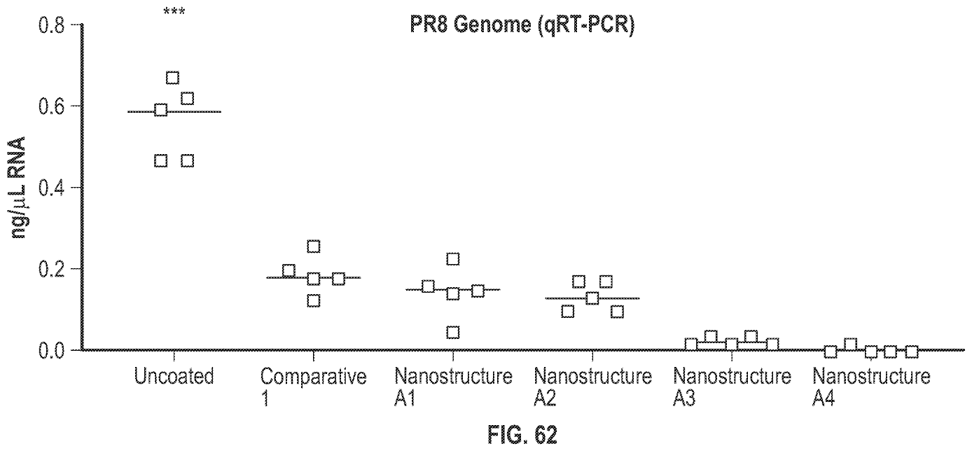

A significant reduction in all samples exposed to nanostructure A compared to the uncoated control occurred, as shown in FIGS. 61-62 and Table 21.

TABLE 21

| | | Nano- | Nano- | Nano- | Nano- |
|---|---|---|---|---|---|
| Anal- | | struc- | struc- | struc- | struc- |
| ysis | Compar- | ture A | ture A | ture A | ture A |
| No. | ative | (1) | (2) | (3) | (4) |
| 1 | 78.13 | 78.13 | 97.54 | 86.16 | 92.19 |
| 2 | 87.71 | 78.13 | 92.19 | 89.65 | 82.61 |
| 3 | 86.16 | 86.16 | 95.62 | 95.62 | 86.16 |
| 4 | 95.62 | 78.13 | 86.16 | 94.49 | 92.19 |
| 5 | 86.16 | 95.62 | 92.19 | 97.17 | 70.04 |
| Average | 86.75 | 83.23 | 92.74 | 92.62 | 84.64 |

The present disclosure provides, among others, the following aspects, each of which can be considered as optionally including any alternate aspects.
Clause 1. A nanostructure comprising a compound, or salt thereof, the compound comprising:
a plurality of N-isopropylacrylamide units; a moiety represented by the formula:

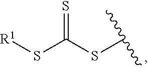

wherein R¹ is C₁-C₂₀ alkyl;
a moiety represented by the formula:

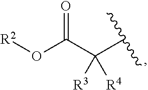

wherein R², R³, and R⁴ are each independently hydrogen or C₁-C₂₀ alkyl;
a plurality of moieties represented by the formula:

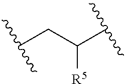

wherein R⁵ is C₄-C₁₀ aryl; and
a plurality of moieties represented by the formula:

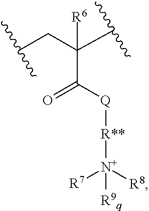

wherein Q is O or N, R** is C₁-C₂₀ alkyl, e.g., methyl, ethyl, propyl, butyl, pentyl, hexyl, heptyl, octyl, nonyl, decyl, or the like, R⁶, R⁷, and R⁸ are C₁-C₆ alkyl or hydrogen and R⁹, if present, is C₁-C₁₆ alkyl, C₁-C₆ alkylyne, azole, guanidine, an oligomer of guanidine, such as diguanidine, polysaccharide, chromophore, and combination(s) thereof, and wherein at least one R⁹ is present and is diguanidine.
Clause 2. The nanostructure of clause 1, wherein the nanostructure is represented by the formula:

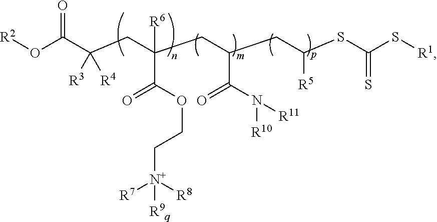

wherein n, m, and p are each independently integers of 1 to 100, q is 0 or 1, and each of R², R³, and R⁴ of Formula (I) are each independently hydrogen or C₁-C₂₀ alkyl, R⁵ of Formula (I) is C₄-C₁₀ aryl, each of R⁶, R⁷, and R⁸ of Formula (I) are C₁-C₆ alkyl or hydrogen, R⁹ of Formula (I), if present, is C₁-C₁₆ alkyl, C₁-C₆ alkylyne, azole, guanidine, an oligomer of guanidine, such as diguanidine, polysaccharide, chromophore, and combination(s) thereof, and wherein each of R¹⁰ and R¹¹ is independently hydrogen or C₁-C₂₀ alkyl.
Cause 3. The nanostructure of clause 2, wherein n is 20-50.
Clause 4. The nanostructure of clause 3, wherein n is 30.
Clause 5. The nanostructure of any of clauses 2-4, wherein m is 30 to 60.
Clause 6. The nanostructure of clause 5, wherein m is 45.
Clause 7. The nanostructure of any of clauses 2-6, wherein p is 45-55.
Clause 8. The nanostructure of clause 7, wherein p is 50.
Clause 9. The nanostructure of clause 7, wherein p is 52.
Clause 10. The nanostructure of any of clauses 2-9, wherein R^{t} is butyl.
Clause 11. The nanostructure of any of clauses 2-10, wherein R² is methyl.
Clause 12. The nanostructure of any of clauses 2-11, wherein R³ is C₁-C₂₀ alkyl.
Clause 13. The nanostructure of clause 12, wherein R³ is methyl.
Clause 14. The nanostructure of clause 12, wherein R³ is hydrogen.
Clause 15. The nanostructure of any of clauses 2-14, wherein R⁴ is C₁-C₂₀ alkyl.
Clause 16. The nanostructure of clause 15, wherein R⁴ is methyl.
Clause 17. The nanostructure of clause 15, wherein R⁴ is hydrogen.
Clause 18. The nanostructure of any of clauses 2-17, wherein R⁵ is phenyl.
Clause 19. The nanostructure of any of clauses 2-18, wherein R⁶ is C₁-C₆ alkyl.
Clause 20. The nanostructure of clause 19, wherein R⁶ is methyl.
Clause 21. The nanostructure of any of clauses 2-20, wherein R⁷ is C₁-C₆ alkyl.
Clause 22. The nanostructure of clause 21, wherein R⁷ is methyl.
Clause 23. The nanostructure of any of clauses 2-22, wherein R⁸ is C₁-C₆ alkyl.
Clause 24. The nanostructure of clause 23, wherein R⁸ is methyl.
Clause 25. The nanostructure of any of clauses 2-24, wherein R⁹ is C₁-C₁₆ alkyl.
Clause 26. The nanostructure of clause 25, wherein R⁹ is C₇ alkyl.
Clause 27. The nanostructure of any of clauses 2-26, wherein R⁹ is C₁-C₆ alkylyne.
Clause 28. The nanostructure of clause 26, wherein R⁹ is C₃ alkylyne.
Clause 29. The nanostructure of any of clauses 2-28, wherein R⁹ is azole.
Clause 30. The nanostructure of clause 29, wherein R⁹ is a combination of azole and polygalactose.
Clause 31. The nanostructure of clause 29, wherein R⁹ is a combination of azole and coumarin.
Clause 32. The nanostructure of any of clauses 2-31, wherein the nanostructure is represented by the formula:

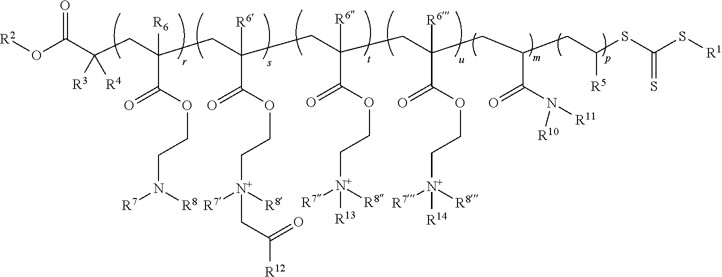

wherein r, s, t, u, m, and p are integers ranging from 1 to 100, wherein R¹ is butyl, each of R², R³, R⁶, R^{6′}, R^{6″}, R^{6′″}, R⁷, R^{7′}, R^{7″}, R^{7′″}, R⁸, R^{8′}, R^{8″}, and R^{8′″} is methyl, R⁴ is hydrogen, R⁵ is phenyl, R¹⁰ is isopropyl, R¹¹ is hydrogen, R¹² is diguanidine, R¹³ is azole, and R¹⁴ is octyl.
Clause 33. A method of depositing a nanostructure onto a surface, the nanostructure comprising:
a plurality of N-isopropylacrylamide units; a moiety represented by the formula:

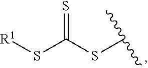

wherein R¹ is C₁-C₂₀ alkyl;
a moiety represented by the formula:

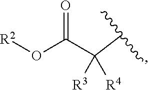

wherein R², R³, and R⁴ are each independently hydrogen or C₁-C₂₀ alkyl;
a plurality of moieties represented by the formula:

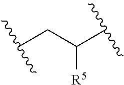

wherein R⁵ is C₄-C₁₀ aryl; and
a plurality of moieties represented by the formula:

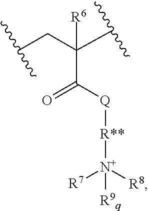

wherein Q is O or N, R** is C₁-C₂₀ alkyl, e.g., methyl, ethyl, propyl, butyl, pentyl, hexyl, heptyl, octyl, nonyl, decyl, or the like, R⁶, R⁷, and R⁸ are C₁-C₆ alkyl or hydrogen and R⁹, if present, is C₁-C₁₆ alkyl, C₁-C₆ alkylyne, azole, guanidine, an oligomer of guanidine, such as diguanidine, polysaccharide, chromophore, and combination(s) thereof, and wherein at least one R⁹ is present and is diguanidine.
Clause 34. The method of clause 33, wherein depositing is performed using an aqueous solution comprising the nanostructure at a concentration of about 0.5 wt % to about 3 wt %.
Clause 35. The method of clause 33, wherein depositing is performed using an aqueous emulsion comprising the nanostructure at a concentration of about 0.5 wt % to about 3 wt %.
Clause 36. The method of any of clauses 33-35, further comprising evaporating water of the aqueous solution after depositing the aqueous solution onto the surface.
Clause 37. The method of any of clauses 33-36, wherein depositing the structure on the surface is performed by painting the surface, dipping the surface, spraying the surface, taping the surface, brush coating the surface, spin coating the surface, roll coating the surface, doctor-blade coating the surface, or combination(s) thereof with the nanostructure.
Clause 38. The method of any of clauses 33-37, wherein the surface is a surface of an item of personal protective equipment.
Clause 39. The method of any of clauses 33-38, wherein the surface is an interior or exterior surface of an aircraft, a ship, a train, a boat, a terminal, or a spacecraft.
Clause 40. The method of any of clauses 33-39, wherein the surface is a surface of an air filter of a vehicle.
Clause 41. The method of any of clauses 33-40, wherein the surface is a floor surface, a seat surface, a tray table surface, an overhead bin surface, a ceiling surface, a door surface, or a door handle surface.
Clause 42. The method of any of clauses 33-41, wherein the nanostructure is a nanoworm.
Clause 43. The method of any of clauses 33-42, wherein the nanostructure is a nanorod.

While the foregoing is directed to aspects of the present disclosure, other and further aspects of the disclosure may be devised without departing from the basic scope thereof, and the scope thereof is determined by the claims that follow.

1. A nanostructure comprising a compound, or salt thereof, the compound comprising:
a plurality of N-isopropylacrylamide units;
a moiety represented by the formula: 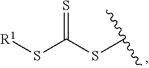
wherein R¹ is C₁-C₂₀ alkyl;
a moiety represented by the formula: 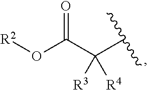
wherein R², R³, and R⁴ are each independently hydrogen or C₁-C₂₀ alkyl;
a plurality of moieties represented by the formula: 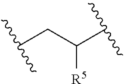
wherein R⁵ is C₄-C₁₀ aryl; and
a plurality of moieties represented by the formula: 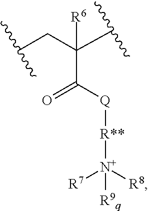
wherein Q is O or N, R** is C₁-C₂₀ alkyl, R⁶, R⁷, and R⁸ are C₁-C₆ alkyl or hydrogen and R⁹, if present, is C₁-C₁₆ alkyl, C₁-C₆ alkylyne, azole, guanidine, an oligomer of guanidine, polysaccharide, chromophore, and combination(s) thereof, and wherein at least one R⁹ is present and is diguanidine.

2. The nanostructure of claim 1, wherein the nanostructure is represented by formula (I): 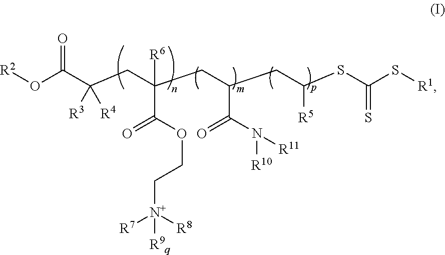
wherein n, m, and p of Formula (I) are each independently integers of 1 to 100, q is 0 or 1, and wherein each of R², R³, and R⁴ of Formula (I) are each independently hydrogen or C₁-C₂₀ alkyl, R⁵ of Formula (I) is C₄-C₁₀ aryl, each of R⁶, R⁷, and R⁸ of Formula (I) are C₁-C₆ alkyl or hydrogen, R⁹ of Formula (I), if present, is C₁-C₁₆ alkyl, C₁-C₆ alkylyne, azole, guanidine, an oligomer of guanidine, such as diguanidine, polysaccharide, chromophore, and combination(s) thereof, and each of R¹⁰ and R¹¹ of Formula (I) is independently hydrogen or C₁-C₂₀ alkyl.

3. The nanostructure of claim 1, wherein n is 20-50.

4. The nanostructure of claim 1, wherein m is 30-60.

5. The nanostructure of claim 1, wherein p is 45-55.

6. The nanostructure of claim 1, wherein p is 52.

7. The nanostructure of claim 1, wherein R¹ is butyl.

8. The nanostructure of claim 1, wherein R² is methyl.

9. The nanostructure of claim 1, wherein R³ is hydrogen.

10. The nanostructure of claim 1, wherein R⁴ is methyl.

11. The nanostructure of claim 1, wherein R⁵ is phenyl.

12. The nanostructure of claim 1, wherein each of R⁶, R⁷, and R⁸ is independently C₁-C⁶ alkyl.

13. The nanostructure of claim 12, wherein each of R⁶, R⁷, and R⁸ are independently methyl.

14. The nanostructure of claim 1, wherein R⁹ is C₇ alkyl.

15. The nanostructure of claim 1, wherein R⁹ is C₃ alkylyne.

16. The nanostructure of claim 2, wherein the nanostructure is represented by formula (II): wherein the nanostructure is represented by the formula: 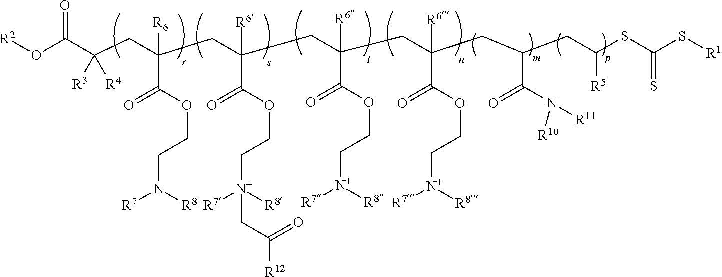
wherein r, s, t, u, m, and p are integers ranging from 1 to 100, wherein R¹ is butyl, each of R², R³, R⁶, R^{6′}, R^{6″}, R^{6′″}, R⁷, R^{7′}, R^{7″}, R^{7′″}, R⁸, R^{8′}, R^{8″}, and R^{8′″} is methyl, R⁴ is hydrogen, R⁵ is phenyl, R¹⁰ is isopropyl, R¹¹ is hydrogen, R¹² is diguanidine, R¹³ is azole, and R¹⁴ is octyl.

17. A method of depositing a nanostructure onto a surface, comprising:
depositing the nanostructure on the surface, the nanostructure comprising a compound or salt thereof, the compound comprising:
a plurality of N-isopropylacrylamide units; a moiety represented by the formula: 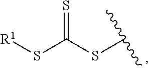
wherein R¹ is C₁-C₂₀ alkyl;
a moiety represented by the formula: 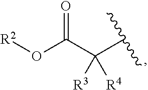
wherein R², R³, and R⁴ are each independently hydrogen or C₁-C₂₀ alkyl;
a plurality of moieties represented by the formula: 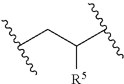
wherein R⁵ is C₄-C₁₀ aryl; and
a plurality of moieties represented by the formula: 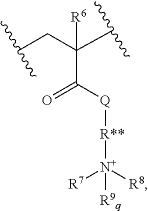
wherein Q is O or N, R** is C₁-C₂₀ alkyl, e.g., methyl, ethyl, propyl, butyl, pentyl, hexyl, heptyl, octyl, nonyl, decyl, or the like, R⁶, R⁷, and R⁸ are C₁-C₆ alkyl or hydrogen and R⁹, if present, is C₁-C₁₆ alkyl, C₁-C₆ alkylyne, azole, guanidine, an oligomer of guanidine, such as diguanidine, polysaccharide, chromophore, and combination(s) thereof, and wherein at least one R⁹ is present and is diguanidine.

18. The method of claim 17, wherein depositing is performed using an aqueous solution comprising the nanostructure at a concentration of about 0.5 wt % to about 3 wt %.

19. The method of claim 17, further comprising evaporating water of the aqueous solution after depositing the aqueous solution onto the surface.

20. The method of claim 1, wherein the nanostructure is a nanoworm.
